(19) United States
(12) Patent Application Publication
(10) Pub. No.: US 2015/0294580 A1
(43) Pub. Date: Oct. 15, 2015

(54) SYSTEM AND METHOD FOR PROMOTING FLUID INTELLEGENCE ABILITIES IN A SUBJECT

(71) Applicant: ASPEN PERFORMANCE TECHNOLOGIES, Tel Aviv (IL)

(72) Inventors: Jose Roberto KULLOK, Efrat (IL); Saul KULLOK, Efrat (IL)

(73) Assignee: ASPEN PERFORMANCE TECHNOLOGIES, Tel Aviv (IL)

(21) Appl. No.: 14/251,007

(22) Filed: Apr. 11, 2014

(51) Int. Cl. G09B 7/02

(52) U.S. Cl. CPC G09B 7/02

(57) ABSTRACT

A method of promoting fluid intelligence abilities in a subject includes: selecting one or more serial order of symbols sequences from a predefined library of complete symbols sequences and providing the subject with one or more incomplete serial orders of symbols sequences; prompting the subject to manipulate symbols within the incomplete serial orders of symbols sequences or to discriminate differences or sameness between two or more of the incomplete serial orders of symbols sequences; determining whether the subject correctly manipulated the symbols or correctly discriminated differences or sameness between the two or more incomplete serial orders of symbols sequences; if the subject correctly manipulated the symbols or correctly discriminated differences or sameness between the two or more of the incomplete serial orders of symbols sequences, then displaying the correct manipulations or discriminated selection with at least one different spatial or time perceptual related attribute, to highlight the correct answer.

### FIELD

The present disclosure relates to a system, method, software, and tools employing a novel disruptive non-pharmacological technology, characterized by prompting a sensory-motor-perceptual activity in a subject to be correlated with the statistical properties and implicit embedded pattern rules information depicting the sequential order of alphanumerical series of symbols (e.g., in alphabetical series, letter sequences and in series of numbers) and in symbols sequences interrelations, correlations and cross-correlations. This novel technology sustains and promotes, in general, neural plasticity and in particular neural-linguistic plasticity. This technology is executed through new strategies, implemented by exercises designed to obtain these interrelations, correlations and cross-correlations between sensory-motor-perceptual activity and the implicit-explicit symbolic information content embedded in a statistical and sequential properties\rules depicting serial orders of symbols sequences. The outcome is manifested mainly via fluid intelligence abilities e.g., inductive-deductive reasoning, novel problem solving, and spatial orienting.

A primary goal of the non-pharmacological technology disclosed herein is maintaining stable cognitive abilities, delaying, and/or preventing cognitive decline in a subject experiencing normal aging; restraining working and episodic memory and cognitive impairments in a subject experiencing mild cognitive decline associated, e.g., with mild cognitive impairment (MCI), pre-dementia; and delaying progression of severe working, episodic and prospective memory and cognitive decay at the early phase of neural degeneration in a subject diagnosed with a neurodegenerative condition (e.g., Dementia, Alzheimer's, Parkinson's). The non-pharmacological technology disclosed herein is also beneficial as a training cognitive intervention designated to improve the instrumental performance of the elderly person in daily demanding functioning tasks such that enabling some transfer from fluid cognitive trained abilities to everyday functioning. The non-pharmacological technology disclosed herein is also beneficial as a brain fitness training/cognitive learning enhancer tool in normal aging population and a subpopulation of Alzheimer's patients (e.g., stage 1 and beyond), and in subjects who do not yet experience cognitive decline.

### BACKGROUND

Brain/neural plasticity refers to the brain's ability to change in response to experience, learning and thought. As the brain receives specific sensorial input, it physically changes its structure (e.g., learning). These structural changes take place through new emergent interconnectivity growth connections among neurons, forming more complex neural networks. These recently formed neural networks become selectively sensitive to new behaviors. However, if the capacity for the formation of new neural connections within the brain is limited for any reason, demands for new implicit and explicit learning, (e.g., sequential learning, associative learning) supported particularly on cognitive executive functions such as fluid intelligence-inductive reasoning, attention, memory and speed of information processing (e.g., visual-auditory perceptual discrimination of alphanumeric patterns or pattern irregularities) cannot be satisfactorily fulfilled. This insufficient “neural connectivity” causes the existing neural pathways to be overworked and over stressed, often resulting in gridlock, a momentary information processing slow down and/or suspension, cognitive overflow or in the inability to dispose of irrelevant information. Accordingly, new learning becomes cumbersome and delayed, manipulation of relevant information in working memory compromised, concentration overtaxed and attention span limited.

Worldwide, millions of people, irrespective of gender or age, experience daily awareness of the frustrating inability of their own neural networks to interconnect, self-reorganize, retrieve and/or acquire new knowledge and skills through learning. In normal aging population, these maladaptive learning behaviors manifest themselves in a wide spectrum of cognitive functional and Central Nervous System (CNS) structural maladies, such as: (a) working and short-term memory shortcomings (including, e.g., executive functions), over increasing slowness in processing relevant information, limited memory storage capacity (items chunking difficulty), retrieval delays from long term memory and lack of attentional span and motor inhibitory control (e.g., impulsivity); (b) noticeable progressive worsening of working, episodic and prospective memory, visual-spatial and inductive reasoning (but also deductive reasoning) and (c) poor sequential organization, prioritization and understanding of meta-cognitive information and goals in mild cognitively impaired (MCI) population (who don't yet comply with dementia criteria); and (d) signs of neural degeneration in pre-dementia MCI population transitioning to dementia (e.g., these individuals comply with the diagnosis criteria for Alzheimer's and other types of Dementia.).

The market for memory and cognitive ability improvements, focusing squarely on aging baby boomers, amounts to approximately 76 million people in the US, tens of millions of whom either are or will be turning 60 in the next decade. According to research conducted by the Natural Marketing Institute (NMI), U.S., memory capacity decline and cognitive ability loss is the biggest fear of the aging baby boomer population. The NMI research conducted on the US general population showed that 44 percent of the US adult population reported memory capacity decline and cognitive ability loss as their biggest fear. More than half of the females (52 percent) reported memory capacity and cognitive ability loss as their biggest fear about aging, in comparison to 36 percent of the males.

Neurodegenerative diseases such as dementia, and specifically Alzheimer's disease, may be among the most costly diseases for society in Europe and the United States. These costs will probably increase as aging becomes an important social problem. Numbers vary between studies, but dementia worldwide costs have been estimated around $160 billion, while costs of Alzheimer in the United States alone may be $100 billion each year.

Currently available methodologies for addressing cognitive decline predominantly employ pharmacological interventions directed primarily to pathological changes in the brain (e.g., accumulation of amyloid protein deposits). However, these pharmacological interventions are not completely effective. Moreover, importantly, the vast majority of pharmacological agents do not specifically address cognitive aspects of the condition. Further, several pharmacological agents are associated with undesirable side effects, with many agents that in fact worsen cognitive ability rather than improve it. Additionally, there are some therapeutic strategies which cater to improvement of motor functions in subjects with neurodegenerative conditions, but such strategies too do not specifically address the cognitive decline aspect of the condition.

Thus, in view of the paucity in the field vis-à-vis effective preventative (prophylactic) and/or therapeutic approaches, particularly those that specifically and effectively address cognitive aspects of conditions associated with cognitive decline, there is a critical need in the art for non-pharmacological (alternative) approaches.

With respect to alternative approaches, notably, commercial activity in the brain health digital space views the brain as a “muscle”. Accordingly, commercial vendors in this space offer diverse platforms of online brain fitness games aimed to exercise the brain as if it were a “muscle,” and expect improvement in performance of a specific cognitive skill/domain in direct proportion to the invested practice time. However, vis-à-vis such approaches, it is noteworthy that language is treated as merely yet another cognitive skill component in their fitness program. Moreover, with these approaches, the question of cognitive skill transferability remains open and highly controversial.

The non-pharmacological technology disclosed herein is implemented through novel neuro-linguistic cognitive strategies, which stimulate sensory-motor-perceptual abilities in correlation with the alphanumeric information encoded in the sequential and statistical properties of the serial orders of its symbols (e.g., in the letters series of a language alphabet and in a series of numbers 1 to 9). As such, this novel non-pharmacological technology is a kind of biological intervention tool which safely and effectively triggers neuronal plasticity in general, across multiple and distant cortical areas in the brain. In particular, it triggers hemispheric related neural-linguistic plasticity, thus preventing or decelerating the chemical break-down initiation of the biological neural machine as it grows old.

The present non-pharmacological technology accomplishes this by particularly focusing on the root base component of language, its alphabet, organizing its constituent parts, namely its letters and letter sequences (chunks) in novel ways to create rich and increasingly new complex non-semantic (serial non-word chunks) networking. The present non-pharmacological technology also accomplishes this by focusing on the natural numbers numerical series, organizing its constituent parts, namely its single number digits and number sets (numerical chunks) in novel serial ways to create rich and increasingly new number serial configurations.

From a developmental standpoint, language acquisition is considered to be a sensitive period in neuronal plasticity that precedes the development of top-down brain executive functions, (e.g., memory) and facilitates “learning”. Based on this key temporal relationship between language acquisition and complex cognitive development, the non-pharmacological technology disclosed herein places ‘native language acquisition’ as a central causal effector of cognitive, affective and psychomotor development. Further, the present non-pharmacological technology derives its effectiveness, in large part, by strengthening, and recreating fluid intelligence abilities such as inductive reasoning performance/processes, which are highly engaged during early stages of cognitive development (which stages coincide with the period of early language acquisition). Furthermore, the present non-pharmacological technology also derives its effectiveness by promoting efficient processing speed of phonological and visual pattern information among alphabetical serial structures (e.g., letters and letter patterns and their statistical properties, including non-words), thereby promoting neuronal plasticity in general across several distant brain regions and hemispheric related language neural plasticity in particular.

The advantage of the non-pharmacological cognitive intervention technology disclosed herein is that it is effective, safe, and user-friendly, demands low arousal thus low attentional effort, is non-invasive, has no side effects, is non-addictive, scalable, and addresses large target markets where currently either no solution is available or where the solutions are partial at best.

### SUMMARY

In one aspect, the present subject matter relates to a method of promoting fluid intelligence abilities in the subject comprising selecting at least one complete serial order of symbols sequence, where all symbols in the sequence having the same spatial and/or time perceptual related attributes from a predefined library of complete symbols sequences, while also providing the subject with a plurality of symbols arranged inside a matrix format. The plurality of symbols arranged inside this matrix format having the same spatial or time perceptual related attributes than the selected at least one complete serial order of symbols. The said matrix format containing a plurality of symbols generated in a sequential quasi-random manner and thus the plurality of symbols in it arranged in a quasi-random symbol matrix. In the present Example, the one or more selected complete serial orders of symbols are non-random set arrays which are included as part of the symbols sequences forming the symbol matrix, and this selected at least one non-random complete serial order of symbols, is provided as a ruler to the subject. The subject is prompted to search, discover and serially select symbols inside the symbol matrix, following the ordinal order provided in the ruler, within a first predefined time interval, each symbol of the selected at least one non-random complete serial order of symbols sequence, until all symbols in the selected at least one non-random serial order of symbols sequence are discovered and selected. If the proposed symbol selection is not the correct symbol inside the symbol matrix in accordance to the ordinal order provided in the ruler, then the subject is returned to the step of being prompted to search, discover and serially select the symbols inside the symbol matrix. If the proposed symbol selection is the correct next symbol inside the symbol matrix in accordance to the ordinal order provided in the ruler, then the correctly selected symbol inside the symbol matrix is highlighted by changing at least one spatial or time perceptual related attribute of the correctly selected symbol. If the complete serial order of symbols sequence of the selected at least one non-random complete serial order of symbols sequence has not been selected, then the subject is again returned to the step of being prompted to search, discover and serially select the symbols inside the symbol matrix. If the complete serial order of symbols sequence of the selected at least one non-random complete serial order of symbols sequence has been correctly selected, then the complete serial orders of symbols sequence is displayed inside the symbol matrix with at least one different spatial or time perceptual related attribute than the other symbols in the quasi-random symbol matrix. The above steps in the method are repeated for a predetermined number of iterations separated by one or more predefined time intervals, and upon completion of the predetermined number of iterations, the subject is provided with each iteration results. In embodiments, the predetermined number of iterations can be any number needed to establish a satisfactory reasoning performance ability concerning the particular task at hand is being promoted within the subject. Non-limiting examples of number of iterations include 1, 2, 3, 4, 5, 6, and 7. However, any number of iterations can be performed.

Another aspect of the present subject matter relates to a method of promoting fluid intelligence abilities in the subject comprising selecting at least one serial order of consecutive letters symbols having the same spatial and time related attributes, from a predefined library of complete non-random symbols sequences, and providing the subject with a plurality of non-random letters symbols sequences of serially consecutive ordered different letters symbols, from the previously selected serially consecutive ordered different letters symbols non-random sequences. Each of the plurality of non-random symbols sequences entails serially consecutive ordered different symbols, and where each said non-random symbols sequence is positioned in a quasi-random letter symbol matrix wherein they are spatially surrounded by a number of same letters symbols, which are randomly serially distributed. The subject is prompted to, within a first predefined time interval, search, discover and select each of the serially consecutive ordered different letter symbols of the non-random letters symbols sequences positioned in the quasi-random letter symbol matrix, and where the selection of the serially consecutive ordered different letters symbols in the non-random letters symbols sequences being accomplished by correctly selecting one letter symbol at a time. If the proposed letter symbol selection is not the correct next letter symbol within the serially consecutive ordered different letters symbols non-random sequence, then the subject is returned to the step of being prompted to serially search, discover and select the non-random serially consecutive ordered different letters symbols sequence. If the proposed letter symbol selection is the correct next letter symbol within the non-random serially consecutive ordered different letters symbols sequence, then the correct selected letter symbol is highlighted by changing at least one spatial or time perceptual related attribute of the correct selected letter symbol. If all letters symbols of the non-random serially consecutive ordered different letters symbols sequence have not been selected, then the subject is returned to the step of being prompted to serially search, discover and select the non-random serially consecutive ordered different letters symbols sequence. If all letters symbols of the non-random serially consecutive ordered different letters symbols sequence have been correctly selected, then the entire non-random serially consecutive ordered different letters symbols sequence is displayed with at least one different spatial or time perceptual related attribute than the other serially random distributed letters symbols in the quasi-random letter symbol matrix. The above steps in the method are repeated for a predetermined number of iterations separated by one or more predefined time intervals, and upon completion of the predetermined number of iterations, the subject is provided with each iteration results. The predetermined number of iterations can be any number needed to establish a satisfactory reasoning performance ability concerning the particular task at hand is being promoted within the subject. Non-limiting examples of number of iterations include 1, 2, 3, 4, 5, 6, and 7. However, any number of iterations can be performed.

In another aspect, the subject matter disclosed herein provides a novel non-pharmacological, non-invasive sensorial biofeedback psychomotor application designed to exercise and recreate the developmentally early neuro-linguistic aptitudes of an individual that can be effective in slowing down cognitive decline associated with aging and in restoring optimal neuroperformance.

In yet another aspect, the subject matter disclosed herein provides a non-pharmacological approach that enhances predisposition for implicit learning of serial and statistical alphabetical knowledge properties in order to maintain the stability of selective cognitive abilities thus preventing or delaying in part of the normal aging population: gradual decline of fluid cognitive abilities (e.g., inductive reasoning), working memory fluidity, attention, visual-spatial orientation, visual-auditory speed of processing, etc.

In yet another aspect, the subject matter disclosed herein provides a non-pharmacological approach for compensating or significantly limiting the worsening of working, episodic and prospective memory and cognitive abilities of the pre-dementia mild cognitive impaired MCI population, possibly restoring working and episodic memory and cognitive executive function performance in some tasks to those associated with normal aging adults.

In yet another aspect, the subject matter disclosed herein provides a non-pharmacological cognitive intervention to effectively shield the CNS in the brain in the very early stage of dementia, so that neural degeneration will progress at a very slow pace, thus significantly postponing cognitive functional and physiological morphological (neural) stagnation resulting in a hold-up of the early stage of the disease and to some degree also resulting in longer transitional periods between later more severe dementia stages.

In yet another aspect, the subject matter disclosed herein provides a non-pharmacological, neuro-linguistic stimulation platform promoting new implicit and explicit learning of serial and statistical properties of the alphabet and natural numbers.

In yet another aspect, the subject matter disclosed herein provides a disruptive scalable internet software cognitive neuroperformance training platform which safely stimulates neural networking reach-out among visual-auditory-motor, language-alphabetical, and attention and memory brain areas thus promoting plasticity across functionally different and distant areas in the brain via novel interactive computer based cognitive training Specifically, this new triggered plasticity stimulates implicit-explicit cognitive learning thus consolidating novel symbolic interrelations, correlations and cross-correlations between non-semantic, visual-auditory-motor, fluid intelligence abilities and spatial salient aspects of attended stimuli, mainly in working memory. Accordingly, fluid intelligence abilities concerning alphanumeric symbolic information is best manipulated in working memory because the present method implements a novel exercising approach that meshes in non-linear complex ways, multiple sources of sensorial-motor-perceptual information (e.g., non-semantic, visual-auditory-motor, inductive reasoning and spatial attention etc.). Further, the approach of the present method expedites the manipulation of symbolic items in working memory.

In yet another aspect, the subject matter disclosed herein provides a non-pharmacological novel cognitive intervention which stimulates visual-auditory-motor cortices via sensorial-perceptual engagement to trigger spatial-temporal cross-domain learning, based on the brain's participating neural networks' natural capacity to interact with each other in novel complex/multifaceted ways. The resulting new learning appears both simple and novel (interesting) to the user.

In yet another aspect, the subject matter disclosed herein provides non-pharmacological brain fitness tools to stimulate, reconstruct and sharpen core selective cognitive skills (e.g., fluid and crystallized skills) that are affected by aging. This is achieved through effortless, quick, novel statistical and sequential assimilation of alphabetical (e.g., non-semantic letter sequences) and numerical patterns and sets by way of cognitive (not-physical) exercises that improve a number of skills, including motor, visual, auditory performances, spatial attention, working, episodic and prospective memories, speed of processing (e.g., visual and auditory “target” pattern search), ignoring or filtering out distracting non-relevant sensorial information, and fluid intelligence abilities (e.g., problem solving, inductive reasoning, abstract thinking, pattern-irregularity recognition performance, etc.)

In a further aspect, the subject matter disclosed herein provides an interactive cognitive intervention software platform to non-pharmacologically retrain early acquired an constantly declining fluid intelligence abilities such as: inductive reasoning, problem solving, pattern recognition, abstract thinking etc., by novel exercising of basic alphabetical and numerical symbolic implicit familiarity acquired particularly during the early language acquisition stage of cognitive development, which assists in improving information processing speed, establishing cognitive performance stability, delaying or reversing cognitive decline in early stages of the aging process and maintains or restores basic instrumental functionality skills in daily demanding tasks.

### BRIEF DESCRIPTION OF DRAWINGS

FIG. 1 is a flow chart setting forth the broad concepts covered by the specific non-limiting exercises put forth in the Examples disclosed herein.

FIG. 2 is a flow chart setting forth the method that the present exercises use in promoting fluid intelligence abilities in a subject by having the subject search and discover each individual symbol of a preselected serial order of symbols, inside a symbol matrix, which includes searching and discriminating the letters of alphabetic sets arrays, like a direct alphabetic set array and/or an inverse alphabetic set array.

FIG. 3 shows an example of a quasi-random symbol matrix that is presented to the subject. When searching, it can be seen that, within the quasi-random symbol matrix, the letters symbols A through X can be found by a subject in a serial order, starting from the top left-hand corner of the quasi-random symbol matrix and proceeding in a row-by-row perceptual discrimination of the letter symbols in the rows of the matrix, moving from left to right in each row.

FIG. 4 is a flow chart setting forth the method that the present exercises use in promoting fluid intelligence abilities in a subject by having the subject serially search and discover a number of serially consecutive letters symbols in a plurality of sequences within a quasi-random letter symbol matrix.

### DETAILED DESCRIPTION

### Overview

A growing body of research supports the protective effects of late-life intellectual stimulation on incident dementia. Recent research from both human and animal studies indicates that neural plasticity endures across the lifespan, and that cognitive stimulation is an important predictor of enhancement and maintenance of cognitive functioning, even in old age. Moreover, sustained engagement in cognitively stimulating activities has been found to impact neural structure in both older humans and rodents. Conversely, limited education has been found to be a risk factor for dementia. There is also a sizeable body of literature documenting that different types of cognitive training programs have large and durable effects on the cognitive functioning of older adults, even in advanced old age.

Longitudinal Studies Addressing Training Effects on Cognitive Decline:

Longitudinal studies addressing the decline in intellectual abilities in later adulthood and early old age, suggest that such decline is commonly selective (often ability specific), rather than global or catastrophic. In other words, typically, individuals show statistically reliable decrement on a particular subset of abilities, although their performance remains stable on other abilities. Moreover, there are wide individual differences in the specific abilities showing decline.

A study by Willis and Schaie examined the effects of cognitive training on two primary mental abilities-spatial orientation and inductive reasoning, within the context of the Seattle longitudinal study (SLS), which study provided a major model for longitudinal-sequential studies of aging. (See Willis, S. L. and Shaie, K. W. Psychol. Aging. 1986 September; 1(3):239-47). These specific cognitive abilities were targeted because they had been identified by previous studies to exhibit patterns of normative decline. The focus of the study was on facilitating the subject's use of effective cognitive strategies, identified in previous research, on the respective cognitive abilities. Spatial orientation ability was assessed by four measures: Primary Mental Abilities (PMA) Space; Object Rotation; Alphanumeric rotation; and Cube Comparison. Inductive reasoning ability was measured by four measures: The PMA reasoning measure (which assesses inductive reasoning via letter series problems); The Adult Development and Enrichment Project (ADEPT) Letter Series test; The Word Series test: and The Number Series test. Each of these four inductive reasoning measure tests involves different types of pattern-description rules involving letters, words, numbers or mathematical computations. In addition to the spatial orientation and inductive reasoning, Willis and Schaie's test battery also involved psychometric measures representing primary mental abilities (PMA) for perceptual speed, numeric and verbal abilities.

The results of Willis and Schaie's study suggested that training effects were significant only for the two targeted abilities, i.e., inductive reasoning and spatial orientation abilities, but not for the other abilities tested, i.e., perceptual speed, numeric and verbal. Further, the results showed that not only were the training efforts effective in significantly improving the performance of older adults whose abilities trained had declined, but were also effective in enhancing the performance of those older persons whose (i.e., those who showed no prior decline) target abilities had remained stable. Thus, Willis and Schaie's study suggested that for elderly subject s with known intellectual histories, it appears feasible to develop individual profiles of ability change and to target cognitive intervention efforts specifically to the needs of the individual, whether there is remediation of loss or increasing performance to a level not previously demonstrated by the individual. However, the magnitude of training effects has been found to vary with cognitive risk and dementia status.

Overview of the Seattle Longitudinal Study (SLS):

An overview of the Seattle Longitudinal Study (SLS) is provided in a review article by Schaie, Willis and Caskie, and briefly summarized below (See Schaie, K. W., Willis, S. L., and Caskie, G. I. L., Neuropsychol Dev Cogn B Aging Neuropsychol Cogn. 2004 June; 11(2-3): 304-324.)

The SLS study has provided a major model for longitudinal-sequential studies of aging and has allowed for charting the course of selected psychometric abilities from young adulthood through old age. The SLS has investigated individual differences and differential patterns of change. In so doing it has focused not only on demonstrating the presence or absence of age-related changes and differences but has attended also to the magnitude and relative importance of the observed phenomena.

During all seven cycles of the SLS, the principal dependent variables were the measures of verbal meaning, space, reasoning, number and word fluency, identified by Thurstone as accounting for the major proportion of variance in the abilities domain in children and adolescents contained in the 1948 version of the Thurstone's SRA Primary Mental Abilities Test. The second set of variables that has been collected consistently includes the rigidity-flexibility measures from, the Test of Behavioral Rigidity, which also include a modified version of the Gough social responsibility scale. Limited demographic were collected during the first three cycles. The above measures are referred to as the “Basic Test Battery,” and have been supplemented since 1974 with a more complete personal data inventory, the Life Complexity Inventory (LCI), which includes topics such as major work circumstances (with home-making defined as a job) friends and social interactions, daily activities, travel experiences, physical environment and life-long educational pursuits. The battery was expanded in 1991 by adding the Moos Family Environment and Work Scales, and a family contact scale. A Health Behavior Questionnaire was added in 1993.

In the 1975 collateral study, a number of measures from the ETS kit of factor referenced tests as well as the 1962 revision of the PMA were added. Of these the Identical Picture, Finding A's and Hidden Pattern tests were included in the fourth (1977) SLS cycle.

To be able to explore age changes and differences in factor structure, multiple markers for most abilities were included during the fifth (1984) cycle. Also measures of Verbal Memory were added. This now permits an expanded cognitive battery to measure the primary abilities of Verbal Comprehension, Spatial Orientation, Inductive Reasoning, Numerical Facility, Perceptual, Speed and Verbal Memory at the latent construct level. Also added were a criterion measure of “real life tasks,” the ETS Basic Skills test (Educational Testing Service, 1977), and a scale for measuring participants' subjective assessment of ability changes between test cycles. Beginning in 1997 the Everyday Problems Test (EPT) was substituted for the Basic Skills test, since the more recent test was specifically constructed for work with adults and has been related to measures of the Instrumental Activities of Daily Living (IADL).

The fifth cycle (1984) of the SLS marked the designing and implementation of cognitive training paradigms to assess whether cognitive training in the elderly serves to remediate cognitive decrement or increase levels of skill beyond those attained at earlier ages. (See Schaie, K. W., and Willis, S. L., ISSBD Bull. 2010; 57(1): 24-29). The database available through the fifth cycle also made it possible to update the normative data on age changes and cohort differences and to apply sequential analysis designs controlled for the effects of experimental mortality and practice. Finally, this cycle saw the introduction of measures of practical intelligence analyses of marital assortativity using data on married couples followed over as long as 21 years, and the application of event history methods to hazard analysis of cognitive change with age.

Throughout the history of the SLS, an effort now extending over 47 years, the focus has been on five major questions, which investigators have asked with greater clarity and increasingly more sophisticated methodologies at each successive stage of the study: (1) Does intelligence change uniformly through adulthood, or are there different life course ability patterns; (2) At what age is there a reliably detectable decrement in ability, and what is its magnitude?; (3) What are the patterns of generational differences, and what is their magnitude?; (4) What accounts for individual differences in age-related change in adulthood?; and (5) Can intellectual decline with increasing age be reversed by educational intervention?. These are summarized in turn below:

(1) Does intelligence change uniformly through adulthood, or are there different life course ability patterns? The SLS studies have shown that there is no uniform pattern of age-related changes across all intellectual abilities, and that studies of an overall Index of Intellectual Ability (IQ) therefore do not suffice to monitor age changes and age differences in intellectual functioning for either individuals or groups. The data do lend some support to the notion that fluid abilities tend to decline earlier than crystallized abilities. However, there are, important ability-by age, ability-by-gender, and ability-by-cohort interactions that complicate matters. Moreover, whereas fluid abilities begin to decline earlier, crystallized abilities appear to show steeper decrement once the late 70s are reached.

Although cohort-related differences in the rate and magnitude of age changes in intelligence remained fairly linear for cohorts who entered old age during the first three cycles of our study, these differences have since shown substantial shifts. For example, rates of decremental age change have abated somewhat, and at the same time modestly negative cohort trends are beginning to appear as we begin to study members of the baby boom generation. Also, patterns of socialization unique to a given gender role in a specific historical period may be a major determinant of the pattern of change in abilities.

More fine grained analyses suggested that there may be substantial gender differences as well as differential changes for those who decline and those who remain sturdy when age changes are decomposed into accuracy and speed. With multiple markers of abilities, we have conducted both cross-sectional and longitudinal analyses of the invariance of ability structure over a wide age range. In cross-sectional analyses, it is possible to demonstrate configural but not metric factor invariance across wide age/cohort ranges. In longitudinal analyses, metric invariance obtains within cohorts over most of adulthood, except for the youngest and oldest cohorts. Finally, we examined the relationship of everyday tasks to the framework of practical intelligence and perceptions of competence in everyday situations facing older persons.

(2) At what age is there a reliably detectable decrement in ability, and what is its magnitude? It has been generally observed that reliably replicable average age decrements in psychometric abilities do not occur prior to age 60, but that such reliable decrement can be found for all abilities by 74 years of age. Analyses from the most recent phases of the SLS, however, suggested that small but statistically significant average decrement can be found for some, but not all, cohorts beginning in the sixth decade. However, more detailed analyses of individual differences in intellectual change demonstrated that, even at age 81, fewer than half of all observed individuals have shown reliable decremental change over the preceding 7 years. In addition, average decrement below age 60 amounts to less than 0.2 of a standard deviation; by 81 years of age, average decrement rises to approximately 1 population standard deviation for most variables.

As data from the SLS cover more cohorts and wider age ranges within individuals, they attain increasing importance in providing a normative base to determine at what ages declines reach practically significant levels of importance for public policy issues. Thus, these data have become relevant to issues such as mandatory retirement, age discrimination in employment, and prediction of proportions of the population that can be expected to live independently in the community. These bases will shift over time because we have demonstrated in the SLS that both level of performance and rate of decline show significant age-by-cohort interactions.

(3) What are the patterns of generational differences, and what is their magnitude? Results from the SLS have conclusively demonstrated the prevalence of substantial generational (cohort) differences in psychometric abilities. These cohort trends differ in magnitude and direction by ability and therefore cannot be determined from composite IQ indices. As a consequence of these findings, it was concluded that cross-sectional studies used to model age change would overestimate age changes prior to the 60s for those variables that show negative cohort gradients and underestimate age changes for those variables with positive cohort gradients.

Studies of generational shifts in abilities have in the past been conducted with random samples from arbitrarily defined birth cohorts. As a supplement and an even more powerful demonstration, we have also conducted family studies that compared performance levels for individuals and their adult children. By following the family members longitudinally, we are also able to provide data on differential rates of aging across generations. In addition, we have also recruited siblings of our longitudinal participants to obtain data that allow extending the knowledge base in the developmental behavior genetics of cognition to the adult level by providing data on parent-offspring and sibling correlations in adulthood.

(4) What accounts for individual differences in age-related change in adulthood? The most powerful and unique contribution of a longitudinal study of adult development arises from the fact that only longitudinal data permit the investigation of individual differences in antecedent variables that lead to early decrement for some persons and maintenance of high levels of functioning for others into very advanced age. A number of factors that account for these individual differences have been implicated; some of these have been amenable to experimental intervention. The variables that have been implicated in reducing risk of cognitive decline in old age have included (a) absence of cardiovascular and other chronic diseases; (b) a favorable environment mediated by high socioeconomic status; (c) involvement in a complex and intellectually stimulating environment; (d) flexible personality style at midlife; (e) high cognitive status of spouse; and (f) maintenance of high levels of perceptual processing speed.

(5) Can intellectual decline with increasing age be reversed by educational intervention? Because longitudinal studies permit tracking stability or decline on an individual level, it has also been feasible to carry out interventions designed to remediate known intellectual decline as well as to reduce cohort differences in individuals who have remained stable in their own performance over time but who have become disadvantaged when compared with younger peers. Findings from the cognitive training studies conducted with our longitudinal subjects suggested that observed decline in many community-dwelling older people might well be a function of disuse and is clearly reversible for many. Indeed, cognitive training resulted in approximately two-thirds of the experimental subjects showing significant improvement; and about 40% of those who had declined significantly over 14 years were returned to their pre-decline level. In addition, we were able to show that we did not simply “train to the test” but rather trained at the ability (latent construct) level, and that the training did not disturb the ability structure. We have now extended these studies to include both a 7-year and a 14-year follow-up that suggest the long-term advantage of cognitive interventions.

The Advanced Cognitive Training for Independent and Vital Elderly (ACTIVE) Trial:

A large-scale multicenter, randomized, controlled cognitive intervention trial, sponsored by the National Institute on Aging and the National Institute of Nursing Research, called The Advanced Cognitive Training for Independent and Vital Elderly (ACTIVE) study, followed 2,832 people age 65 to about 94 in six U.S. metropolitan areas for ten years after they received 10 sessions of targeted cognitive training. The primary objective of the ACTIVE trial was to test the effectiveness and durability of three distinct cognitive interventions (i.e., memory training, reasoning training, or speed-of-processing training) in improving the performance of elderly persons on basic measures of cognition and on measures of cognitively demanding daily activities (e.g., instrumental activities of daily living (IADL) such as food preparation, driving, medication use, financial management). These interventions previously had been found successful in improving cognitive abilities under laboratory or small-scale field conditions.

The results of a two-year follow-up of the ACTIVE study were reported by Ball et al. (See Ball K., et al., JAMA, 2002 Nov. 13; 288(18): 2271-2281). ACTIVE was a randomized controlled, single-blind trial, using a four-group design, including three treatment groups and a control group. Ball et al. reported that each intervention group received a 10-session intervention, conducted by certified trainers, for one of three cognitive abilities—memory, inductive reasoning, or speed of processing. Assessors were blinded to participant intervention assignment. Training exposure and social contact were standardized across interventions so that each intervention served as a contact control for the other two interventions. Booster training was provided to a random sub sample in each intervention group. Measurement points consisted of baseline tests, an immediate posttest (following the intervention), and A1 and A2 annual posttests.

Memory training focused on verbal episodic memory. Participants were taught mnemonic strategies for remembering word lists and sequences of items, text material, and main ideas and details of stories. Participants received instruction in a strategy or mnemonic rule, exercises, individual and group feedback on performance, and a practice test. For example, participants were instructed how to organize word lists into meaningful categories and to form visual images and mental associations to recall words and texts. The exercises involved laboratory like memory tasks (e.g., recalling a list of nouns, recalling a paragraph), as well as memory tasks related to cognitive activities of everyday life (e.g., recalling a shopping list, recalling the details of a prescription label). Reasoning training focused on the ability to solve problems that follow a serial pattern. Such problems involve identifying the pattern in a letter or number series or understanding the pattern in an everyday activity such as prescription drug dosing or travel schedules. Participants were taught strategies to identify a pattern and were given an opportunity to practice the strategies in both individual and group exercises. The exercises involved abstract reasoning tasks (e.g., letter series) as well as reasoning problems related to activities of daily living. Speed-of-processing training focused on visual search skills and the ability to identify and locate visual information quickly in a divided-attention format. Participants practiced increasingly complex speed tasks on a computer. Task difficulty was manipulated by decreasing the duration of the stimuli, adding either visual or auditory distraction, increasing the number of tasks to be performed concurrently, or presenting targets over a wider spatial expanse. Difficulty was increased each time a participant achieved criterion performance on a particular task.

Eleven months after the initial training was provided, booster training was offered to a randomly selected 60% of initially trained subjects in each of the 3 intervention groups. Booster training was delivered in four 75-minute sessions over a two to three-week period. Consistent with results of the primary analyses, secondary analyses indicated large immediate intervention gains on the cognitive outcomes. Eighty-seven percent of speed trained, 74% of reasoning-trained, and 26% of memory-trained participants demonstrated reliable improvement on the pertinent cognitive composite immediately following intervention. While intervention participants showed reliable posttest gains, a comparable proportion of control participants also improved, and the proportion of control participants exhibiting reliable retest gain remained fairly constant across study intervals. In terms of the proportion of the intervention group showing reliable gain in the trained domain, booster effects occurred for the speed conditions (boost, 92%; no boost, 68%; control, 32%) and the reasoning conditions (boost, 72%; no boost, 49%; control, 31%). While some dissipation of intervention effects occurred across time, cognitive effects were maintained from baseline to A2, particularly for boosted participants (79% [speed boost] vs. 37% [controls]; 57% [reasoning boost] vs 35% [controls]).

Willis et al. reported data obtained from a five-year follow-up of the ACTIVE study (See Willis et al., JAMA. 2006 Dec. 20; 296(23): 2805-2814). Cognitive outcomes assessed the effects of each intervention on the cognitive ability trained. Memory training outcomes involved three measures of verbal memory ability: Hopkins Verbal Learning Test, Rey Auditory-Verbal Learning Test, and the Rivermead Behavioral Paragraph Recall test. Reasoning training outcomes involved three reasoning ability measures: letter series, letter sets, and word series. Speed of processing training outcomes involved three useful field of view subscales.

Functional outcomes assessed whether the cognitive interventions had an effect on daily function. Everyday functioning represented the participant's self-ratings of difficulty (IADL difficulty from the Minimum Data Set-Home Care and ranged from “independent” to “total dependence” on a 6-point scale) in completing cognitively demanding tasks involved in meal preparation, house-work, finances, health maintenance, telephone use, and shopping. Two performance-based categories of daily function were also assessed. Everyday problem solving assessed ability to reason and comprehend information in common everyday tasks (e.g., identifying information in medication labels). Performance was measured with printed materials (e.g., yellow pages, using the Everyday Problems Test) and behavioral simulations (e.g., making change, using the Observed Tasks of Daily Living). These measures were hypothesized to be most closely related to reasoning and memory abilities due to their task demands. Everyday speed of processing assessed participants' speed in interacting with real world stimuli (e.g., looking up a telephone number, using the Timed IADL Test), and the ability to react quickly to 1 of 4 road signs (Complex Reaction Time Test), which was hypothesized to be the most closely related to speed of processing.

Data obtained from the five-year follow-up study showed that each intervention produced immediate improvement in the cognitive ability trained that was retained across five years. Similarly, when controlling for baseline age and cognitive function, booster training for the reasoning and speed of processing groups produced significantly better performance (net of initial training effect) on their targeted cognitive outcomes that remained significant at five years. Further, training effects on daily functioning showed that for self-reported IADL difficulty, at year five, participants in all three intervention groups reported less difficulty compared with the control group in performing IADL. However, this effect was significant only for the reasoning group, which compared with the control group had an effect size of 0.29 (99% CI, 0.03-0.55) for difficulty in performing IADL. Neither speed of processing training (effect size, 0.26; 99% Cl, −0.002 to 0.51) nor memory training (effect size, 0.20; 99% CI, −0.06 to 0.46) had a significant effect on IADL. Group mean IADL difficulty ratings improved through the first two years of the study (baseline through year two). The decline in function for all groups is first evident between years two and three. From years three to five, the decline is dramatically accelerated for the control group and to a lesser extent for the three treatment groups.

Willis et al. concluded that declines in cognitive abilities have been shown to lead to increased risk of functional disabilities that are primary risk factors for loss of independence. The five-year results of the ACTIVE study provide limited evidence that cognitive interventions can reduce age-related decline in self-reported IADLs that are the precursors of dependence in basic ADLs associated with increased use of hospital, outpatient, home health, and nursing home services and health care expenditures. The authors concluded that these results are promising and support future research to examine if these and other cognitive interventions can prevent or delay functional disability in an aging population.

Reasoning Training in the ACTIVE Study:

In light of the ACTIVE findings of five-year durability of training effects and some transfer to everyday functioning, there has been considerable interest in further examination of the characteristics of individuals profiting from reasoning training and of issues of dosing, including adherence with training and added effects of booster training.

To follow-up on the data obtained from the five-year follow-up of the ACTIVE study, Willis and Caskie reported employing piecewise growth models from baseline to the 5th annual follow-up to examine the five-year trajectory separately for the reasoning training group. (See Willis, S. L. and Caskie, G. I. L., J Aging Health. 2013 December; 25(80)). Although only the reasoning composite score was used in the prior studies to represent the proximal outcome of the reasoning training, Willis and Caskie's study reported findings for both the composite and three individual reasoning tests (letter series, letter sets, and word series). Their study addressed three major questions with regard to the reasoning training group within the ACTIVE trial. 1) What was the impact of training on the trajectory of the reasoning trained group from baseline to five-year follow-up? 2) Did adherence with training and booster sessions influence training outcomes? 3) What covariates were significant predictors of training effects?

The dependent variables in Willis and Caskie's cognitive outcome analysis were: three reasoning measures and a composite score of the three measures. The Letter Series test requires participants to identify the pattern in a series of letters and circle the letter that comes next in the series. The Word Series test requires participants to identify the pattern in a series of words, such as the month or day of the week, and circle the word that comes next in the series. The Letter Sets test requires participants to identify which set of letters out of 4 letter sets does not follow the pattern of letters. For the Reasoning Composite, each of the 3 reasoning measures was standardized to its baseline value, and an average of the equally weighted standardized scores was calculated.

The dependent variables in Willis and Caskie's functional outcome analysis were: two measures of everyday reasoning/problem-solving abilities—the Everyday Problems Test (EPT), and the Observed Tasks of Daily Living (OTDL); and two measures of everyday speed of processing—the Complex Reaction Time test (CRT) and the Timed Instrumental Activities of Daily Living (TIADL). Lower scores on the CRT and TIADL reflected better performance. The covariates were: baseline Mini-Mental State Exam (MMSE), self-rated health, age, education, and gender.

The adherence indicators were: Participants were considered compliant with initial training if they participated in at least 80% of the training sessions (i.e., 8-10 sessions). Adherence with the booster training sessions at the 1st annual and 3rd annual follow-up assessments was indicated by participation in at least three of the four sessions; participants not randomly assigned to booster training were given missing values for the booster adherence variables.

The reasoning training program focused on improving the ability to solve problems that require linear thinking and that follow a serial pattern or sequence. Such problems involve identifying the pattern in a series of letters or words. Participants were taught strategies (e.g., underlining repeated letters, putting slashes between series, indicating skipped items in a series with tick marks) to identify the pattern or sequence involved in solving a problem; they used the pattern to determine the next item in the series. Participants practiced the strategies in both individual and group exercises. Exercises involved both abstract reasoning tasks (e.g., letter series) and reasoning problems related to activities of daily living (e.g., identifying medication dosing pattern).

Willis and Caskie's results showed training resulted in a significant positive training effect for all reasoning measures, which were maintained though the fifth annual follow-up. A significant third annual booster effect was one-half the size of the training effect. Additionally, training adherence resulted in greater training effects. Covariates such as higher education, Mini-Mental State Exam (MMSE), better health and younger age related to higher baseline performance. Finally, a significant functional outcome included training effects for the Complex Reaction Time (CRT), and first annual booster effects for the CRT and Observed Tasks of Daily Living (OTDL).

It is noteworthy that the ACTIVE study was the first large-scale randomized trial to show that cognitive training improves cognitive functioning in well-functioning older adults, and that this improvement lasts up to 5 years follow up. Prior smaller intervention studies had documented significant immediate effects of training; the ACTIVE trial using intent-to-treat analyses replicated these findings. However, prior training research had not carefully examined issues of adherence with training and the effect of temporally-spaced booster sessions. Prior studies had seldom reported the proportion of participants compliant with the intervention or whether adherence enhanced the intervention effect. The significant effect of adherence indicates that the dosing of the intervention is an important factor in its effectiveness. The finding that the three-year booster sessions resulted in an effect approximately half the size of the initial training is informative, given that the number of booster sessions was 60% of the intensity of the initial training and the participants were three years older, on average in their mid-to-late seventies. The efficacy of the delayed booster suggests that maintenance of training effects may indeed extend beyond the five year follow-up, underscoring the importance of following this sample into old-old age.

Ten-Year Effects of the ACTIVE Cognitive Training Trial on Cognition and Everyday Functioning in Older Adults:

The results of a ten-year follow-up of the ACTIVE study were reported by Rebok et al. (See Rebok., et al., JAGS, January 2014—Vol. 62, No. 1). In the ACTIVE trial, 10 to 14 weeks of organized cognitive training delivered to community-dwelling older adults resulted in significant improvements in cognitive abilities and better preserved functional status (memory group: effect size=0.48, 99% CI=0.12-0.84; reasoning group: effect size=0.38, 99% CI=0.02-0.74; speed of processing group: effect size=0.36, 99% CI=0.01-0.72) than in non-trained persons 10 years later. Each training intervention produced large and significant improvements in the trained cognitive ability. These improvements dissipated slowly but persisted to at least 5 years for memory training (memory training effects were no longer maintained for memory performance after 5 years) and to 10 years for reasoning (effect size=0.23, 99% CI=0.09-0.38) and speed-of-processing (effect size=0.66, 99% CI=0.43-0.88) training Booster training produced additional and durable improvement for the reasoning intervention for the reasoning performance (effect size=0.21, 99% CI=0.01-0.41) and the speed-of-processing intervention for the speed-of-processing performance (effect size=0.62, 99% CI=0.31-0.93). This is the first demonstration of long-term transfer of the training effects on cognitive abilities to daily functions.

Unlike for the non-trained participants, at a mean age of 82 years old, cognitive function for the majority of the reasoning and speed-trained participants was at or above their baseline level for the trained cognitive ability 10 years later. A significant percentage of participants in all trained groups (≧60%) continue to report less difficulty performing IADLs than (49%) non-trained participants controls (P<0.05). After 10 years, 60% to 70% of participants were as well off as or better off than when they started (less decline in self-reported IADL compared with the non-trained control group).

In summary, this is the first multi-site (six U.S. cities) large-scale (2,832 volunteer persons—mean baseline age: 73.6; 26% African American—living independently) randomized, controlled single blind trial carried to demonstrate a long-term transfer of the training effects on cognitive abilities to daily functions. Results at 10 years demonstrate that cognitive training has beneficial effects on cognitive abilities and on self-reported IADL function. These results provide support for the development of other interventions targeting cognitive abilities that hold the potential to delay the onset of functional decline and possibly dementia and are consistent with comprehensive geriatric care that strives to maintain and support functional independence.

Cognitive Decline or Excess Knowledge:

Aging adults' performance on many psychometric tests supports the finding that cognitive information-processing capacities decline across adulthood, and that the brain slows down due to normal aging causes. Imaging studies show clearly that even healthy aging brains experience neural shrinkage in areas that are related to learning, reason and memory.

Despite the above, there might be additional reasons for the slowing down of the aging brain. First, it could well be that an older mind organizes information differently from a mind of a 20 years old. Secondly, it might simply be that it takes older minds longer to retrieve the right bits of information since they have accumulated a larger semantic reserve.

The theory of age-related positivity effect provides further theoretical and clinical support in favor of the theory that maintains that older brains think and process information in a different manner than young brains (See Andrew E. Reed, Laura L. Carstensen (2012). Front. Psychol. 3:339). The “positive effect” refers to an age-related trend that favors positive over negative stimuli in cognitive processing. Relative to their younger counterparts, older people attend to and (tend to) remember more positive than negative information (negative information is more cognitive demanding (See Labouvie-Vief et al. 2010, The Handbook of Life-Span Development, Vol. 2, eds R. M. Lerner, M. E. Lamb, and A. M. Freund Hoboken: John Wiley & Sons, Inc.), 79-115.). Researchers came to the conclusion that the “positive effect” in the older aging brain represents controlled processing, rather than cognitive decline.

Ramscar argues that older adults will exhibit greater sensitivity to the fine-grained properties of test items (in lexical decision and naming data, older adults show greater sensitivity to differences in item properties in comparison to younger adults (See M. Ramscar et al. Topics in Cognitive Science 6 (2014) 5-42). For example, hard pair association e.g., jury-eagle versus an easy pair association e.g., baby-cries (See Des Rosiers, G., & Ivison, D. (1988). Journal of Clinical Experimental Neuropsychology, 8, 637-642.). Therefore, the patterns of response change that are typically considered as evidence for and measure of cognitive decline, stem out of basic principles of learning and emerge naturally in learning models as adults acquire more knowledge. More so, Ramscar strongly argues that psychometric tests do not take account of the statistical skew of human experience, or the way knowledge increases with experience as we age. Therefore, he remains very skeptical concerning the use of psychometric tests as strong indicative or proof of cognitive decline in older individuals.

It is widely accepted that crystalized knowledge climbs sharply between ages 20 and 50 and then plateaus, even as fluid intelligence drops steadily, by more than 50 percent between ages 20 and 70, in some studies. In light of the above, the present subject matter acknowledges and addresses the fact that the overwhelming amount of acquired crystalized knowledge (verbal-declarative knowledge concerning expanded vocabulary, knowledge of low frequency words and fixed predictability outcomes from semantic knowledge) along adulthood, becomes a critical detrimental information processing backlog in the older aging brain. More so, that the information processing backlog takes place at a time when there is also a pronounced decline of fluid knowledge. In the long run, this situation promotes an inverse relationship between the continual growth of crystalized knowledge versus the continual decline of fluid knowledge, a situation that is too cognitively taxing to be sustained physiologically. It does not take too long before the physiologically uncontrolled proliferation of crystalized intelligence forces fixed patterns of cognitive stiff behaviors. These stiff cognitive behaviors rely heavily on semantic and episodic information retrieval from memory when the aging individual copes with everyday problem solving and demanding daily tasks. More so, these stiff cognitive behaviors also swell negative information processing demands in the older aging brain that inevitably increase its risk for gravitating into neuropathology.

In light of the above, the subject matter disclosed herein reveals a non-pharmacological approach directed to promote novel strategies in the aging brain, mainly concerning fluid intelligence abilities, via the performance of a new platform of alphanumeric exercises. Further, recurrent performance of the presently disclosed novel non-pharmacological technology diminishes detrimental cognitive information processing demands and disrupts fixed pattern loops of sensorial-motor-perceptual repetitive habitual behaviors (e.g., a healthy aging person and the elderly will start acting favorably in a less predicted, routine-like manner and will display more varied novel reactions) stemming from a lifetime of accumulated crystalized knowledge (particularly crystalized knowledge related to expectations derived from non-flexible declarative knowledge constructs e.g., word associations).

In summary, the subject matter disclosed herein provides a practical and novel cognitive training approach that combines both point of views formulated by theoretical researchers in respect to the status of cognitive functional abilities in the aging brain (whether the aging brain experiences cognitive decline or simply knows too much).

The present subject matter provides a novel non-pharmacological technology which implementation is of immediate survival benefit for the older healthy and non-healthy aging brains. The presently disclosed non-pharmacological technology provides cognitive training of a novel platform of alphanumeric exercises aimed to promote a variety of fluid intelligence abilities in healthy, MCI, mild Dementia and Alzheimer's aging subjects.

Cognitive Decline-Normal Versus Pathological

Normal aging is associated with a decline in various memory abilities in many cognitive tasks; the phenomenon is known as Age-related Memory Impairment (AMI) or Age-Associated Memory Impairment (AAMI). Memory functions which decline with age are: (a) Working memory (e.g., holding and manipulating information in the mind, as when reorganizing a short list of words into alphabetical order; verbal and visuospatial working speed, memory and learning; visuospatial cognition is more affected by aging than verbal cognition); (b) Episodic memory (e.g., personal events and experiences); (c) Processing speed; (d) Prospective memory, i.e., the ability to remember to perform a future action (e.g., remembering to fulfill an appointment or take a medication); (e) Ability to remember new textual information, to make inferences about new textual information, to access prior knowledge in long-term memory, and to integrate prior knowledge with new textual information; and (f) Recollection.

During a person's twenties, brain cells begin to gradually die off and the body starts producing smaller amounts of the chemicals needed for memory function. In fact, the brain produces 15% to 20% fewer neurotransmitters, chemicals that transfer messages between neurons. However, these chemical changes do not affect a person's ability to lead a normal life and any resulting memory loss does not worsen noticeably over time. Occasional memory lapses, such as forgetting why you walked into a room or having difficulty recalling a person's name, become more common as we approach our 50's and 60's. One widely cited study (Larrabee G J, Crook T H 3rd. Estimated prevalence of age-associated memory impairment derived from standardized tests of memory function. Int Psychogeriatr. 1994 Spring; 6(1):95-104.) estimates that more than half of the people over 60 have “age-associated memory impairment,” and finds that this type of memory loss is prevalent in younger groups as well. In short, it's comforting to know that this minor forgetfulness is a normal sign of aging, not a sign of dementia.

But other types of memory loss, such as forgetting appointments or becoming momentarily disoriented in a familiar place, may indicate mild cognitive impairment (MCI). MCI involves memory loss that is more severe than what is considered normal for the aging process and it falls somewhere between age-associated memory impairment and early dementia. In MCI, there is measurable memory loss, but that loss does not interfere with a patient's everyday life, in terms of the ability to live independently, but the patient might become less active socially. MCI is not severe enough (does not include cognitive problems/symptoms associated with dementia, such as disorientation or confusion about routine activities) to be diagnosed as dementia. In many cases, memory loss in people with MCI does worsen, however, and studies suggest that approximately 10-15% of people with MCI eventually develop Alzheimer's disease. MCI also affects a person's language ability, judgment, and reasoning. Prevalence and incidence rates of MCI vary as a result of different diagnostic criteria as well as different sampling and assessment procedures (Petersen et al, 2001. Current concepts in mild cognitive impairment. Arch Neurol 58: 1985-1992.).

Precise understanding/awareness of the magnitude and pattern of MCI is of importance because early intervention might delay progression to Alzheimer's disease, the most common type of dementia. People with MCI develop dementia at a rate of 10-15% per year, while the rate of memory loss for healthy aging individuals is 1-2% per year (Ibid). It is estimated that approximately 20% of people over the age of 70 have MCI.

Dementia is the most serious form of memory impairment, a condition that causes memory loss that interferes with a person's ability to perform everyday tasks. In dementia, memory becomes impaired, along with other cognitive skills, such as language use (e.g., inability to name common objects), judgment (e.g., time and place disorientation), and awareness (ability to recognize familiar people). The most common type of dementia is Alzheimer's disease.

Alzheimer's disease affects 5.3 million Americans and is the sixth leading cause of death in the United States. According to the Alzheimer's Association, by the year 2030 as many as 7.7 million Americans will be living with Alzheimer's disease if no effective prevention strategy or cure is found. By 2050, the number is projected to skyrocket to 11-16 million. Ten million baby boomers are expected to develop the disease. According to Alzheimer's Disease International, approximately 30 million people worldwide suffer from dementia and about two-thirds of them live in developing countries. In people younger than 65 years of age, dementia affects about 1 person in 1000. In people over the age of 65, the rate is about 1 in 20, and over the age of 80, about 1 in 5 people have dementia. According to the National Institute of Aging, between 2.4 and 4.5 million people in the United States have Alzheimer's disease.

TABLE 1
Some examples of the types of memory problems common in normal age-
related forgetfulness, mild cognitive impairment, and dementia:

Normal Age-Related Forgetfulness
Sometimes misplaces keys, eyeglasses, or other items.
Momentarily forgets an acquaintance's name.
Occasionally has to “search” for a word.
Occasionally forgets to run an errand.
May forget an event from the distant past.
When driving, may momentarily forget where to turn; quickly orients self.
Mild Cognitive Impairment (MCI)
Frequently misplaces items.
Frequently forgets people's names and is slow to recall them.
Has more difficulty using the right words.
Begins to forget important events and appointments.
May forget more recent events or newly learned information.
May temporarily become lost more often. May have trouble understanding
and following a map.
Worries about memory loss. Family and friends notice the lapses in memory.
Dementia
Forgets what an item is used for or puts it in an inappropriate place.
May not remember knowing a person.
Begins to lose language skills. May withdraw from social interaction.
Loses sense of time. Doesn't know what day it is.
Has serious impairment of short-term memory. Has difficulty learning and
remembering new information.
Becomes easily disoriented or lost in familiar places, sometimes for hours.
May have little or no awareness of cognitive problems.

Cognitive decline manifests as shortcomings related to simple reasoning about items relationships, visual-spatial abilities and working and episodic/verbal memory.

Reasoning decline manifests as a decline or a compromise in the ability to perform tasks (exercises) involving simple reasoning relationships, e.g., tasks related to inferring into the future the next immediate action/step (or a number of future actions/steps) in a process involving a number of past correlated actions/steps (e.g., figuring out the next number/letter/shape in a series of numbers/letters/shapes).

Memory decline manifests as an inability to solve or ameliorate learning gridlocks arising from cognitive functions such as working/short-term memory (e.g., processing, storage, retrieval and/or disposal of relevant/irrelevant information.) Memory decline resulting in learning domain problems is manifested by, e.g., alphabet learning; forgetting lengthy instructions; place keeping errors (e.g., missing out letters or words in sentences); failure to cope with simultaneous processing and storage demands.

Visual-spatial decline manifests as e.g., difficulty in complex pattern recognition; difficulty in arranging picture pieces of different/same shapes and sizes together to assemble a complete picture (shape closure, e.g., cannot do puzzles); difficulty to follow complex spatial directions; and recollection of objects' spatial location (misplacement of car keys, wallet, watch, etc.)

In one aspect, the subject matter disclosed herein provides a non-pharmacological approach to enhance and enable cognitive competences via delaying or preventing working/short-term memory decline.

The term working memory (WM) refers to a brain system that provides temporary storage and manipulation of the information necessary for such complex cognitive tasks as, language comprehension, learning, and reasoning. It is widely accepted that WM has been found to require the simultaneous storage and processing of information. The central executive component of working memory, which is assumed to be an attentional-controlling system, is significant/crucial in skills such as learning an alphabet and is particularly susceptible to the effects of Alzheimer's disease. WM is strongly associated with cognitive development and research shows that its capacity tends to drop with old age and that such decline begins already at the early age of 37 in certain populations. That is, the potential market for delaying memory decline in normal aging population is about 50% of the total global population.

In another aspect, the subject matter disclosed herein provides a novel non-pharmacological cognitive training to hinder forgetfulness and cognitive ability loss in normal aging baby boomers by promoting brain (neuronal) plasticity. Brain/neuronal plasticity refers to the brain's ability to change in response to experience, learning and thought. The most accepted evidence about the occurrence of brain plasticity is when training increases the thickness or volume of neural structures (Boyke et al. Training-Induced Brain Structure Changes in the Elderly. The Journal of Neuroscience, Jul. 9, 2008; 28(28):7031-7035; 7031). However, a more common finding is a change in neural activity with mental training. The change can be manifested in the activation of new regions or in measurements of decrease or increase of neural activity in task-related structures that were activated before the training There is a body of overwhelming literature suggesting that enhanced neural activity is facilitated for old adults, and there are data supporting the finding that training enhances neural activation and behavioral function in older adults (Nyberg et al. Neural correlates of training-related memory improvement in adulthood and aging. Proc Natl Acad Sci USA. 2003; 100(23):13728-13733 and Carlson et al. Evidence for neurocognitive plasticity in at-risk older adults: the experience corps program. J Gerontol Biol Med Sci. 2009; 64(12):1275-1282.). In short, as the brain receives specific sensorial input, it physically changes its structure, e.g., via forming new neuronal connections.

In another aspect, the subject matter disclosed herein provides a novel non-pharmacological, non-invasive sensorial biofeedback psychomotor application designed to exercise and recreate the developmentally early neuro-linguistic aptitudes of an individual that can be effective in slowing down aging and restoring optimal neuroperformance.

Early Childhood Language Development:

Scientists have found that language development begins before a child is even born, as a fetus is able to identify the speech and sound patterns of the mother's voice. By the age of four months, infants are able to differentiate sounds and even read lips. Infants are able to distinguish between speech sounds from all languages, not just the native language spoken in their homes. Nonetheless, this remarkable ability disappears around the age of 10 months and children begin to only recognize the speech sounds of their native language. By the time a child reaches age three, he or she will have a vocabulary of about 3,000 words.

Ontology of Cognitive Development:

The current understanding of cognitive development stages in humans is loosely based on observations by Piaget (Piaget's stages). Piaget identified four major stages during the cognitive development of children and adolescents: sensorimotor (birth-2 years old), preoperational (2-7 years old), concrete operational (7-11 years old) and formal operational (adolescent to adult). Piaget believed that at each stage, children demonstrate new intellectual abilities and increasingly complex understanding of the world.

The first stage, sensorimotor, involves the use (acting) of sensorial, motor, and perceptual activities (i.e., modal systems), without the use of symbols, e.g., alphabets, numbers, or other representations, (i.e., amodal systems). At the sensorimotor stage, because acquaintance/familiarity with objects or symbols is absent or limited at this stage, infants cannot predict reaction, and therefore must constantly experiment and learn reaction through trial and error. Importantly, early language development begins during this stage.

Thus, at this first stage, infants perform (execute/deploy) actions for the sake of action (i.e., an action performed without any objective or end goal). Notably, while infants successfully implement (act) sensory-motor kinematics in their egocentric space, these sensory-motor kinematics establish informational interrelations, correlations and cross-relations among manipulated objects and at this stage, the infants do so by relying solely on limited information namely information limited to the sensory-kinematical properties of the manipulated objects, without the benefit of familiarity/understanding, or awareness of the representational capacity that symbols can directly afford to the manipulated objects. In other words, infants engage in fluid intelligence operations of inductive “reasoning processes kind,” deploying or executing sequences of actions with manipulated objects, without really understanding why they are acting this or that way with the said objects and this is what is herein meant by deploying actions for the sake of actions (also referred to herein as “motor-motion for the sake of motor-motion”), without the benefit of the representational powers (knowledge) of symbols related to the sensory-motor manipulated objects.

Language development is one of the hallmarks of preoperational stage (2-7 years old period) where memory and imagination also develop. In this stage, children engage in “make believe” and can understand and express basic relationships between the past and the future. More complex temporal relationships and concepts linking past-present and future, such as cause and effect relationships, have not yet been learned at this stage. In relation to the latter said, fluid Intelligence can be characterized as egocentric, intuitive and illogical. In the later stages of cognitive development, the concrete operational stage (ages 7-11) and formal operational stage (adolescent to adult), crystalized intellectual development is achieved through the use of logical and systematic manipulation of representational informational qualities/attributes of symbols. Thus, it can be said that the cognitive edifice is finally formed when the representational power of symbols is introduced into the cognitive landscape. While in the concrete operational stage symbols are related to concrete objects and thinking involves concrete references, in the formal operational stage symbols are related to abstract concepts and thinking involves abstract informational relationships and concepts.

According to Piaget, when formal operational thought is attained, no new structures are needed. Intellectual development in adults is therefore thought to proceed by developing more complex schema through the addition of symbolic knowledge. However, as discussed below, the process of neuronal “pruning” that occurs during normal ontological development of the brain inherently places enormous limitations and challenges, which restrain the nature and amount of additional formal operational knowledge acquired in adulthood, even more pronounced/particularly when the aging brain is facing pathological changes, e.g., neuro-degeneration.

The non-pharmacological technology disclosed herein addresses this challenge via a new kind of cognitive training that enhances the predisposition for the implicit acquisition of new fluid intelligence performance and competence subsequently promoting neural-linguistic plasticity mainly via novel inductive reasoning strategies that administer to a subject in need thereof, a novel neuro-linguistic cognitive platform supported by novel serial and statistical properties of the alphabet and natural numbers. This can be achieved effectively via novel interactive computer-based cognitive training regimens, which promote neuronal plasticity across functionally different and distant areas in the brain, particularly hemispheric-related neural-linguistic plasticity.

With respect to the stages of cognitive development described above, it is noteworthy to mention that in despite of the fact that there is no explicit learning awareness at the sensorimotor stage (i.e., fluid intelligence “inductive reasoning” stage), early language development begins during this stage. The conceptual understanding of fluid intelligence operational competences such as inductive reasoning and spatial orienting abilities and their temporal relationship to early language development, is a key feature on which the non-pharmacological technology disclosed herein is based (it's undeniable the seminal role played by fluid intelligence skills principally inductive-deductive reasoning and spatial orienting abilities in the early shaping of language acquisition. More so, efficient processing speed of sensorial-perceptual information and how this information is manipulated and retrieve from memory (e.g., alphanumeric information manipulation in working memory and retrieval from long term memory) are developmental markers sub-serving future cognitive skill and behavior. More so, fluid intelligence skills do shape language acquisition in early human cognitive life so “grounding” brain cognitive functioning to a timely successfully launch of crystalized intelligence abilities during late childhood).

When cognitive decline exceeds the norm of what is expected during normal aging, the individual becomes diagnosed with MCI. Clinically, MCI is not precisely defined and is difficult to distinguish from normal aging. Approximately 50% of MCI subjects develop dementia and of those approximately 50% end up with Alzheimer's. In MCI, cognitive dysfunction occurs across many areas (i.e., not localized) in the brain, making it problematic to pinpoint whether what is observed is a pathology or just a symptomatic behavior of massive cognitive decline. MCI subjects over the age of 55 transition to Alzheimer's by the time they are 60-63. At this stage, neuroimaging shows that their brain is shrinking, which means the problem has transitioned to the physiological structure of the brain and soon biochemical imbalance follows, which is triggered by neuronal death, which is incurable.

The novel non-pharmacological technology disclosed herein comprises novel audio-visual-tactile means aimed at exercising different serial orders of symbols sequences (numbers, letters, alphanumeric, etc.). The exposure to this novel non-pharmacological technology at the MCI stage may not only delay, but perhaps event prevent onset of dementia and Alzheimer's. In subjects with dementia and Alzheimer's, the novel non-pharmacological technology can delay or maintain the individual in the milder first phase of dementia for a longer period (this parameter is measured as a population). There are 3-4 stages of Alzheimer's. At later more severe stages (stages two and above), the subjects become violent and their care poses an enormous burden on caretakers. Thus, by maintaining milder phases for a longer period, this novel non-pharmacological technology can bring social relief to caretakers of subjects with dementia and Alzheimer's.

The Brain as a “Muscle”—Neural Systems Morphology Versus Functionality:

The reasons the present non-pharmacological technology rejects for the most part the brain's analogy to just being a “muscle,” and views it as too simplistic and short sighted are: (a) Aging is a time dependent process where cognitive performance and competencies gradually decline across multiple functional domains; as the brain neural machinery (e.g., the popular descriptive analogy of the brain been like a muscle) ages, its related cognitive abilities deteriorate also, thus a decrease of skills despite robust practice-time is also expected; (b) Muscles are not biologically complex enough to emulate thought, affection and language-related psychomotor activity by their own, nor do they capture or resemble a person's identity in any shape or form; and (c) The functional organization displayed by the nervous system is by far more complex than the body's morphological organization. The peripheral and central nervous systems are nourished by a fabric of temporal signals and disturbances that impose non-linear complex informational constrains upon the body's skeletal and muscular physical structures. This complex temporal fabric of the nervous systems consists in multiple layers of biological clocks that interact with each other at multiple levels of biological organization (e.g., cellular, organs, systems, etc.) within the body's internal milieu and act-react differently to temporal events outside the body (e.g., circadian rhythms). The timing and synergic cycling properties of these biological clocks gradually become out of sync as we age and our cognitive and motor neuroperformance (performance and ability competence) suffers.

Grounded Cognition; Symbol Grounding Problem (SGP):

The theory of grounded/embodied cognition holds that all aspects of cognition are shaped by aspects of the body. These aspects of cognition include high level mental constructs (such as concepts and categories) and human performance on various cognitive tasks (such as reasoning or judgment). The aspects of the body include the motor system, the perceptual system, the body's interactions with the environment (situatedness) and the ontological assumptions about the world that are built into the body and the brain. A core principle of grounded cognition is that cognition shares mechanisms with perception, action and introspection.

Standard theories of cognition assume that knowledge resides in a semantic memory system separate from the brain's modal sensorial systems for perception (e.g., vision, audition, touch), action (e.g., movement, proprioception) and introspection (e.g., mental states, affect).

According to standard theories of cognition, representations in modal sensorial systems are transduced into amodal symbols that represent knowledge about experience in semantic memory. Once this knowledge exists, it is assumed it supports the spectrum of cognitive processes from perception to thought.

Usually, the symbols constituting a symbolic system neither resemble nor are causally linked to their corresponding meaning. They are merely part of a formal, notational convention agreed upon by its users. One may then wonder whether an Artificial Agent AA (or indeed a population of them) may ever be able to develop an autonomous, semantic capacity to connect symbols with the environment in which the AA is embedded interactively. This is to many the core issue of the SGP.

As Hamad phrases the SGP, “how can the semantic interpretation of a formal symbol system be made intrinsic to the system, rather than just parasitic on the meanings in our heads?” In other words, the question is: how can the meanings of the meaningless symbol tokens, which are manipulated solely on the basis of their (arbitrary) shapes, be grounded in anything but other meaningless symbols? (Hamad 1990). Hamad uses the Chinese Room Argument (Searle 1980) to introduce the SGP. An AA, such as a robot, appears to have no access to the meaning of the symbols it can successfully manipulate syntactically. It is like someone who is expected to learn Chinese as his/her native language by consulting a Chinese-Chinese dictionary. Both the AA and the non-Chinese speaker are bound to be unsuccessful, since a symbol's mere physical shape and syntactic properties normally provide no clue as to its corresponding semantic value or meaning, the latter being related to the former in a notoriously, entirely arbitrary way.

In practical terms, the key question posed by the SGP is how a modal sensorial perceptual representation (e.g., a picture of a person slicing a cucumber) is converted into an amodal symbolic representation (e.g., writing/spelling out the letters—“slicing the cucumber” on a piece of paper/computer)

Sensory-Visual Perception:

When a visual stimulus is received in the retina, the light stimulus is segregated along the brain in two distinct neural pathways—one neural pathway, the Parvocellular “ventral” pathway is directed towards the inferior temporal cortex (ITC) and resolves information concerning shape, size and color of fovea it items (e.g., visual pattern recognition of objects and their related features). (See Ungerleider L. G. & Mishkin M. (1982), in Ingle D. J. Goodale M. A. & Mansfield R. J. W. (eds.). Analysis of visual behavior (549-586). MIT Press) (See also Goodale M. A. & Milner D. (1992), in Baars B. J. Banks W. P. & Newman J. B. (eds.). Essential sources in the scientific study of consciousness, MIT Press.) This visual neural pathway in the brain is commonly referred as the “what” is it?, and the other neural pathway, the Magnocellular “dorsal” pathway is directed towards the posterior parietal cortex (PPC) and resolves information concerning the state of motion of visual stimuli and coarse outlines of objects (e.g. computes time to collision when we move around objects and visually coding boundaries\edges of (moving) objects). Milner and Goodale describe a model where there is a visual system for perception and there is another visual system for planning “action” (e.g., ballistic pointing movements considered the simplest reaching movements), that is, the dorsal stream reaches more specialized areas in the parietal-frontal cortex of the monkey brain like the neural network area VIP-F4 which serves to prepare goal directed action (See Milner D. & Goodale M. A. (1995) The visual brain in action, Oxford University Press). Additionally, the dorsal visual neural pathway serves as a good example of how the brain neural overlaps, grounds cognition with the environment (e.g., when there is a need for planning and deploying motor reaching movements) and is commonly referred by the Milner and Goodale model as the “where/how” is it?

In humans, brain hemispheric control and perceptual span contribute to orthographic processing of visually perceived symbols. The perceptual span of the human eye constitutes about 12 symbols. Sensory perception by the right visual field (RVF) is controlled by the left hemisphere of the brain and the left visual field (LVF) is controlled by the right hemisphere. When reading, the eyes are on the move at all times. Words can only be identified during very brief ‘fixations’ time periods lasting about ¼th of a second (during which the eyes are in continuous motion). Around the fixation point (sharpest foveal acuity) only four to five symbols (e.g., letters, numbers etc.,) are seen with 100% acuity. In the LVF, the strongest serial neuronal firing is to the first and middle symbol in the sequence, not to the last symbol. In the RVF, the strongest serial neuronal firing is to the first, middle and last symbol in the sequence.

Orthographic Sequential Encoded Regulated by Inputs to Oscillations within Letter Units (‘SERIOL’) Processing Model:

According to the SERIOL processing model, orthographic processing occurs at two levels—the neuronal level, and the abstract level. At the neuronal level, orthographic processing occurs progressively, beginning from retinal coding (e.g., sequential position of letter symbols within a sequence), followed by letter symbols spatial related attributes-feature coding (e.g., lines, angles, curves), and ending with letter symbols coding (coding for letter symbols nodes according to temporal neuronal firing.) (Whitney. How the brain encodes the order of letters in a printed word: the SERIOL model and selective literature review. Psychonomic Bulletin & Review 2001, 8 (2), 221-243.)

Cognitive, Affective and Psychomotor Competencies are Affected by Native Language Acquisition:

As noted earlier in the present disclosure, native language acquisition occurs during childhood, a period of rapid increase in brain volume. At this point in childhood development, the brain has many more neural connections than it will ever have, enabling us to be far more apt to implicitly acquire new information than as adults. As a rule of thumb, much of the knowledge acquired in life is learned implicitly. Native language acquisition is no exception; it is acquired unaware or without any explicit intention of learning. From a developmental point of view, native language acquisition is an extraordinary sensitive developmental neural period that engages us entirely: namely our cognitive, affective, and psychomotor domains. More so, our adult clarity of thought and expression is only possible when we have mastered a sufficient automatic command of our native language. Usually, a weakness in a specific skill results in a drawback in that particular skill only, but weakness in our ability to automatically command our native language results in the paralysis of all thought and of our power of expression.

Neurocognitive research has confirmed that native language acquisition and early cognitive development are strongly linked, and when language acquisition is delayed or impaired, it affects our ability to internalize basic concepts/actions and also causes deficiencies in emotional and psychomotor skills. There are strong intuitive reasons to believe that human cognition as a whole revolves around mental non-concrete symbolic representations that are alphanumeric language-based.

Language and Time Internalization:

The non-pharmacological technology disclosed herein approaches the evolution of the central nervous system in the brain with a multidisciplinary view, emphasizing the brain neural developmental sensitive time periods and the way they manifest within the body's complex temporal biological organization. Early language acquisition is herein considered as a landmark developmental sensitive event that enables neural aptitudes in the growing child that allow him/her to internalize the primordial meaning of “time”. More so, during early language acquisition, the growing child self-develops a sensory motor and elemental tacit awareness towards existing and acting in “time”. As the child grows older (about the age of 6-7), his/her understanding about ‘time’ deepens through learning how to count, read and write (orthographic and numerical sequential decoding of symbols sequences) and he/she will further differentiate his/her sensorial-perceptual capacities to successfully mentally manipulate non-concrete symbolic information to understand the existence and acting-actions of others in “time”.

In short, early language acquisition sets initial conditions that pre-dispose the growing child towards meeting the demands of a social evolutionary path where new implicit self-learning and novel grounding (interaction) with the environment not only involves one's brain (e.g., non-concrete mental operations concerning strict egocentric view) but the brains of others (e.g. non-concrete mental operations that take into account/represent/simulate the point of view of others). The present non-pharmacological technology envisions early language acquisition as a unique sensitive neural developmental period, characterized by one of the apexes of neuroplasticity by which the personal, social and cultural identity of an individual comes to life.

Inductive Reasoning Versus Deductive Reasoning:

Inductive reasoning is usually contrasted to deductive reasoning. Inductive reasoning is a process of logical reasoning in which a person uses a collection of evidence gained through observation and sensory experience and applies it to build up a conclusion or explanation that is believed to fit with the known facts. Therefore, inductive reasoning mostly makes broad generalizations from specific observations. By nature, inductive reasoning is more open-ended and exploratory, especially during the early stages. Inductive reasoning is sometimes called a “bottom up” approach; that is, the researcher begins with specific observations and measures, he then searches, detects and isolates patterns and regularities, formulates some tentative hypotheses to explore, and finally ends up developing some general conclusions or theories.

An inductive argument is an argument claimed by the arguing party merely to establish or increase the probability of its conclusion. In an inductive argument, the premises are intended only to be as strong as, if true, it would be unlikely that the conclusion were false. There is no standard term for a successful inductive argument, but its success or strength is a matter of degree (weak or strong), unlike with deductive arguments. A deductive argument is valid or else invalid. Even if all of the premises are true in a statement, inductive reasoning allows for the conclusion to be false. Here's an example: “Harold is a grandfather. Harold is bald. Therefore, all grandfathers are bald.” The conclusion does not follow logically from the statements. Inductive reasoning has its place in the scientific method. Scientists use it to form hypotheses and theories. Deductive reasoning allows them to apply the theories to specific situations.

Deductive reasoning is the opposite of inductive reasoning and is a basic form of valid reasoning. A deductive argument is an argument that is intended by the arguing party to be (deductively) valid, that is, to provide a guarantee of the truth of the conclusion provided that the argument's premises (assumptions) are true. This point can also be expressed by stating that, in a deductive argument, the premises are intended to provide such strong support for the conclusion that, if the premises are true, then it would be impossible for the conclusion to be false. An argument in which the premises do succeed in guaranteeing the conclusion is called a (deductively) valid argument. If a valid argument has true conclusions, then the argument is said to be sound. Deductive reasoning, or deduction, may start out with a general statement, or hypothesis, and examines the possibilities to reach a specific, logical conclusion. Sometimes deductive reasoning is called the “top-down” approach because the researcher starts at the top with a very broad spectrum of information and he works his\her way down to a specific conclusion. Deductive reasoning may be narrower and is generally used to test or confirm hypotheses. It can then be said in general that the scientific method uses deduction to test hypotheses and theories. In deductive reasoning, if in the argument premise is something true about a class of things in general, it is also true in the logical conclusion for all members of that class of things. For example, “All men are mortal. Harold is a man. Therefore, Harold is mortal.” For deductive reasoning to be sound, the hypothesis must be correct. It is assumed that the premises, “All men are mortal” and “Harold is a man” are true. Therefore, the conclusion is logical and true. It is possible to come to a logical conclusion even if the generalization is not true. If the generalization is wrong, the conclusion may be logical, but it may also be untrue. For example, the argument, “All bald men are grandfathers. Harold is bald. Therefore, Harold is a grandfather,” is valid logically but it is untrue because the original statement is false.

Fluid Intelligence Versus Crystallized Intelligence:

Fluid intelligence is our reasoning and problem solving ability in new situations. It lies behind the use of deliberate and controlled mental operations to solve novel problems that cannot be performed automatically. Mental operations often include drawing inferences, concept formation, classification, generating and testing hypothesis, identifying relations, comprehending implications, problem solving, extrapolating, and transforming information. Inductive and deductive reasoning are generally considered the hallmark indicators of fluid intelligence. Fluid intelligence has been linked to cognitive complexity which can be defined as a greater use of a wide and diverse array of elementary cognitive processes during performance.

In general, fluid intelligence tests typically measure deductive reasoning, inductive reasoning (matrices), quantitative reasoning, and speed of reasoning. For example, these tests may assess novel reasoning and problem solving abilities; ability to reason, form concepts and solve problems that often include novel information or procedures; basic reasoning processes that depend minimally on learning and acculturation; manipulating abstractions, rules, generalizations, and logical relations.

More specific fluid intelligence tests measure narrower abilities. For example, such tests may assess general sequential reasoning, quantitative reasoning, Piagetian reasoning, or speed of reasoning. General sequential reasoning abilities include, e.g., the ability to start with stated rules, premises, or conditions, and to engage in one or more steps to reach a solution to a problem; induction, the ability to discover the underlying characteristic (e.g., rule, concept, process, trend, class membership) that governs a problem or a set of materials. Quantitative reasoning abilities include, e.g., the ability to inductively and deductively reason using concepts involving mathematical relations and properties. Piagetian reasoning abilities include, e.g., seriation, conservation, classification and other cognitive abilities as defined by Piaget. Speed of reasoning abilities is not clearly defined.

Crystallized intelligence is the ability to use skills, knowledge and experience or in other words, the amount of information you accumulate and the verbal skills you develop over time. Together, these elements form your crystallized intelligence. According to psychologist Raymond Cattell, who developed the concept in the 1980s to explain intelligence, crystallized intelligence comprises the skills and knowledge acquired through education and acculturation. It is related to specific information and is distinct from fluid intelligence, which is the general ability to reason abstractly, identify patterns, and recognize relations. Applying old knowledge to solve a new problem depends on crystallized intelligence; for example, the ability to use one's knowledge of ocean tides to navigate unfamiliar seas. Cattell believed that crystallized intelligence interacts with fluid intelligence. Many psychologists believe that crystallized intelligence increases with age, as people learn new skills and facts; however, researchers disagree about the precise relation between crystallized intelligence and age.

In general crystallized intelligence tests may measure, the breadth and depth of knowledge of a culture; abilities developed through learning, education and experience; storage of informational declarative and procedural knowledge; ability to communicate (especially verbally) and to reason with previously learned procedures; abilities that reflect the role of learning and acculturation. Crystallized intelligence is not the same as achievement.

More specific tests of crystallized intelligence measure narrower abilities. For example, such tests may assess language development, lexical knowledge, listening ability, general (verbal) information, information about culture, general science information, general achievement, communication ability, oral production and fluency, grammatical sensitivity, foreign language proficiency and foreign language aptitude. Language development abilities include, general development, or the understanding of words, sentences, and paragraphs (not requiring reading), in spoken native language skills. Lexical knowledge abilities include, e.g., the extent of vocabulary that can be understood in terms of correct word meanings. Listening ability may assess, e.g., the ability to listen and comprehend oral communications. General (verbal) information abilities include, e.g., the range of general knowledge. Information about culture includes e.g., the range of cultural knowledge (e.g., music, art). General science information abilities include, e.g., the range of scientific knowledge (e.g., biology, physics, engineering, mechanics, electronics). Geography achievement abilities include, e.g., the range of geographic knowledge. Communication ability includes, e.g., ability to speak in “real life” situations (e.g., lecture, group participation) in an adult-like manner. Oral production and fluency abilities include, e.g., more specific or narrow oral communication skills than reflected by communication ability.

Grammatical sensitivity abilities include, e.g., knowledge or awareness of the grammatical features of the native language. Foreign language proficiency abilities are similar to language development, but for a foreign language. Foreign language aptitude includes e.g., rate and ease of learning a new language.

Inducing Inductive Reasoning: Does it Transfer to Fluid Intelligence

It is generally agreed that inductive reasoning constitutes a central aspect of intellectual functioning. Inductive reasoning is usually measured by tests consisting of classifications, analogies, series, and matrices. Many intelligence tests contain one or more of these tests therefore the contribution of inductive reasoning to intelligence test performance is beyond question. (See Klauer, K. J. and Willmes, K., Contem. Edu. Psychol. 27, 1-25 (2002))

Klauer and Willmes (cited above) discuss that at least four important waves of research have contributed to knowledge about the relationship between inductive reasoning and intelligence. Spearman (1923), the founder of the factor analytical tradition, was convinced that his general intelligence factor g was mainly determined by inductive processes (“education of relations”). Thurstone (1938) used a different factor analytic approach, which led him to a concept of multiple intelligence factors. One of these was the factor “Reasoning” that is made up of a combination of inductive and deductive tests. Cattell (1963) found an adequate solution by making the distinction between fluid and crystallized intelligence. Fluid intelligence is primarily involved in problem solving, whereas crystallized intelligence is involved in acquired declarative knowledge. Fluid intelligence can be understood as at least partially determined by genetic and biological factors, while the crystallized factor is conceived of as a combined product of fluid intelligence and education. Vocabulary tests are typical markers of the crystallized factor, whereas inductive tests typically serve as markers of the fluid factor. Using the method of linear structural equations (LISREL), Cattell's theory of fluid and crystallized intelligence was confirmed. Undheim and Gustafsson also concluded that inductive processes play a major role in fluid intelligence. (Undheim, J.-O., & Gustafsson, J.-E. The hierarchical organization of cognitive abilities: Restoring general intelligence through use of linear structural relations (LISREL). Multivariate Behavioral Research, 22, 149-171. (1987))

Continuing interest in inductive reasoning and fluid intelligence has prompted cognitive researchers to engage in analyzing the processes that occur when subjects solve tasks requiring inductive reasoning. Further, researchers in the field of artificial intelligence have constructed computer programs that attempt to solve certain kinds of inductive-reasoning problems in order to test theories about inductive processes.

Prescriptive Theory of Inductive Reasoning:

In certain non-limiting aspects, the presently disclosed subject matter provides novel exercises, based on, but not derived from, an understanding of the prescriptive theory of inductive reasoning. As such, the present subject matter discloses novel concepts such as spatial or time perceptual related “attribute” and “interrelation, correlation among alphanumeric symbols and cross-correlations among alphanumeric symbols sequences, which concepts are different in their fundamental premises from previously-described concepts, which are mostly based on randomly selected associations among symbols and/or the combinations of symbols and things in the world. In particular, the present subject matter relies exclusively on alphanumeric symbolic sequential and statistical novel information characterized by interrelations, correlations and cross-correlations among symbols and symbol sequences.

In general, a prescriptive theory does not describe how subjects actually proceed when solving problems—there is presumably an infinite number of ways to solve inductive problems, depending on the type of problem as well as on different experiential backgrounds and idiosyncrasies of the problem solver.

Unlike descriptive theories, a prescriptive theory delineates what to do when a problem has to be solved by describing those steps that are sufficient to solve problems of the type in question. A prescriptive theory of inductive reasoning specifies the processes considered to be sufficient to discover a generalization or to refute an overgeneralization. Obviously, such a theory can be tested in a straightforward manner by a training experiment for transfer. Participants trained to apply an efficient strategy to solve inductive problems should outperform subjects who did not have this training, given that the subjects are not already highly skilled in solving inductive problems. Thus, children would seem to be likely candidates for the training of inductive reasoning strategies.

Inductive reasoning enables one to detect regularities and to uncover irregularities. These are conceptually illustrated in the above cited publication by Klauer and Willmes, and reproduced herein. (See Klauer, K. J. and Willmes, K., Contem. Edu. Psychol. 27, 1-25 (2002)).

As shown in Table 2 herein, Klauer and Willmes suggest that inductive reasoning is accomplished by a comparative process, i.e., by a process of finding out similarities and/or differences with respect to attributes of objects or with respect to relationships between objects. Conceptualizing the definition of inductive reasoning this way implies that inducing adequate comparison processes in learners would improve the learners' abilities of inductive reasoning.

Specifically, Table 2 makes use of an incomplete form of a mapping sentence as developed by Guttman. The three facets A, B, and C consist of 3, 2, and 5 elements, respectively. Accordingly, 3=2×5=30 varieties of inductive reasoning tasks are distinguished.

TABLE 2
Inductive reasoning consists in finding out regularities
and irregularities by detecting

| | | |
|---|---|---|
| A $\{ \begin{matrix}a 1 similarities \\ a 2 differences \\ a 3 similarities \\ \& differences\end{matrix} \}$ | of | B $\{ \begin{matrix}b1 attributes \\ b2 relations\end{matrix} \}$ |

C $with respect to \{ \begin{matrix}c1 verbal \\ c2 pictoral \\ c3 geometrical \\ c4 numerical \\ c5 other\end{matrix} \} objects or n \text{-} tuples of objects .$

Facets A and B constitute six types of inductive reasoning. Table 3 specifies these six types in some detail. The table presents the designations given each of the six types of inductive reasoning, moreover the facet identifications, the item formats used in psychological tests, and the cognitive operations required by them.

Table 4 shows an overview of the genealogy of inductive reasoning tasks for the six types of tasks defined by Facets A and B. The inductive reasoning strategy refers to the comparison process which deals either with comparing attributes of objects (left-hand branch of the genealogy) or with relations between objects (right-hand branch). In any case, one is required to search for similarity, for difference, or both similarity and difference. In this way one detects commonalities and difference. The item classes “cross classification” and “system formation” require one to take notice of both the same and a different attribute or the same and a different relationship. That is the reason why these item classes represent the most complex inductive problems—the problem solver must deal with two or more dimensions simultaneously.

TABLE 3
Types of Inductive Reasoning Problems

| | Facet | Problem | Cognitive operation |
|---|---|---|---|
| Process | identification | formats | required |
| Generalization (GE) | a₁b₁ | Class formation | Similarity of attributes |
| | | Class expansion | |
| | | Finding common attributes | |
| Discrimination (GE) | a₂b₁ | Identifying irregularities | Discrimination of |
| | | | attributes (concept |
| | | | differentiation) |
| Cross-Classification | a₃b₁ | 4-fold scheme | Similarity & difference |
| (CC) | | 6-fold scheme | in attributes |
| | | 9-fold scheme | |
| Recognizing | a₁b₂ | Series completion | Similarity of |
| Relationships | | ordered series | relationships |
| (RR) | | analogy | |
| Differentiating | a₂b₂ | Disturbed series | Differences in |
| Relationships (DR) | | | relationahips |
| System Construction | a₃b₂ | Matrices | Similarity & difference |
| (SC) | | | in relationships |

TABLE 4
Genealogy of tasks in inductive reasoning

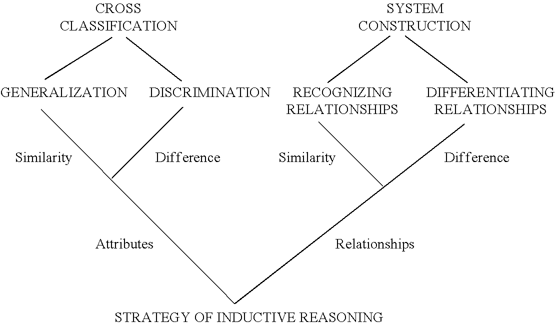

Advantages of the Present Non-Pharmacological Technology Over Digital Brain Fitness and Other Cognitive Interventions:

The present non-pharmacological technology aims to stimulate a new neuroplasticity apex in normal aging individuals in general and in mild neurodegenerative elderly individuals in particular. The present non-pharmacological technology is a new cognitive intervention platform, which regime of performance aims to enable an efficient transfer of fluid (inductive/abstract reasoning, spatial orientation operations, novel problem solving, adapt to new situations) and related crystalized intelligence competences (e.g., declarative-verbal knowledge) to everyday demanding tasks by promoting implicit acquisition of rules, concepts and schema governing sequential and statistical patterns and patterns closure of symbolic information in one's native language alphabet and in numerical series. To that effect, the present technology achieves its goal via a new cognitive intervention platform of exercises based on interactive (and passive at times) exposures to novel strategies consisting in a suite of phonological-visual sequential patterns of serial and statistical symbolic knowledge encoded in one's native alphabet and/or in numerical series. The present non-pharmacological technology aims to effectively recreate threshold plastic neuro-linguistic conditions potentially capable of giving birth and sustaining a language-sensitive neural period, predisposing the brain of the aging individual to a new and safe opportunity, although late, for native symbolic language acquisition.

As such, a brain fitness approach which mainly emphasizes “practice time,” is only a partial and limited solution (non-transferable cognitive skills) to brain fitness, health and wellness. Therefore, a brain fitness, health and wellness computer training program that claims to mainly exercise the brain by adopting the analogy of “use it or lose it,” as if the brain was just a “muscle,” is a program that works on material pieces consisting of muscles, tendons and bones and claims benefits that embrace the entire structure and functions of the body. This mechanistic, shortsighted approach to computer brain neuroperformance lacks proper understanding of the complex temporal reciprocal interactions, coordination and synergies that take place at multiple levels of biological functional organization which strongly constrain the body's physical structures and result in cognitive-mental and neuromuscular healthy behaviors.

More so, the notion that a few daily puzzles and quizzes can sharpen the intellect and stave off cognitive decline is controversial. Most research in the field has shown that these brain games do little than to allow the participant to develop strategies for improving performance on the particular task at hand. The improvement does not typically extend beyond the game itself. Still, research has also found that “there were absolutely no transfer effects” from the training tasks to more general tests of cognition. In other words, the expectation that the computer training available nowadays will improve overall mental sharpness by training only one aspect of the mind, such as memory, is presently unfounded.

Instead, the presently disclosed subject matter predicates a more physiological sound approach to brain fitness, based in a new cognitive training mainly focused on sensorial-motor-perceptual and fluid mental skills' exercises of symbolic alphanumeric sequential and statistical information, that aims to ensure that the aging individual attains, as a primary goal, stable cognitive neuroperformance, and in time (after 6 to 12 months of cognitive training), novel problem solving strategies transferring to functional benefits in daily (demanding) tasks. Further, the subject matter disclosed herein serves as a cognitive aptitude enhancement to a subpopulation of healthy normally aging individuals. To that effect, the presently disclosed subject matter predicates a one of its kind non-pharmacological, cognitive symbolic language fitness intervention technology, where the end-user exercises novel strategies related to his/her fluid and crystallized intelligences in order to delay the normal aging process or reverse or postpone a state of mild neuro-degeneration in elderly neuro-pathology. These fluid and crystallized intelligence abilities consist of: inductive reasoning, spatial orienting, audio-visual processing speed, related memory processes (working memory, episodic etc.), psychomotor abilities (to operate and mobilize relevant biological knowledge within one's native language alphabet and natural number series [symbolic alphanumeric information], and to mobilize physiological bottom-up and top-down processes to assist in stabilizing related cognitive functions). Accordingly, the subject matter disclosed herein disclosed primes our structural-temporal-social brains to stabilize and enhance the performance of a number of cognitive functions which bring about competence gains due to the increased neural sensitivity. This new epoch of neural sensitivity promotes robust implicit learning of alphanumeric sequential and statistical information. Yes, in a certain way an aging adult's brain will experience the neuroperformance benefits of a child's brain again!

The subject matter disclosed herein provides a comprehensive cognitive intervention based on new exercising of alphabetical/numeric symbolic information and novel strategies concerning problem solving aimed to promote stability and sustain neuroperformance conditions in the aging population, which represents a paradigm shift in the way people view and think about the common usage of alphabetical knowledge in general, and about the way people think and operate with numbers (numerical series) in particular. Specifically, the subject matter disclosed herein provides an innovative out-of-the-box technological approach which could inspire new multidisciplinary non-pharmacological solutions to prevent and/or delay aging-related memory loss and other cognitive skills decline in normally aging, MCI and moderate Alzheimer's individuals.

Further, the presently disclosed non-pharmacological technology focuses on a new cognitive intervention platform that exercises novel fluid intelligence strategies centering on inductive-deductive reasoning, novel problem solving, abstract thinking, implicit identification of sequential and statistical pattern rules and irregularities, spatial orienting and related crystallized intelligence narrow abilities. Still, the present disclosed non-pharmacological technology also causes efficient interaction of symbolic exercised sequential information in working memory. Accordingly, the presently disclosed new cognitive training successfully primes existing neural networks, sensory-motor and perceptual abilities in the aging individual, enabling a new epoch of neural sensitivity similar to the ontological development characterized by early symbolic language acquisition. Successful performance of these basic cognitive symbolic alphabetical-numeric exercises is determinant to ensure proper neuro-linguistic-numeric symbolic development, instrumental namely in mastering one's native language, number operational knowledge and the role of numbers in language comprehension, all of which assist to competent copying with a wide range of basic daily (demanding) tasks.

In terms of development, early symbolic language acquisition is considered to be a most sensitive period, triggered and supported by neuronal plasticity. The early symbolic language acquisition enable the fast development of higher brain executive functions and competence aptitudes such as fluid intelligence abilities (e.g. inductive-deductive reasoning, novel problem solving etc.,) which supported by an efficient manipulation and processing of symbolic information in working memory, it later develops the ability to explicitly verbally learn facts sequentially and associatively.

### Methods

The definition given to the terms below is in the context of their meaning when used in the body of this application and in its claims

A “series” is defined as a sequence of terms

“Serial terms” are defined as the orderly components of a series.

A “serial order” is defined as a sequence of terms characterized by: (a) the relative spatial position of each term and the relative spatial positions of those terms following and/or preceding it; (b) its sequential structure: an “indefinite serial order,” is defined as a serial order where no first neither last term are predefined; an “open serial order.” is defined as a serial order where the first term is predefined; a “closed serial order,” is defined as a serial order where only the first and last terms are predefined; and (c) its number of terms, as only predefined in ‘a closed serial order’.

A “string” is defines as any sequence of any number of terms.

“Terms” are represented by any symbols or by only letters, or numbers or alphanumeric symbols.

A “letter string” is defined as any sequence of any number of letters.

A “number string” is defined as any sequence of any number of numbers.

“Terms arrays” are defines as open serial orders of terms.

“Set arrays” are defined as closed serial orders of terms.

“Letter set arrays” are defined as closed serial orders of letters, wherein same letters may be repeated.

An “alphabetic set array” is a closed serial order of letters, wherein all letters are different (not repeated), where each letter is a particular member of a set, and where each of these members has a different ordinal position in the set array. An alphabetic set array is herein considered as a Complete and Non-Random letters sequence. Letter symbols are herein only graphically represented with capital letters. For single letter members, we will obtain the following 3 direct and 3 inverse alphabetic set arrays:

Direct alphabetic set array: A, B, C, D, E, F, G, H, I, J, K, L, M, N, O, P, Q, R, S, T, U, V, W, X, Y, Z.

Inverse alphabetic set array: Z, Y, X, W, V, U, T, S, R, Q, P, O, N, M, L, K, J, I, H, G, F, E, D, C, B, A.

Direct type alphabetic set array: A, Z, B, Y, C, X, D, W, E, V, F, U, G, T, H, S, I, R, J, K, L, P, K, O, M, N.

Inverse type alphabetic set array: Z, A, Y, B, X, C, W, D, V, E, U, F, T, G, S, H, R, I, Q, J, P, K, O, L, N, M.

Central type alphabetic set array: A, N, B, O, C, P, D, Q, E, R, F, S, G, T, H, U, I, V, J, W, K, X, L, Y, M, Z.

Inverse central type alphabetic set array: N, A, O, B, P, C, Q, D, R, E, S, F, T, G, U, H, V, I, W, J, X, K, Y, L, Z, M.

An “ordinal position” is defined as the relative position of a term in a series, in relation to the first term of this series, which will have an ordinal position defined by the first integer number (#1), and each of the following terms in the sequence with the following integer numbers (#2, #3, #4, . . . ) Therefore, the 26 different letter terms of the English alphabet will have 26 ordinal positions which, in the case of the direct set array (see above), ordinal position #1 will correspond to the letter “A”, and ordinal position #26 will correspond to the letter “Z”.

The term “incomplete” serial order refers herein only in relation to a serial order which has been previously defined as “complete.”

As used herein, the term “relative incompleteness” is used in relation to any previously selected serial order which, for the sake of the intended task herein required performing by a subject, the said selected serial order could be considered to be complete.

As used herein, the term “absolute incompleteness” is used only in relation to set arrays, because they are defined as complete closed serial orders of terms (see above). For example, in relation to a set array of terms, incompleteness only involves the number of missing terms; and in relation to an alphabetic set array, incompleteness is absolute, involving at the same time: number of missing letters, type of missing letters and ordinal positions of missing letters.

A “non-alphabetic letter sequence” is defined as any letter series that does not follow the sequence and/or ordinal positions of letters in any of the alphabetic set arrays.

A “symbol” is defined as a mental abstract graphical sign\representation, which includes letters and numbers.

A “letter term” is defined as a mental abstract graphical sign/representation, which is generally, characterized by not representing a concrete: thing/item/form/shape in the physical world. Different languages may use the same graphical sign/representation depicting a particular letter term, which it is also phonologically uttered with the same sound (like “s”).

A “letter symbol” is defined as a graphical sign/representation depicting in a language a letter term with a specific phonological uttered sound. In the same language, different graphical sign\representation depicting a particular letter term, are phonologically uttered with the same sound(s) (like “a” and “A”).

An “attribute” of a term (symbol, letter or number) is defined as a spatial distinctive related perceptual features and time distinctive related perceptual features.

A “spatial related perceptual attribute” is defined as a characteristically spatial related perceptual feature of a term, which can be discriminated by sensorial perception. There are two kinds of spatial related perceptual attributes.

An “individual spatial related perceptual attribute” is defined as a spatial related perceptual attribute that pertains to a particular term. Individual spatial related perceptual attributes include, e.g., symbol case; symbol size; symbol font; symbol boldness; symbol tilted angle in relation to an horizontal line; symbol vertical line of symmetry; symbol horizontal line of symmetry; symbol vertical and horizontal lines of symmetry; symbol infinite lines of symmetry; symbol no line of symmetry; and symbol reflection (mirror) symmetry.

A “collective spatial related perceptual attribute” is defined as a spatial related perceptual attribute that pertains to the relative location of a particular term in relation to the other terms in a letter set array or in an alphabetic set array or in an alphabetic letter symbol sequence. Collective spatial related perceptual attributes include, e.g., in a set array, a symbol ordinal position; the physical space occupied by a symbol; when printed in written form—the distance between the physical spaces occupied by two consecutive symbols\terms; and left or right relative position of a term\symbol in a set array.

A “time related perceptual attribute” is defined as a characteristically temporal related perceptual feature of a term (symbol, letter or number), which can be discriminated by sensorial perception such as: a) any color of the RGB full color range of the symbols term; b) frequency range for the intermittent display of a symbol, of a letter or of a number, from a very low frequency rate, up till a high frequency (flickering) rate. Frequency is denominated as: 1/t, where t is in the order of seconds; c) particular sound frequencies by which a letter or a number is recognized by the auditory perception of a subject.

An “arrangement of terms” (symbols, letters and/or numbers) is defined as one of two classes of term arrangements, i.e., an arrangement of terms along a line, or an arrangement of terms in a matrix form. In an “arrangement along a line,” terms will be arranged along a horizontal line by default. If for example, the arrangement of terms is meant to be along a vertical or diagonal or curvilinear line, it will be indicated. In an “arrangement in a matrix form,” terms are arranged along a number of parallel horizontal lines (like letters arrangement in a text book format), displayed in a two dimensional format.

The terms “generation of terms,” “number of terms generated” (symbols, letters and/or numbers) is defined as terms generally generated by two kinds of term generation methods-one method wherein the number of terms is generated in a predefined quantity; and another method wherein the number of terms is generated by a quasi-random method.

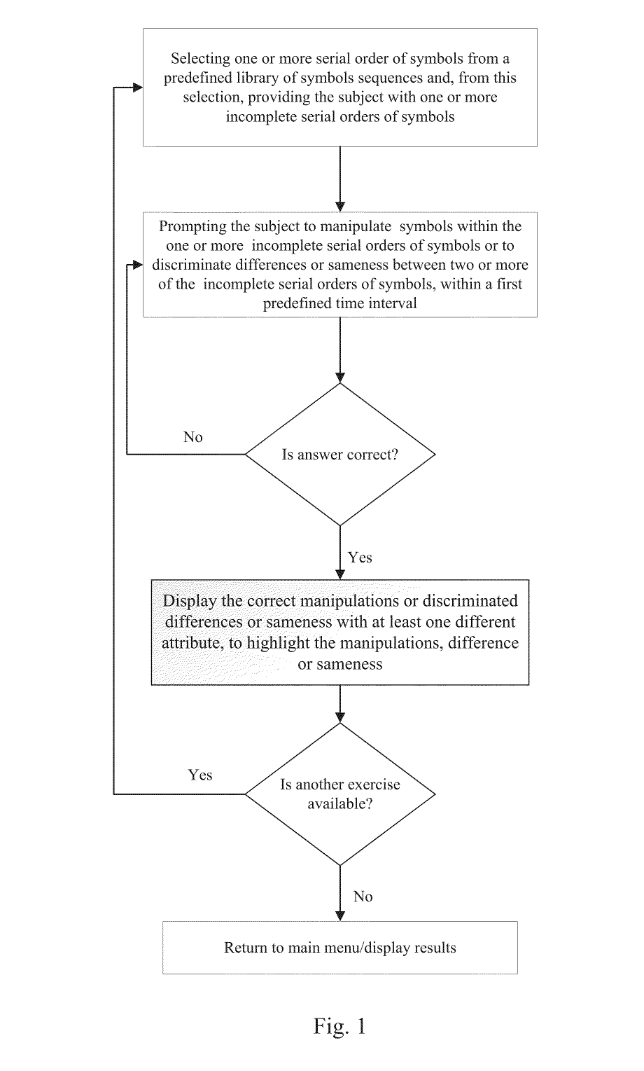

The implementation of the methods for promoting fluid intelligence abilities in a subject are carried out by way of a number of non-limiting exercises that can be used to enhance or promote the fluid intelligence abilities in a subject. By re-engaging the fluid intelligence abilities, the normal aging subject is better equipped to maintain or prolong its functional stability in a number of cognitive performances and abilities, prevent performance decay of basic day to day demanding tasks, and combat the effects, or even reverse the effects of mild cognitive decline. Still, by re-engaging the basic intelligence abilities, the aging elderly subject is in general better equipped to prevent or delay the onset of dementia and in particular postpone the negative manifestation of mild cognitive symptoms in the early stage of Alzheimer's disease. In general, the exercises that have been developed to achieve these aspects of the present subject matter involve a method of promoting fluid intelligence abilities in a subject. FIG. 1 is a flow chart setting forth the broad concepts covered by the specific non-limiting exercises put forth in the Examples below.

As can be seen in FIG. 1, the method of promoting fluid intelligence abilities in the subject comprises selecting at least one serial order of symbols from a predefined library of symbols sequences and providing the subject with an exercise involving at least one unique serial order of symbols obtained from the previously selected serial order of symbols. The subject is then prompted to, within a first predefined time interval, manipulate symbols within the at least one obtained serial order, or to discriminate if there are or not differences between two or more of the obtained serial orders within the exercise. After manipulating the symbols or discriminating if there are or not differences between two or more of the obtained serial orders within the exercise, an evaluation is performed to determine whether the subject correctly manipulated the symbols or correctly discriminated if there are or not differences between the two or more of the obtained serial orders. If the subject made an incorrect manipulation or discrimination, then the exercise is started again and the subject is prompted to again manipulate symbols within the at least one obtained serial order or to discriminate if there are or not differences between two or more of the obtained serial orders within the exercise. If, however, the subject correctly manipulated the symbols or correctly discriminated if there are or not differences between the two or more of the obtained serial orders, then the correct manipulations as well as correct discrimination of differences or sameness, are displayed with at least one different symbol attribute to highlight or remark the manipulation and the discriminated difference or sameness. The above steps in the method are repeated for a predetermined number of iterations separated by second predefined time intervals, and upon completion of the predetermined number of iterations, the subject is provided with the results of each iteration. The predetermined number of iterations can be any number needed to establish that a proficient reasoning performance concerning the particular task at hand is being promoted within the subject. Non-limiting examples of number of iterations include 1, 2, 3, 4, 5, 6, and 7.

It is important to point out that, in the above method of promoting fluid intelligence abilities and in the following exercises and examples implementing the method, the subject is performing the manipulation or the discrimination of symbols in an array/series of symbols without invoking explicit conscious awareness concerning underlying implicit governing rules or abstract concepts/interrelationships, correlations or cross-correlations among the manipulated or discriminated symbols by the subject. In other words, the subject is performing the manipulation and/or discrimination without overtly thinking or strategizing about the necessary actions to accomplish manipulating the symbols or discriminating differences or sameness between symbols in an array/series of symbols. The herein presented suite of exercises the subject is required to perform makes use of interrelations, correlations and cross-correlations among symbols in symbol string sequences and alphabetic set arrays, such that the mental ability of the exercising subject get to promote novel reasoning strategies that improve fluid intelligence abilities. The improved fluid intelligence abilities will be manifested in at least, novel problem solving, drawing inductive-deductive inferences, pattern and irregularities recognition, identifying relations, comprehending implications, extrapolating, transforming information and abstract concept thinking.

Furthermore, it is also important to consider that the methods described herein are not limited to only alphabetic symbols. It is also contemplated that the methods of the present subject matter are also useful when numeric serial orders and/or alpha-numeric serial orders are used within the exercises. In other words, while the specific examples set forth employ serial orders of letter symbols, it is also contemplated that serial orders comprising numbers and/or alpha-numeric symbols can be used.

The library of symbol sequences comprises a predefined number of set arrays (closed serial orders of predefined non-random sequences of terms: symbols\letters\numbers), which may include alphabetic set arrays. Alphabetic set arrays are characterized by comprising a predefined number of different letter terms, each letter term having a predefined ordinal position in the closed set array, and none of said different letter terms are repeated within this predefined unique serial order of letter terms. A non-limiting example of a unique set array is the English alphabet, in which there are 26 predefined different letter terms where each letter term has a predefined consecutive ordinal position of a unique closed serial order among 26 different members of a set array only comprising 26 members. In one aspect of the present subject matter, a predefined library of symbol sequences is considered, which may comprise set arrays. The English alphabet is herein considered as only one unique serial order of letter terms among the at least six other different serial orders of the same letter terms. The English alphabet is a particular alphabetic set array herein denominated: direct alphabetic set array, considered as a non-random sequence. The other five different serial orders of the same letter terms are also unique alphabetic set arrays, which are herein also considered as non-random sequences, denominated: inverse alphabetic set array; direct type of alphabetic set array; inverse type of alphabetic set array; central type of alphabetic set array; and, inverse central type alphabetic set array, respectively. It is understood that the above predefined library of letter terms sequences may contain fewer letter terms sequences than those listed above or comprise additional different set arrays.

The method implementing the present subject matter is not uniquely confined to sequences of letter terms comprising only individual letter symbols. The method also contemplates the presentation of sequences of terms involving multiple letter symbols combinations. However, the multiple letter symbol combinations within a term adhere to the unique serial order principles set forth above, including the exclusion of repeated terms within the set array sequence.

As put forth above, the present subject matter may prompt the subject to discriminate differences between two or more serial orders of terms which were obtained from previously selected one or more set arrays of a predefined library of set arrays. In one aspect of the present subject matter, the obtained two or more serial orders of terms contain at least one different attribute between each of the obtained serial orders of terms. An attribute of a term (symbol\letter\number), is a spatial or temporal perceptual related distinctive feature. In this regard, the present subject matter is directed to the concept that the attribute that is different between the two or more of the obtained serial orders of terms is an attribute selected from the group comprising at least symbol size, symbol font style, symbol spacing, symbol case, boldness of symbol, angle of symbol rotation, symbol mirroring, or combinations thereof. These attributes are considered spatial perceptual related attributes of the terms. Other spatial perceptual related attributes of a term includes, without limitation, letter symbol vertical line of symmetry, letter symbol horizontal line of symmetry, letter symbol vertical and horizontal lines of symmetry, letter symbol infinite lines of symmetry, and letter symbol with no line of symmetry.

The time perceptual related attributes of a term (symbol\letter\number) are features depicting a quantitative state change in time or a spatial quantitative state change in time of that term. The time perceptual related attributes of a term include any color of the full red-green-blue spectral color range of a term when it is visually displayed. Among other time perceptual related attributes there is the frequency range for the intermittent display of a term in a sequence, from a very low intermittency frequency rate up to a high flickering rate. Frequency rate of display is herein defined in 1/t seconds, where t ranges from milliseconds to seconds.

The present methods are not restricted to presenting two or more serial orders of terms containing only one different attribute between each serial order of terms. The present methods also contemplate presenting the two or more obtained serial orders of terms with a plurality of different attributes between each of the serial orders of terms. The plurality of different attributes between the obtained serial orders of terms may be any of those described above.

As previously indicated above, the exercises and examples implementing the methods of the present subject matter are useful in promoting fluid intelligence abilities in the subject through the sensorial-motor and perceptual domains that jointly engage when the subject performs the given exercise. That is, the serial manipulating or discriminating of symbols from an array of symbols by the subject engages various degrees of motor activity within the subject's body. These various degrees of motor activity engaged within the subject's body may be any motor activity derived and selected from the group consisting of sensorial perceptual operations involved in the manipulation or discrimination in or between one and more obtained serial order of terms, body movements involved in the execution of said manipulation or discrimination, and combinations thereof. While any body movements can be considered motor activity implemented by the subject's body, the present subject matter is mainly concerned with implemented body movements selected from the group consisting of body movements of the subject's eyes, head, neck, arms, hands, fingers and combinations thereof.

By way of novel exercises, where the subject engage in certain degrees of body motor activity, the methods of the present subject matter are requiring the subject to bodily-ground cognitive fluid intelligence abilities, implementing manipulations and discrimination of, for non-limiting example, letter symbols via exercising of novel interrelations, correlations and cross-correlations among these letter symbols as mentioned above. The exercises and examples implementing the present subject matter bring the subject back to an early developmental realm where mental cognitive operations fast developed by interrelating, correlating and cross-correlating day to day trial and error experiences via planning and implementation of actions (manipulation) and basic pattern recognition (discrimination of differences and sameness) of qualities (attributes) heavily grounded in symbolic operational knowledge. By doing this, the exercises and examples herein strengthen the fluid intelligence abilities within the subject. It is important that the exercises and examples accomplish this goal by downplaying or mitigating as much as possible the subject need to recall and/or use verbal semantic or episodic memory. The exercises and examples are mainly within promoting fluid intelligence performance, maintaining or prolonging stability of particular trained fluid intelligence cognitive functions, improvement of particular trained fluid intelligence ability aptitude and transfer of improvement in some trained fluid intelligence ability performance to day to day tasking, but do not rise to the operational level of promoting crystalize intelligence via explicit associative learning based on declarative or semantic knowledge. As such, the letter strings and serial orders of letter symbols are selected and presented together in ways aimed to specifically downplay or mitigate the subject's need for problem solving strategies and/or drawing inductive-deductive inferences necessitating information recall-retrieval from declarative semantic and/or episodic kinds of memory.

A large number of attributes utilized in the present exercises and examples are most efficient in promoting fluid intelligence. Accordingly, the subject will need a longer performance time to manipulate and mentally mesh together discrimination of different attributes (also different in kind e.g. spatial and temporal related attributes displaying in the same exercise) if more attributes are used within the exercises. It is herein contemplated that up to seven different attributes can be changed within the set arrays and the subject will still be within the realm of fluid intelligence abilities. However, if the number of different attributes under consideration rises above seven, manipulation and pattern recognition concerning underlying rules or abstract concepts linking together (interrelations) serial sequences of terms (letter\number\symbols), will be in need of crystalize narrow abilities in order to strategize and solve what is required from him/her to perform in order to solve the prompted problem. Thus, if more than seven attributes come into play, what was learned from past experience through semantic or episodic memory is unavoidably mentally invoked within the subject.

In addition to take into consideration the utilization of different attributes for the serial terms within an exercise, there are also temporal attributes which are integral components of the exercises in the Examples given below, which should not be confounded with the temporal attributes of terms in the serial orders explained above. There are a number of different time intervals that are an essential temporal part of the exercises. A first predefined time interval involves the time given to the subject to perform the serial manipulation of the symbols or the discrimination between the at least two or more serial orders of terms obtained from the one or more selected set arrays in the predefined library of non-random set arrays. In general, the subject is given a certain amount of time to perform the task. If the subject fails to perform the task within the first time interval, the method then stops that particular exercise and the subject is transitioned on to the next exercise in the task sequence. The first predefined time interval can range from milliseconds to minutes. The length of this first predefined time interval, depends on the actual challenge presented by the manipulations or discriminations being asked to the subject to perform.

A second predefined time interval is employed between iterations within the exercise of each implementation of the methods. The second predefined time interval is a pause between the exercises in each Example, thus giving the subject a break in the routine of the particular exercise. Without limitation, the second predefined time interval ranges generally from 5 seconds to 17 seconds.

This temporal integral aspect of the method in the Examples set forth below is utilized to help insure that the subject is exercising within the mental domain of fluid intelligence, therefore able to right away promote performance improvements in (the trained) fluid intelligence ability, and is not, in fact, contaminating the exercise by resorting to problem solving strategies based on verbal or episodic recall-retrieval of semantic information from long term memory (which will mostly result in practice effects contamination).

In an aspect of the present subject matter, the examples of the exercises include providing a graphical representation of a non-random letter set array sequence, in a ruler shown to the subject, when providing the subject with the obtained serial terms, to execute the exercise. The visual presence of the ruler helps the subject to perform the exercise, by fast visual spatial recognition of the presented set array, sequence, in order to assist manipulate the required letter symbols or discriminate between differences and sameness between the obtained two or more sequences of terms. In this aspect of the present subject matter, the ruler is a set array sequence selected from the predefined library of non-random set array sequences discussed above.

In a further aspect of the present subject matter, the exercises and examples are implemented through a computer program product. In particular, the present subject matter includes a computer program product for promoting fluid intelligence abilities in a subject, stored on a non-transitory computer-medium which when executed causes a computer system to perform a method. The method executed by the computer program on the non-transitory computer readable medium comprises selecting a serial order of letter-number-alphanumeric symbols from a predefined library of letter-number-alphanumeric symbols sequences and providing the subject with an exercise involving at least one serial order of terms, derived from a previously selected serial order from a predefined library of serial orders of terms. The subject is then prompted to manipulate serial terms (symbols\letters\numbers) within the serial order of terms or to discriminate differences between two or more of the obtained serial orders of terms within the exercise. After manipulating the serial terms or discriminating between the two or more serial orders of terms within the exercise, an evaluation is perform to determine whether the subject correctly manipulated the serial terms or correctly discriminated if there are or not differences between the two or more obtained serial orders of terms. If the subject made an incorrect manipulation or discrimination, then the exercise is started again and the subject is prompted to manipulate serial terms within the obtained serial order or to discriminate if there are differences or not, between two or more of the derived serial orders of terms within the exercise. If, however, the subject correctly manipulated the letter symbols or correctly discriminate the said differences, then the correct manipulations or discriminated differences are displayed with at least one different serial term attribute, to highlight and/or remark the manipulation or difference. The above steps in the method are repeated for a predetermined number of iterations, and upon completion of the predetermined number of iterations, the subject is provided with each iteration results.

In a still further aspect of the present subject matter, the exercises and examples implementing the present methods are presented by a system for promoting fluid intelligence abilities in a subject. The system comprises a computer system comprising a processor, memory, and a graphical user interface (GUI). The processor contains instructions for: selecting a serial order of terms from a predefined library of terms sequences, and providing the subject with an exercise involving at least one serial order of terms derived from the initially selected serial order of terms in the said predefined library, on the GUI; prompting the subject on the GUI to manipulate one or more serial terms within the derived serial order of terms or to discriminate if there are or not differences between two or more derived serial orders of terms within a first predefined time interval; determining whether the subject correctly manipulated the serial terms or correctly discriminated the said differences between the two or more obtained serial orders of 1 terms; if the subject made an incorrect manipulation or discrimination of a serial term, then returning to the step of prompting the subject on the GUI to manipulate serial terms within the obtained serial order of terms, or to discriminate if there are or not differences between two or more obtained serial orders of terms within a first predefined time interval; if the subject correctly manipulated the letter symbols or correctly discriminated the said differences between the two or more obtained serial orders of terms, then displaying the correct manipulations or discriminated differences between serial terms on the GUI with at least one different spatial or temporal related attribute of a serial term to highlight the manipulation or said difference; repeating the above steps for a predetermined number of iterations separated by predefined time intervals; and, upon completion of the predetermined number of iterations, providing the subject with the results of each iteration on the GUI.

It will be readily apparent to a skilled artisan that the features of the general method as described above will be implementable in the computer program product and the system as further described. Furthermore, the following exercises and examples are non-limiting embodiments implementing the present subject matter and are not presented in a limiting form, meaning that other exercises and examples embodying the general concepts discussed herein are also within the scope and spirit of the present subject matter.

In addition, prior to conducting the exercises in the following Examples, it is contemplated that the subject will take a test and/or a battery of tests to determine the scope of any mild cognitive decline or the onset or severity of mild-cognitive impairment (MCI) or mild cognitive functional condition\state of Alzheimer's disease. Likewise, after completing any number of the exercises presented in the Examples, the subject may take a further test and/or battery of tests to determine the scope of performance and transfer promotion of fluid reasoning abilities achieved through the completion of the exercises in the Examples.

Furthermore, as discussed above, while the following Examples provide a series of exercises involving problem solving related to the novel manipulation and discrimination of serial terms sequences, it is contemplated as being within the scope of the present subject matter that the exercises could also be of numerical symbols alone (that is, numbers including the integer set 1-9) or contain alphanumeric symbols (that is, letters and numbers together in the symbol sequence of terms). Still further, the following exercises are generally implemented using a computer system and computer program product and, as such, auditory and tactile exercises for promoting fluid intelligence abilities in a subject are also contemplated as being within the scope of the present subject matter.

In certain non-limiting embodiments, a modular software implements the neuroperformance platform technology disclosed herein, and exploits via its family of proprietary algorithms—statistical properties implicitly encoded in the sequential order of single letters and letter chunks (words, sentences, etc.) in a language alphabet and single numbers and number sets in a numerical series. Some modules are passive while others are interactive. Once an exercise session ends, the user may proceed to immediately test the impact of the session using a psychometric suite testing primary cognitive ability (e.g., inductive reasoning, spatial orientation, numerical facility, perceptual speed, verbal comprehension, verbal recall (general ability of verbal memory encoding, storage also measuring speed of processing via retrieval speed of verbal items).

In certain non-limiting embodiments, performance of alphanumeric exercises sessions lasts about 20-25 minutes long. Since new learning is facilitated by frequent training repetitions, for attaining optimal improvement in performance, in a non-limiting embodiment it is recommended that the user perform a daily routine of at least 2 sessions. If alongside improvements in fluid intelligence abilities, improvement in memory performance (e.g., long term improvements) is also desired, each alphanumeric exercise session should last for at least 35 minutes (in healthy aging individuals, memory training session time will be adjusted according to the user's age), twice a day in a daily fashion. In normal aging population, mini (short)-programs to improve performance in the specific trained cognitive skill may last from 3 to 6 months depending on the trained cognitive skill (e.g., memory, inductive reasoning, spatial orienting, speed of processing etc.) and/or cognitive decline domain area and severity. However, if the desired goal is to improve skill competence in the specific trained cognitive skill and not only attain improvement in skill performance, longer-programs will be required that may last from 1 to 3 years. A variety of programs offering a number of booster sessions will also be available 3 to 6 months after the current training program has been completed. It is estimated that at least an 80% of attendance in each program should be achieved by the subject in order for him/her to experience desired performance improvements in the specific trained cognitive skill. In the MCI population, some programs such as the one focused on compensating or delaying memory and/or reasoning and visuospatial impairments may require a daily routine for as long as a person wishes to stay active.

It should be noted that the effects of some modules may be cumulative, such that the improvement will build progressively as a function of repetitive and continuous use, and may last for months. Other modules may require daily use to retain improvements.

In certain non-limiting embodiments, a personal neuro-linguistic performance profile is established for a specific user who is then provided a personal access code. Once the profile is established, a selected suite of exercises, including e.g., language and/or visual simulation modules from a library of modules are accessed and downloaded (e.g., via the Internet) directly to an end user's computer, tablet, cellphone, iPod, etc.

In adults and the elderly, a customized and adapted version of the following psychometric ability tests are among the standard suite of cognitive ability tests that can be used to assess the herein cognitive training provided by the present novel suite of alphanumeric exercises concerning performance efficacy of the specific trained ability and its general progress trend over time.

As discussed above, upon completion of an exercise session (comprising one or more exercises disclosed herein), the user may proceed to immediately test the impact of the session using a psychometric suite testing a primary cognitive ability (e.g., inductive reasoning, spatial orientation, numerical facility, perceptual speed, verbal comprehension, verbal recall (general ability of verbal memory encoding, storage also measuring speed of processing via retrieval speed of verbal items).

Several methods (e.g., tests) for evaluating various aspects of fluid intelligence abilities are known in the art. Some exemplary tests are enumerated below. A person of skill in the art can readily select from available tests as to which one to use depending on the fluid intelligence ability being measured.

Inductive reasoning ability involves identification of novel relationships in serial patterns and the inference of principles and rules in order to determine additional serial patterns. Inductive reasoning is measured by e.g., The Primary Mental Ability Battery (PMA) reasoning test (See Thurstone, L. L., & Thurstone, T. G. (1949). Examiner Manual for the SRA Primary Mental Abilities Test (Form 10-14). Chicago: Science Research Associates.). The user is shown a series of letters (e.g., A B C B A D E F E) and is asked to identify the next letter in the series. Another test for inductive reasoning is the ADEPT letter series test (See Blieszner et al., Training research in aging on the fluid ability of inductive reasoning. Journal of Applied Developmental Psychology 1981; 2:247-265.). This is a similar test to the PMA reasoning test. In the word series test for inductive reasoning, the user is shown a series of words (e.g., January, March, May) and is asked to identify the next word in the series (See Schaie, K. W. (1985). Manual for the Schaie-Thurstone Adult Mental Abilities Test (STAMAT). Palo Alto, Calif.: Consulting Psychologists Press). In the ETS Number Series test, the user is shown a series of numbers (e.g., 6, 11, 15, 18, 20) and is asked to identify the next number that would continue the series. (See Ekstrom, R. B. et al., 1976. Kit of factor-referenced cognitive tests (rev. ed.). Princeton, N.J.: Educational Testing Service.). The Raven's Progressive Matrices (RPM) test measures (non-verbal) relational reasoning, or the ability to consider one or more relationships between mental representations (as the number of relations increases in the RPM, the user tend to respond more slowly and less accurately). The user is required to identify relevant features based on the spatial organization of an array of objects, and then select the object that matches one or more of the identified features. The Kaufman Brief Intelligence Test (KBIT) measures fluid and crystalized intelligence consisting of a core and expanded batteries, e.g., propositional analogy-like matrix reasoning tests, propositional analogy tests also evaluate relational reasoning. Propositional analogy testing entails the abstraction of a relationship between a familiar representation and mapping it to a novel representation. The user is required to determine whether the semantic relationship existing between two entities is the same as the relationship between two other, often completely different, entities.

Spatial orientation is the ability to visualize and mentally manipulate spatial configurations, to maintain orientation with respect to spatial objects, and to perceive relationships among objects in space. In the alphanumeric rotation test to measure spatial orientation, the user is shown a letter or number and is asked to identify which six other drawings represent the model rotated in two-dimensional space.

Numerical facility is the ability to understand numerical relationships and compute simple arithmetic functions. In the PMA number test, the user checks whether additions or simple sums shown are correct or incorrect. (See Thurstone & Thurstone, 1949, cited above). The addition test measures speed and accuracy in adding three single or two-digit numbers. (See Ekstrom, et al., 1976, cited above). The subtraction and multiplication test is a test of speed and accuracy with alternate rows of simple subtraction and multiplication problems (See Ekstrom et al. 1976, cited above)

Perceptual speed is the ability to search and find alphanumeric symbols, make comparisons and carry out other basic tasks involving visual perception, with speed and accuracy. For example in the Finding A's test, in each column of 40 words, the user must identify the five words containing the letter “A”. (See Ekstrom, et al., 1976, cited above). In the number comparison test, the user inspects pairs of multi-digit numbers and indicates whether the two numbers in each pair are the same or different. (See Ekstrom, et al., 1976, cited above).

Verbal comprehension (e.g., language knowledge and comprehension) is measured by assessing the scope of the user's recognition vocabulary. Verbal comprehension is measured by tests such as PMA verbal meaning which is a four-choice synonym test which is highly speeded. (See Thurstone & Thurstone, 1949, cited above). ETS Vocabulary II is a five-choice synonym test of moderate difficulty level, and ETS Vocabulary IV is another five-choice synonym test consisting mainly of difficult items (See Ekstrom, et al., 1976, cited above).

Verbal recall is the ability to encode, store and recall meaningful language units. In the Immediate Recall test, the user study a list of 20 words for 3½ minutes and then is given an equal period of time to recall the words in any order. (See Zelinski et al., Three-year longitudinal memory assessment in older adults: Little change in performance. Psychology and Aging 1993; 8: 176). In the Delayed Recall test, the user is asked to recall the same list of words as in Immediate Recall testing after an hour of intervening activities (other psychometric tests). (See Zelinski et al., 1993, cited above). In the PMA Word Fluency test, the user freely recalls as many words as possible according to a lexical rule within a five-minute period. (See Thurstone & Thurstone, 1949, cited above).

Memory tests measure verbal memory ability and memory change over time (assessing verbal list-learning and memory—recognition and delayed recognition and immediate and delayed recall) or measure memory behaviors characteristic of everyday life. The Hopkins Verbal Learning Test (HVLT and HVLT-R) is used to measure memory. The HVLT requires recall of a series of 12 semantically related words (four words from each of three semantic categories) over three learning trials, free recall after a delay, and a recognition trial. (See Brandt, J. & Benedict, R. (2001), Hopkins Verbal Learning Test-Revised: Professional Manual. PAR: Florida). In another memory test, the Rey-Auditory Verbal learning Test (AVLT), the user is presented (hears) with a 15-item list (List A) of unrelated words, which it's asked to write down (recall) immediately over five repeated free-recall trials. After five repeated free-recall trials, a second “interference” list (List B) is presented in the same manner, and the user is asked to recall as many words from list B as possible. After the interference trial (List B), the user is immediately asked to recall the words from list A, which he/she heard five times previously. After a 20 min delay, the user is asked to again recall the words from List A. (See Rey A. Archives de Psychologie. 1941; 28:215-285). The Rivermead Behavioral Memory Test's (RBMT) battery consists of: (i) remembering a name (given the photograph of a face); (ii) remembering a belonging (some belonging of the testee is concealed, and the testee has to remember to ask for it back on completion of the test); (iii) remembering a message after a delay; (iv) an object recognition task (ten pictures of objects are shown, and the testee then has to recognize these out of a set of 20 pictures shown with a delay; (v) a face recognition task (similar to object recognition, but using five faces to be recognized later among five distractors); (vi) a task involving remembering a route round the testing room; and (vii) recall of a short story, both immediately and after a delay (See Wilson et al. The Rivermead Behavioural Memory Test. 34, The Square, Titchfield, Fareham, Hampshire PO14 4AF: Thames Valley Test Company; 1985).

In each of the non-limiting Examples below, the subject is presented with various exercises and prompted to make selections based upon the particular features of the exercises. It is contemplated that, within the non-limiting Examples 1-2, the choice method presented to the subject could be any one of three particular non-limiting choice methods: multiple choice; force choice; and/or go-no-go choice.

When the subject is provided with multiple choices when performing the exercise, the subject is presented multiple choices as to what the possible answer is. The subject must discern the correct answer/selection and select the correct answer from the given multiple choices.

Furthermore, when the force choice method is employed within the exercises, the subject is presented with only one choice for the correct answer and, as is implicit in the name, the subject is forced to make that choice. In other words, the subject is forced to select the correct answer because that is the only answer presented to the subject.

Likewise, a choice method presented to the subject is a go-no-go choice method. In this method, the subject is prompted to answer every time the subject is exposed to the correct answer. In a non-limiting example, the subject may be requested to click on a particular button each time a certain symbol is shown to the subject. Alternatively, the subject may be requested to click a different button each time another certain symbol is displayed. Thus, the subject clicks the button when the particular symbol appears and does not click any buttons if the particular symbol is not there.

The present subject matter is further described in the following non-limiting examples.

### Example 1

### Visual Search and Discovery of a Serial Order of Symbols in a Quasi-Random Symbol Matrix or in a Non-Random Symbol Matrix

The present non-limiting Example requires the subject to visually serially search and discover a predefined set array of symbols (e.g., letters\numbers\alphanumeric) inside another sequence of symbols arranged in a matrix format and having the same spatial and time perceptual related attributes than the symbols in the predefined set array. In a non-limiting embodiment, the present Example requires the subject to visually serially search and discover inside the symbols sequence in the matrix, a previously selected direct alphabetic set array comprising (A-Z) letters symbols and/or an inverse alphabetic set array consisting of (Z-A) letters symbols. The subject is required to visually serially search and discover these symbols (one symbol at a time), in accordance with their serial order positions in a provided ruler, as fast as the subject can. The sequential order of symbols in the matrix may be obtained, in a first stage, from a quasi-random letter symbol generator or from written texts or verbal data sources from a written text or a verbal data source library. The obtained sequence of symbols for the matrix will be finally adapted in order to contain the said previously selected sequence of symbols which the subject is required to visually serially search and discover.

A non-limiting embodiment of the present Example comprises four block exercises. Each block exercise contains two trial exercises, wherein the subject is required to visually serially search and discover symbols sets arrays consisting of two complete alphabetical serial orders of letters symbols generated and displayed to the subject. All block exercises with their respective trial exercises are displayed sequentially.

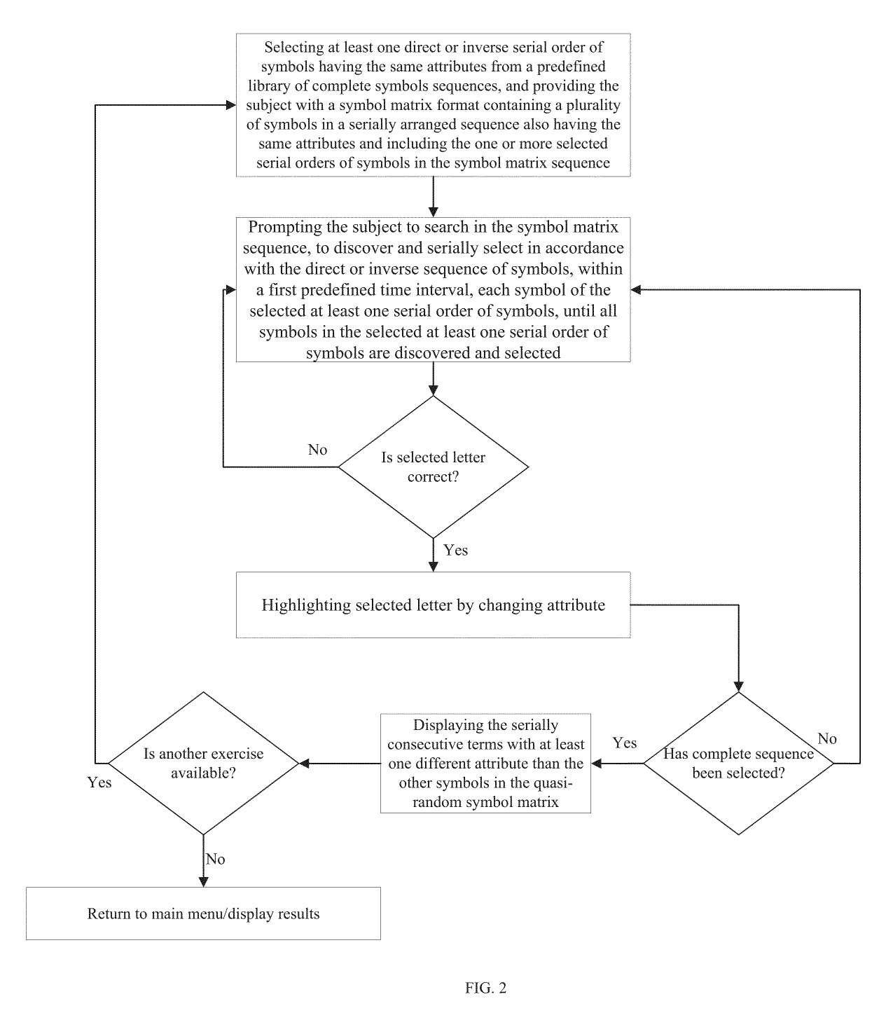

FIG. 2 is a flow chart setting forth the method that the present exercises use in promoting fluid intelligence abilities in a subject by having the subject visually serially search and discover at least one complete serial order of symbols, which in the non-limiting embodiment of the present example consists in alphabetic sets arrays namely, a direct alphabetic set array and/or an inverse alphabetic set array. As can be seen in FIG. 2, the method of promoting fluid intelligence abilities in the subject comprises selecting at least one complete serial order of symbols sequence, where all symbols in the sequence having the same spatial and time perceptual related attributes from a predefined library of complete symbols sequences, while also providing the subject with a plurality of symbols arranged inside a matrix format. The plurality of symbols arranged inside this matrix format having the same spatial and time perceptual related attributes than the selected at least one complete serial order of symbols. The said matrix format containing a plurality of symbols generated in a sequential quasi-random manner and thus the plurality of symbols in it arranged in a quasi-random symbol matrix. In the present Example, the one or more selected complete serial orders of symbols are non-random set arrays which are included as part of the symbols sequences forming the symbol matrix, and this selected at least one non-random complete serial order of symbols, is provided as a ruler to the subject. The subject is prompted to search, discover and serially select symbols inside the symbol matrix, following the ordinal order provided in the ruler, within a first predefined time interval, each symbol of the selected at least one non-random complete serial order of symbols sequence, until all symbols in the selected at least one non-random serial order of symbols sequence are discovered and selected. If the proposed symbol selection is not the correct symbol inside the symbol matrix in accordance to the ordinal order provided in the ruler, then the subject is returned to the step of being prompted to search, discover and serially select the symbols inside the symbol matrix. If the proposed symbol selection is the correct next symbol inside the symbol matrix in accordance to the ordinal order provided in the ruler, then the correctly selected symbol inside the symbol matrix is highlighted by changing at least one spatial or time perceptual related attribute of the correctly selected symbol. If the complete serial order of symbols sequence of the selected at least one non-random complete serial order of symbols sequence has not been selected, then the subject is again returned to the step of being prompted to search, discover and serially select the symbols inside the symbol matrix. If the complete serial order of symbols sequence of the selected at least one non-random complete serial order of symbols sequence has been correctly selected, then the complete serial orders of symbols sequence is displayed inside the symbol matrix with at least one different spatial or time perceptual related attribute than the other symbols in the quasi-random symbol matrix. The above steps in the method are repeated for a predetermined number of iterations separated by one or more predefined time intervals, and upon completion of the predetermined number of iterations, the subject is provided with each iteration results. In embodiments, the predetermined number of iterations can be any number needed to establish a satisfactory reasoning performance ability concerning the particular task at hand is being promoted within the subject. Non-limiting examples of number of iterations include 1, 2, 3, 4, 5, 6, and 7. However, any number of iterations can be performed.

In another non-limiting aspect of Example 1, the method of promoting fluid intelligence abilities in a subject is implemented through a computer program product. In particular, the subject matter in Example 1 includes a computer program product for promoting fluid intelligence abilities in a subject, stored on a non-transitory computer readable medium which when executed causes a computer system to perform the method. The method executed by the computer program on the non-transitory computer readable medium comprises selecting at last one complete serial order of symbols sequence, where all the symbols in the sequence having the same spatial and time related attributes, from a predefined library of complete symbols sequences, and also providing the subject with a plurality of symbols having the same spatial and time perceptual related attributes and where the plurality of symbols arranged inside a symbol matrix format. The said plurality of symbols can be obtain within the symbol matrix, one symbol at a time, in a quasi-random sequential manner or from letter symbols sequences from other letter symbols sources like books, magazines, and audio records. In the non-limiting Example here presented the one or more selected complete serial orders of symbols sequences are one or more selected non-random alphabetic set arrays, which are made to be included in the symbol matrix sequence format, and the selected at least one non-random complete serial order of symbols sequence is provided as a ruler to the subject. The subject is prompted to search, discover and serially select symbols inside the symbol matrix, within a first predefined time interval, each symbol of the selected at least one non-random serial order of symbols sequence, until all symbols in the selected at least one non-random serial order of symbols sequence are discovered and selected. If the proposed symbol selection is not the next correct symbol within the selected non-random serial order of symbols sequence, then the subject is returned to the step of being prompted to search, discover and serially select the symbols inside the symbol matrix. If the proposed symbol selection is the correct next symbol within the selected non-random serial order of symbols sequence, then the correctly selected symbol is highlighted by changing at least one spatial and/or time perceptual related attribute of the selected symbol. If the complete serial order of symbols of the selected at least one non-random complete serial order of symbols sequence has not been selected, then the subject is again returned to the step of being prompted to search, discover and serially select the symbols inside the symbol matrix. If the complete serial order of symbols sequence of the selected at least one non-random complete serial order of symbols sequence has been selected, then the complete serial order of symbols sequence is displayed with at least one different spatial and or time perceptual related attribute than the other symbols in the quasi-random symbol matrix. The above steps in the method are repeated for a predetermined number of iterations separated by one or more predefined time intervals, and upon completion of the predetermined number of iterations, the subject is provided with each iteration results.

In a further non-limiting aspect of Example 1, the method of promoting fluid intelligence abilities in a subject is implemented through a system. The system for promoting fluid intelligence abilities in a subject comprises: a computer system comprising a processor, memory, and a graphical user interface (GUI), the processor containing instructions for: selecting at last one complete serial order of symbols sequence having the same spatial and time related attributes from a predefined library of complete symbols sequences, and providing the subject on the GUI with a plurality of symbols obtained in various possible forms, which include their sequential generation in a quasi-random manner and arranged inside the symbol matrix also in a quasi-random manner, wherein the one or more selected complete serial orders of symbols sequences are included in the sequence of symbols making-up the symbol matrix, and wherein the selected at least one complete serial order of symbols sequence is provided as a ruler to the subject; prompting the subject on the GUI to search, discover and serially select symbols inside the symbol matrix, within a first predefined time interval, and where each next symbol of the selected at least one complete serial order of symbols sequence is selected, until all symbols in the selected at least one complete serial order of symbols sequence are discovered and selected; if the proposed symbol selection is not the correct symbol within the selected complete serial order of symbols sequence, then returning to the step of prompting the subject to search, discover and serially select the symbols inside the symbol matrix; if the proposed symbol selection is the correct next symbol within the selected complete serial order of symbols sequence, then highlighting the correct selected symbol on the GUI by changing at least one spatial or time perceptual related attribute of the correctly selected symbol; if the complete serial order of symbols sequence of the selected at least one complete serial order of symbols sequence has not been selected, then returning the subject to the step of prompting to search, discover and serially select the symbols inside the symbol matrix; if the complete serial order of symbols sequence of the selected at least one complete serial order of symbols sequence has been selected, then displaying the complete serial orders of symbols sequence on the GUI with at least one different spatial or time perceptual related attribute than the other symbols in the quasi-random symbol matrix; repeating the above steps for a predetermined number of iterations separated by one or more predefined time intervals; and upon completion of the predetermined number of iterations, providing the subject with the results of each iteration on the GUI.

In a non-limiting aspect of the exercises of the present Example, two types of non-random complete serial orders of symbols sequences, are generated: 1) a direct alphabetic set array consisting of A-Z letters symbols, and 2) an inverse alphabetic set array consisting of Z-A letters symbols. Depending on the particular exercise within the block exercises, a direct alphabetic or inverse alphabetic set array is also graphically provided to the subject by showing it below the symbol matrix (see block exercise #4, below) in the form of a ruler. The presence of the ruler helps the subject to perform the exercise, by steering his/her visual attention to promote fast and accurate visual-perceptual spatial serial recognition concerning the discovery of each letter symbol that the subject is required to select inside the letter symbol matrix. Examples of direct alphabetical serial orders of letter symbols sequences from which the selected non-random serial order of letter symbols sequence is obtained include, without limitation, direct alphabetic set array, direct type of alphabetic set array, and central type of alphabetic set array. Likewise, examples of inverse alphabetical serial orders of symbols sequences from which the selected non-random serial order of symbols sequence is obtained include, without limitation, inverse alphabetic set array, inverse type of alphabetic set array, and inverse central type of alphabetic set array.

Consistent with the above, a quasi-random symbol matrix can be generated in block exercises #1 to #3. In an alternative non-limiting aspect, a symbol matrix can be generated from written texts or verbal narrations from a “written/verbal format source library”. The written text or verbal narration is displayed in a written/verbal letter symbol matrix format in order to be acted upon in block exercise #4. In summary of various non-limiting aspects, symbol matrices can be obtained in various ways, including: 1) by a symbol quasi-random generator; 2) from written texts such as books, newspapers and magazines; and 3) from audio transcriptions of oral formats such as: stories and narrations (radio or TV news programs, etc.), or conversations, thereafter the obtained letter symbols are organized and formatted into a written symbol matrix. Nevertheless, all these obtained symbols sequences may require adjustment in order for all the symbols of the selected one or more complete serial orders of symbols sequences (like the one or more set arrays of the present Example), will be properly included in the symbols sequence forming the symbol matrix.

It is contemplated that the non-limiting exercises of Example 1 can be implemented using a computer program or software product (or a computer system). In a non-limiting example of when a computer program product is the means by which the methods are implemented, a quasi-random symbol matrix is generated by an algorithm of the herein software program. In a non-limiting example, a quasi-random symbol matrix generated by an algorithm of the herein software program can contain a set of 720 symbols. The quasi-random symbol matrix occupies a surface graphically depicted by an ‘X’ and ‘Y’ axis. In the said quasi-random symbol matrix, the ‘Y’ axis comprises 18 symbols and the ‘X’ axis comprises 40 symbols. The 18 symbols are displayed vertically in the ‘Y’ axis and the 40 symbols are displayed horizontally in the ‘X’ axis. Still, the quasi-random symbol matrix can also be formed in the ‘Y’ axis to entail a string of 30 symbols, and in the ‘X’ axis to entail a string of 24 symbols. The string of 30 symbols will be displayed vertically in the ‘Y’ axis and the string of 24 symbols will be displayed horizontally in the ‘X’ axis, respectively. It is also contemplated that quasi-random symbol matrices of other sizes are also usable within the exercises of Example 1.

Because of the empirical relative occurrence frequency of letters symbols, in written texts and spoken language, there are some written letters symbols and spoken letters symbols sounds in spoken language that empirically manifest a very low occurrence frequency (e.g., in the written English language: letters symbols and letters symbols sounds j, q, x and z). Therefore, in the present exercises, in order to overcome empirical relative very low occurrences frequencies of some written letters symbols and some spoken letters symbols sounds in spoken language and to ensure that letters symbols and letters symbols sounds that empirically have a relative very low occurrence frequency are also manifested when the subject is required to search, discover and select complete serial orders of letters symbols sequences, whether a direct alphabetic set array and/or an inverse alphabetic set array, where each of the letter symbols in a direct or inverse alphabetic set array is intrinsically positioned in its unique respective direct or inverse alphabetical serial order position, the herein software program implements a non-random letter symbol matrix entailing, for example, 5040 letters symbols. In this non-limiting example, the presently disclosed software program, will reorganize and format these 5040 letters symbols in a non-random letter symbol matrix of 63×80 letters symbols. The non-random letter symbol matrix entailing 5040 letters symbols occupies a surface graphically depicted by an ‘X’ and ‘Y’ axis. In the said non-random letter symbol matrix, the Y axis vertically displays a string of 63 letters symbols and the X axis horizontally displays a string of 80 letters symbols. It is empirically expected that a non-random letter symbol matrix comprising 5040 letters symbols is large enough to entail at least two alphabetic sets arrays, namely one direct alphabetic and one inverse alphabetic set array, where the letters symbols of each alphabetic set array happen to serially occupied their unique alphabetical serial order positions within the plurality of letters symbols entailing the non-random letter symbol matrix. In case this objective is not achieved, the herein software program will introduce the necessary adjustments, to reach the above said goal. It is understood that, when using non-random letter symbol matrices obtained from the written or verbal data source library, all of the punctuation and all blank spaces between letters strings (e.g., words) are removed.

In the first three non-limiting block exercises of Example 1, when the correct next symbol of the selected non-random complete serial order of symbols sequence is identified and correctly selected by the subject, the time perceptual related color attribute of the correctly selected symbol is immediately changed to a time perceptual related color attribute that is different than the time perceptual related color attribute of the remaining symbols in the symbol matrix. The correctly selected symbol maintains the first changed time perceptual related color attribute until all symbols in the selected non-random complete serial order of symbols sequence have been correctly identified and selected, meaning that the entire direct and/or inverse alphabetic set array has been correctly serially discovered and selected by the subject. In the fourth non-limiting block exercise of Example 1, the subject is required to identify and serially select both a direct alphabetic set array and an inverse alphabetic set array within the same letter symbol matrix. In the fourth block exercise, the letters symbols associated with a direct alphabetic set array are changed in their time perceptual related color attribute from default time perceptual related color attribute to the first time perceptual related color attribute when correctly selected, and the letters symbols associated with an inverse alphabetic set array are changed in their time perceptual related color attribute from their default time perceptual related color attribute to the second time perceptual related color attribute when correctly selected.

When the completed serial order of letters symbols in a direct alphabetic set array is identified, the correctly discovered and selected letters symbols changes default time perceptual related color attribute to a first time perceptual related color attribute. In a non-limiting embodiment, the first time perceptual related color attribute is red. Likewise, when the completed serial order of letters symbols in an inverse alphabetic set array is identified, the correctly discovered and selected letters symbols changes default time perceptual related color attribute to a second time perceptual related color attribute that is different than the first time perceptual related color attribute. In the non-limiting example, the second time perceptual related color attribute is blue. It is understood that the first time perceptual related color attribute and the second time perceptual related color attribute, as well as the original default time perceptual related color attribute of symbols in the symbol matrices, can each be any time perceptual related color attribute, so long as the first time perceptual related color attribute, the second time perceptual related color attribute and the original default time perceptual related color attribute are not the same.

As discussed above, upon correct identification of the completed serial order of letter symbols sequence, whether direct alphabetic or inverse alphabetic set arrays, the completed serial order of letter symbols sequence is then displayed with the correctly identified letters symbols being displayed with a spatial and/or time perceptual related attribute different than the spatial and/or time perceptual related attribute of the remaining letters symbols in the quasi-random or non-random symbol matrix. The above non-limiting embodiments briefly discuss spatial perceptual related symbol font size attribute and time perceptual related symbol color attribute as symbols attributes that can change. In general, though, the changed attribute of the correctly identified and selected symbols in the symbol matrix is designated from the group of spatial or time perceptual related attributes, or combinations thereof. In a particular aspect, the changed symbols attributes are selected from the group consisting of, symbol size, symbol font style, letter symbol spacing, letter symbol case, boldness of letter symbol, angle of letter symbol rotation, letter symbol mirroring, or combinations thereof. These symbols attributes are considered spatial perceptual related attributes of the symbols. In a particular aspect, the changed symbols attributes are selected from the group consisting of symbol color, symbol flickering and symbol sound. These symbols attributes are considered time perceptual related attributes of the symbols. Other spatial perceptual related attributes of letter symbols that could be used to further highlight the correctly identified and selected letters symbols include, without limitation, letter symbol vertical line of symmetry, letter symbol horizontal line of symmetry, letter symbol vertical and horizontal lines of symmetry, letter symbol infinite lines of symmetry, and letter symbol with no line of symmetry. Furthermore, the correctly identified and selected symbols may be displayed with a time perceptual related flickering attribute behavior in order to further highlight the differences in symbols perceptual related attributes.

In a particular aspect of the present Example, the change in attributes is done according to predefined correlations between space and time related attributes, and the ordinal position of those letter symbols in the selected complete serial order of symbols in the first step of the method. For the case of a subject's visual perception of a complete direct alphabetic set array of the English language, the first ordinal position (occupied by the letter “A”), will generally appear toward the left side of his/her field of vision, whereas the last ordinal position (occupied by the letter “Z”) will appear towards his/her right field of vision. For a non-limiting example of this predefined correlation, if the ordinal position of the letter symbol for which an attribute will be changed falls in the left field of vision, the change in attribute may be different than if the ordinal position of the letter symbol for which the attribute will be changed falls in the right field of vision. In this non-limiting example, if the attribute to be changed is the color of the letter symbol, and if the ordinal position of the letter symbol for which the attribute will be changed falls in the left field of vision, then the color will be changed to a first different color, while if the ordinal position of the letter symbol falls in the right field of vision, then the color will be changed to a second color different from the first color. Likewise, if the attribute to be changed is the size of the letter symbol being displayed, then those letter symbols with an ordinal position falling in the left field of vision will be changed to a first different size, while the letter symbols with an ordinal position falling in the right field of vision will be changed to a second different size that is yet different than the first different size.

The non-limiting exercises in Example 1 are useful in promoting fluid intelligence abilities in the subject by grounding its basic fluid intelligence abilities in selective motor activity that occurs when the subject performs the given exercise. That is, the serial search, identification and selection of the symbols by the subject engage motor activity within the subject's body. The motor activity engaged within the subject may be any motor activity involved in the group consisting of sensorial perception of serially searching and identifying the unique serial order distribution of letters symbols in alphabetic sets arrays among a quasi-random distribution of letters symbols in the quasi-random symbol matrix, sensorial perception of serially searching and identifying the unique serial order distribution of letters symbols in alphabetic sets arrays among a non-random distribution of letters symbols in a non-random symbol matrix, in body movements to execute selecting the next correct letter symbol, sensorial perception of correctly selected letter symbols changing spatial or time perceptual related attributes, sensorial perception to visually ignore or suppress attending at letter symbols serially distributed in a quasi-random manner in the quasi-random symbol matrix or and combinations thereof. While any body movements can be considered motor activity within the subject, the present subject matter is concerned with body movements selected from the group consisting of body movements of the subject's eyes, head, neck, arms, hands, fingers and combinations thereof.

Requesting the subject to engage in specific degrees of motor activity in the exercises of Example 1, require of him/her to bodily-ground cognitive fluid intelligence abilities as discussed above. The exercises of Example 1 cause the subject to revisit an early developmental realm where he/she implicitly experienced a fast advance of fluid cognitive abilities specifically when performing serial pattern recognition of non-concrete terms/symbols meshing with their salient space-time related attributes. The established relationships between non-concrete terms/symbols and their (salient) spatial and/or time related attributes, heavily promote symbolic knowhow in a subject. Accordingly, the exercises of Example 1 strengthen fluid intelligence abilities by promoting in a subject novel inductive-deductive reasoning strategies that result in the attainment of more efficient ways to solve the mentioned exercises. It is important that the exercises of Example 1 accomplish promotion of symbolic relationships between terms/symbols and their spatial and temporal perceptual related attributes by downplaying or mitigating as much as possible the subject's need to recall/retrieve from memory and use verbal semantic or episodic information as part of his/her novel reasoning strategy for problem solving of the exercises in Example 1. The said exercises of Example 1 are mainly about promoting fluid intelligence abilities and novel inductive-deductive reasoning strategies in a subject. Still, the exercises of Example 1 are not intended to raise the subject's sensorial-perceptual body motor performances with symbols and their spatial and/or time perceptual related attributes to the more cognoscenti formal operational stage, where crystalized intelligence's abilities are also promoted in the specific trained domain (crystallized intelligence abilities are brought into play by cognitive establishment of a multi-dimensional mesh of relationships between concrete items/things among themselves, concrete items/things with their spatial and/or time related attributes and by substitution of concrete items/things with non-concrete terms/symbols). Still, crystalized intelligence's narrow abilities are mainly promoted by sequential, descriptive and associative forms of explicit learning, which is a kind of learning strongly rooted in declarative semantic knowledge. As such, the specific symbols' sequences (e.g., letter, number, alphanumeric), randomized symbols sequences (e.g., letter, number, alphanumeric), non-random incomplete symbols sequences and non-random complete direct or inverse alphabetic (unique) serial orders of letter symbols sequences and rules constraining symbols construction of the quasi-random and non-random symbol matrix are herein selected to principally downplay or mitigate the subject's need for developing problem solving strategies and/or drawing abstract relationships necessitating verbal knowledge and/or recall-retrieval of information from declarative-semantic and/or episodic kinds of memories.

In an aspect of the exercises present Example 1, the library of complete terms\symbols sequences includes the following terms\symbols sequences as defined above: direct alphabetic set array; inverse alphabetic set array; direct type of alphabetic set array; inverse type of alphabetic set array; central type of alphabetic set array; and, inverse central type alphabetic set array. It is understood that the above library of complete terms\symbols sequences may contain additional letter symbols sequences or fewer letter symbols sequences than those listed above.

Furthermore, it is also important to consider that the non-limiting exercises of Example 1 are not limited to serial orders of alphabetic symbols sequences. It is also contemplated that the exercises are also useful when numeric symbols serial orders and/or alpha-numeric symbols serial orders sequences are used within the exercises. In other words, while the specific examples set forth employ serial orders of letter symbols sequences, it is also contemplated that serial orders comprising numbers and/or alpha-numeric symbols sequences can be used.

In an aspect of the present subject matter, the exercises of Example 1 include providing a ruler to the subject. The presence of the ruler helps the subject to perform the exercise, by steering his/her visual attention to promote fast and accurate visual-perceptual spatial serial recognition concerning discovering each symbol that the subject is required to correctly select inside the quasi-random symbol matrix or the non-random symbol matrix. In the present exercises, the ruler comprises one of a plurality of sequences in the above disclosed library of complete sequences, namely direct alphabetic set array; inverse alphabetic set array; direct type of alphabetic set array; inverse type of alphabetic set array; central type of alphabetic set array; and inverse central type alphabetic set array.

The subject is given a maximal predefined time period within which the subject must validly perform the exercises. If the subject does not perform the exercise within this maximal predefined time interval, also referred to as “a valid performance time period”, then after a delay, which could be of about 4 seconds, the next in-line quasi-random symbol matrix trial exercise with a new complete letter symbols sequence type embedded inside a new quasi-random symbol matrix is displayed in order to be performed by the subject (for block exercise #4 the next in-line non-random letter symbol matrix trial exercise with a new complete letter symbols sequence type embedded inside the said non-random letter symbol matrix is displayed in order to be performed by the subject). In a non-limiting example, the maximal predefined time interval or valid performance time period for lack of response is defined to be 20-90 seconds, in particular 30-75 seconds, and further specifically 45 seconds for each next symbol to be correctly recognized

In the present Example, there is also a predefined time interval between block exercises. Let Δ1 herein represent a fixed time interval between block exercises' performances of the present task, where Δ1 is herein defined to be of 8 seconds. However, other time intervals are also contemplated, including without limitation, 3-10 seconds and the integral times there between.

The methods implemented by the exercises of Example 1 also contemplate those situations in which the subject fails to perform the given Example. The following failing to perform criteria is applicable to any exercise in any block exercise of the present Example in which the subject fails to perform. Specifically, for the present exercises, “failure to perform” occurs in the event the subject fails to perform by not correctly identifying and selecting the correct complete set of letters symbols sequence comprising a direct alphabetic set array and/or an inverse alphabetic set array in the symbol matrix (a quasi-random or a non-random symbol matrix) within a valid performance time period. In such a case, the subject will automatically be prompted to start a new symbol matrix trial exercise in which the subject must start again from the beginning by serial searching, identifying and correctly selecting the direct alphabetic set array and/or inverse alphabetic set array. The valid performance time period to correctly identify and select one symbol can be any set period of time, for instance 45 seconds.

If the subject fails to perform in this manner for block exercises 1 to 3 of Example 1, in any of 2 new quasi-random symbol matrices trial exercises consecutively, then the subject ends its performance of that particular quasi-random symbol matrix trial exercise and transitions on to the next in-line quasi-random symbol matrix trial exercise in the next in-line block exercise. If the subject fails to perform in 2 new non-random symbol matrices trial exercises consecutively within the fourth block exercise, then the subject is automatically stopped within the exercises of Example 1 and returned to the main menu of Examples implementing the present methods.

Total duration to complete the exercises of Example 1, as well as the time it took to implement each one of the individual symbol matrix trial exercises, is registered in order to help generate an individual and age-gender related performance score. Records of all wrong symbols answers for all type letter\number\alphanumeric symbols sequences displayed and required to be performed are also generated and displayed. In general, the subject will perform this Example about 6 times during their-based brain mental fitness training program.

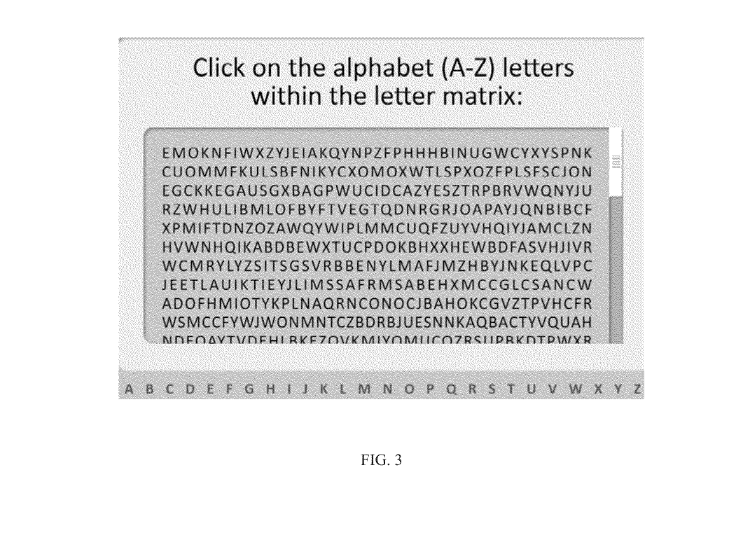

FIG. 3 shows an example of a quasi-random letters symbol matrix that can be presented to the subject. In FIG. 3, it can be seen that, within the quasi-random letters symbol matrix, the letters symbols A through X can be found in serial order, starting from the top left-hand corner of the quasi-random letters symbol matrix and proceeding in a row-by-row analysis of the rows of the letters symbol matrix, moving from left to right in each row. The subject is prompted to click on the correct letters symbols within the quasi-random letters symbol matrix. It is understood that, when the subject correctly clicks on the next letter symbol in the direct alphabetical serial order of letters symbols sequence, the correctly selected letter symbol changes at least one spatial or time perceptual related attribute to highlight the correct letter symbol selection. It is also understood that the quasi-random symbol matrix provided in FIG. 3 is a non-limiting example and that any quasi-random symbol matrix fitting the definition described herein can be used within the scope of the present Example.

### Example 2

### Visual Search, Discovery and Serial Selection of Symbols Consecutively Allocated in a Number of Incomplete Symbols Sequences Located Inside a Quasi-Random Symbol Matrix

In an embodiment of the present non-limiting Example, the subject is required to exercise his/her fluid intelligence ability to rapidly and accurately visually serially search and discover consecutive ordered different letter symbols in a number of symbols sequences, where these symbols sequences ordered either according to a direct alphabetical or to an inverse alphabetical set array, and where these letter symbols sequences are allocated horizontally and/or vertically and/or diagonally across a quasi-random symbol matrix. To that effect, the present non-limiting Example exercises perceptual interactions between a quasi-random distribution of letters symbols and a number of non-random letters symbols sequences allocated amongst the said quasi-random distribution of letters symbols in a letters symbols matrix, to promote fluid intelligence ability in a subject. This interactive perceptual symbols space namely, the quasi-random letters symbols (e.g., letter\number\alphanumeric) matrix in which a random distribution of letters symbols with the same spatial and time perceptual related attributes, close and distant, promote implicit symbolic knowhow consisting in inter-relationships, correlations and cross-correlations with same letters symbols arranged in a plurality of non-random symbols sequences comprising serially consecutive ordered different symbols. More specifically, these perceptual implicit symbolic interactions take place, between two opposite symbols serial conditions which, in embodiments, are: a) the perception of serially consecutive different letters symbols ordered according to a direct alphabetical A-Z serial order of letters symbols and/or ordered according to an inverse alphabetical Z-A serial order of letters symbols; and b) the perception of symbols wherein letter symbols are randomly spatially serially distributed along rows and columns.

In a particular non-limiting aspect, the visual perceptual interaction between a plurality of serially ordered consecutive different letters symbols sequences, and of a random distribution of the same letters symbols serially position across the two-dimensional quasi-random letter symbol matrix format, prompts in the subject a symbolic kind of ‘know-how’ that implicitly steers the subject's visual attention and selective bodily movements to rapidly and accurately search, discover and select a plurality of non-random letters symbols sequences, where each of these non-random letters symbols sequences comprising a number of serially consecutive ordered different letters symbols, ordered according to a direct alphabetical A-Z letter symbol sequence nature and/or an inverse alphabetical Z-A letter symbol sequence nature. These serially consecutive ordered non-random letters symbols sequences are allocated within a quasi-random serial distribution of same letters symbols in the quasi-random letter symbol matrix. Still, the herein generated perceptual interplay between serially consecutive ordered different letters symbols in a plurality of non-random letters symbols sequences and a random serial distribution of same letters symbols in the quasi-random letter symbol matrix helps to mitigate the distracting perceptual effect specifically exerted by the random serial distribution of letters symbols in the letter symbol matrix on the subject's visual attention. Further still, the inserted plurality of non-random letters symbols sequences each comprising of serial consecutive ordered different letters symbols are displayed in different spatial locations and directions inside the quasi-random letter symbol matrix. Furthermore, it is understood that the different letters symbols in the sequences wherein they are serially consecutive ordered, and a predefined number of same letters symbols randomly serially distributed inside a quasi-random letter symbol matrix, will hold mutual relationships among them in the visual perceptual space of the subject, when he/she engages in the execution of the exercises in the present Example. Details regarding the predefined number and mutual relationship amongst the individual letters symbols and distributions of letter symbols within the quasi-random letter symbol matrix are provided below.

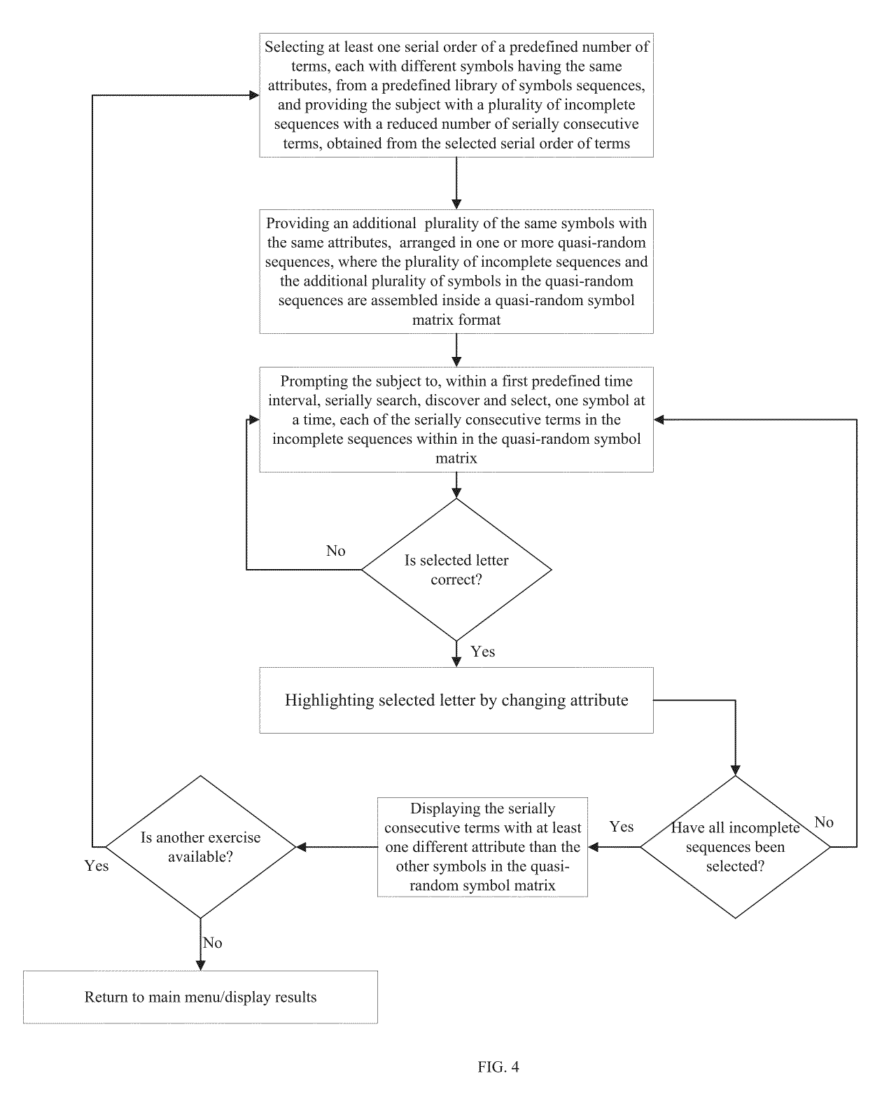

FIG. 4 is a flow chart setting forth the method that the present exercises use in promoting fluid intelligence abilities in a subject by having the subject serially search and discover a number of serially ordered consecutive different letters symbols in non-random letters symbols sequences located within a quasi-random letter symbol matrix. As can be seen in FIG. 4, the method of promoting fluid intelligence abilities in the subject comprises selecting at least one serial order of consecutive letters symbols having the same spatial and time related attributes, from a predefined library of complete non-random symbols sequences, and providing the subject with a plurality of non-random letters symbols sequences of serially consecutive ordered different letters symbols, from the previously selected serially consecutive ordered different letters symbols non-random sequences. Each of the plurality of non-random symbols sequences entails serially consecutive ordered different symbols, and where each said non-random symbols sequence is positioned in a quasi-random letter symbol matrix wherein they are spatially surrounded by a number of same letters symbols, which are randomly serially distributed. The subject is prompted to, within a first predefined time interval, search, discover and select each of the serially consecutive ordered different letter symbols of the non-random letters symbols sequences positioned in the quasi-random letter symbol matrix, and where the selection of the serially consecutive ordered different letters symbols in the non-random letters symbols sequences being accomplished by correctly selecting one letter symbol at a time. If the proposed letter symbol selection is not the correct next letter symbol within the serially consecutive ordered different letters symbols non-random sequence, then the subject is returned to the step of being prompted to serially search, discover and select the non-random serially consecutive ordered different letters symbols sequence. If the proposed letter symbol selection is the correct next letter symbol within the non-random serially consecutive ordered different letters symbols sequence, then the correct selected letter symbol is highlighted by changing at least one spatial or time perceptual related attribute of the correct selected letter symbol. If all letters symbols of the non-random serially consecutive ordered different letters symbols sequence have not been selected, then the subject is returned to the step of being prompted to serially search, discover and select the non-random serially consecutive ordered different letters symbols sequence. If all letters symbols of the non-random serially consecutive ordered different letters symbols sequence have been correctly selected, then the entire non-random serially consecutive ordered different letters symbols sequence is displayed with at least one different spatial or time perceptual related attribute than the other serially random distributed letters symbols in the quasi-random letter symbol matrix. The above steps in the method are repeated for a predetermined number of iterations separated by one or more predefined time intervals, and upon completion of the predetermined number of iterations, the subject is provided with each iteration results. The predetermined number of iterations can be any number needed to establish a satisfactory reasoning performance ability concerning the particular task at hand is being promoted within the subject. Non-limiting examples of number of iterations include 1, 2, 3, 4, 5, 6, and 7. However, any number of iterations can be performed.

In another non-limiting aspect of Example 2, the method of promoting fluid intelligence abilities in a subject is implemented through a computer program product. In particular, the subject matter in Example 2 includes a computer program product for promoting fluid intelligence abilities in a subject, stored on a non-transitory computer readable medium which when executed causes a computer system to perform the method. The method executed by the computer program on the non-transitory computer readable medium comprises selecting at least one serial order of serially consecutive ordered different symbols having the same spatial and time perceptual related attributes, from a predefined library of complete non-random symbols sequences, and providing the subject with a plurality of non-random symbols sequences with a lower number of serially consecutive ordered different symbols than in the previously selected serial orders of serially consecutive ordered different symbols, from where these non-random symbols sequences are obtained. Each symbols sequence of the plurality of non-random symbols sequences, is positioned together with an additional number of same symbols, which are randomly serially distributed in a quasi-random symbol matrix. The subject is prompted to, within a first predefined time interval, search, discover and select each of the serially consecutive ordered different symbols of the non-random symbols sequences positioned in the quasi-random symbol matrix, wherein the selection of serially consecutive ordered different symbols of the non-random sequence is being accomplished by selecting one consecutive ordered different symbol at a time. If the proposed symbol selection is not the correct next symbol within the non-random serially consecutive ordered different symbols sequence, then the subject is returned to the step of being prompted to serially search, discover and select the non-random serially consecutive ordered different symbols sequence. If the proposed symbol selection is the correct next symbol within the non-random serially consecutive ordered different symbols sequence, then the correct selected symbol is highlighted by changing at least one spatial or time perceptual related attribute of the correct selected symbol. If all symbols of the non-random serially consecutive ordered different symbols in the sequence have not been selected, then the subject is returned to the step of being prompted to serially search, discover and select the non-random serially consecutive ordered different symbols sequence. If all symbols of the non-random serially consecutive ordered different symbols sequence have been selected, then the entire non-random serially consecutive ordered different symbols sequence is displayed with at least one different spatial or time perceptual related attribute than the other randomly serially distributed symbols in the quasi-random symbol matrix. The above steps in the method are repeated for a predetermined number of iterations separated by one or more predefined time intervals, and upon completion of the predetermined number of iterations, the subject is provided with each iteration results.

In a further non-limiting aspect of Example 2, the method of promoting fluid intelligence abilities in a subject is implemented through a system. The system for promoting fluid intelligence abilities in a subject comprises: a computer system comprising a processor, memory, and a graphical user interface (GUI), the processor containing instructions for: selecting at least one serial order of serially consecutive ordered different symbols having the same spatial and time perceptual related attributes from a predefined library of complete non-random symbols sequences, and providing the subject on the GUI with a plurality of non-random symbols sequences with a lower number of serially consecutive ordered different symbols, than in the previously selected serial order of serially consecutive ordered different symbols, from where these non-random symbols sequences are obtained. Each of the plurality of non-random symbols sequences is positioned amongst an additional number of the same symbols randomly serially distributed inside a quasi-random symbol matrix; prompting the subject on the GUI to, within a first predefined time interval, serially search, discover and select each of the serially consecutive ordered different symbols of the non-random symbols sequences and where each non-random symbols sequence is positioned in the quasi-random symbol matrix, wherein the subject's selection of the serially consecutive ordered different symbols in a non-random symbols sequence is being accomplished by selecting one symbol at a time; if the proposed symbol selection is not the correct next symbol within the non-random serially consecutive ordered different symbols sequence, then returning to the prompting step; if the proposed symbol selection is the correct next symbol within the non-random serially consecutive ordered different symbols sequence, then highlighting the correct selected symbol on the GUI by changing at least one spatial or time perceptual related attribute of the correct selected symbol; if all symbols of the non-random serially consecutive ordered different symbols sequence have not been selected, then returning to the prompting step; if all symbols of the non-random serially consecutive ordered different symbols sequence have been correctly selected, then displaying the non-random serially consecutive ordered different symbols sequence on the GUI with at least one different spatial or time perceptual related attribute than the other random serially distributed symbols in the quasi-random symbol matrix; repeating the above steps for a predetermined number of iterations separated by one or more defined time intervals; and upon completion of the predetermined number of iterations, providing the subject with each iteration results on the GUI.

The present non-limiting Example entails a single block exercise, in which 3 trial exercises are displayed sequentially. Accordingly, the subject is required to successfully perform the above described task with all the non-random symbols sequences contained in a single quasi-random symbol matrix, for each trial exercise. In a non-limiting embodiment of the present Example, the quasi-random symbol matrix is generated to represent a quasi-random letter symbol matrix, which is generated to be performed by the subject in each of the 3 trial exercise of a single block exercise. In a non-limiting example, when the methods of Example 2 are implemented by a computer program product, the herein software program generates the quasi-random letter symbol matrix via an appropriate algorithm.

As previously discussed, it is contemplated that, in a non-limiting embodiment, the selected serial order of symbols from a predefined library of complete non-random symbols sequences, as well as the serially consecutive ordered different letters symbols of a plurality of non-random symbols sequences, derived from the selected serial order of complete non-random symbols sequences, are associated with alphabetic set arrays which are herein considered as non-random and complete direct alphabetical letters symbols sequences in nature. For those non-limiting embodiments, those alphabetic set arrays which are a non-random direct alphabetical letters symbols sequence in nature will be included in the predefined library of complete non-random serial orders of letters symbols sequences. Examples of these non-random alphabetical serial orders of letters symbols sequences, from which the selected non-random sequences of consecutive ordered different letter symbols are obtained include, without limitation, direct alphabetic set array, direct type of alphabetic set array, and central type of alphabetic set array.

Similarly, it is contemplated that the selected serial order of symbols, as well as the derived non-random symbols sequences, can be associated with an inverse alphabetic set array, which is herein considered a non-random and complete inverse alphabetical letters symbols sequence in nature. For those non-limiting embodiments, non-random inverse alphabetical serial orders of letters symbols sequences will be included in the predefined library of complete non-random serial orders of letters symbols sequences. Examples of non-random inverse alphabetical serial orders of letters symbols sequences include, without limitation, inverse alphabetic set array, inverse type of alphabetic set array, and inverse central type of alphabetic set array.

The quasi-random letter symbol matrix contains a number of non-random letter symbols sequences, which are formed by serially consecutive ordered different letters symbols obeying an A-Z direct alphabetical and\or a Z-A inverse alphabetical non-random serial order of letters symbols. In non-limiting examples, the herein generated quasi-random letter symbol matrix include a total of 720 letters symbols (18 rows of letters symbols (vertically allocated in the letter symbol matrix)×40 letters symbols per row (horizontally allocated in the letter symbol matrix) or a 30 rows of letters symbols (vertically allocated in the letter symbol matrix)×24 letters symbols per row (horizontally allocated in the letter symbol matrix) bringing to a total of 720 letters symbols per/quasi-random letter symbol matrix. In embodiments, the herein software program is also capable of generating symbol matrices in which symbols obey a non-random serial distribution ‘thus transforming the symbol serial structure of the symbol matrix from quasi-random to non-random. It should be obvious that, it will be perceptually more challenging and visually slower and therefore less fluent to serially search, discover and select a plurality of non-random alphabetical letter symbols sequences consisting each of serially consecutive ordered different letters symbols sequences, which are embedded within a non-random letter symbol matrix. Non-random symbol matrices of up to 5040 letter symbols, as described above with respect to Example 1, are also contemplated for the block exercises performances of Example 2.

In a non-limiting embodiment of the present Example, the quasi-random symbol matrix can be generated to represent a quasi-random letter symbol matrix, where sequences of letters symbols constituting the quasi-random letter symbol matrix are generated according to the following constrains in the participating letters symbols, for when the letters symbols are represented by letters symbols of the English alphabet: 1) letters symbols J, K, Q, X and Z are not allowed to be generated as part of the quasi-random letter symbol matrix; however, these letters symbols are still generated for any trial exercise in which the subject is required to serially search, identify and select the non-random serially consecutive ordered different letters symbols sequences meaning that at least some of the non-random letters symbols sequences displayed in the quasi-random letter symbol matrix may contain those not allowed letters symbols; 2) pairs of same letters symbols generated sequentially (displayed one after the other) are not allowed, specifically, the following pairs of same letters symbols are not allowed to be generated and display in a quasi-random letter symbol matrix: AA, BB, CC, DD, EE, FF, GG, HH, II, LL, MM, NN, OO, PP, RR, SS, TT, UU, VV, WW, and YY; and, 3) the following not same letter symbols pairs are not allowed to be generated and display as part of the quasi-random letter symbol matrix: AM, AN, AS, AT, BE, BY, DO, GO, HE, IF, IN, IS, IT, ME, MY, NO, OF, ON, OR, SO, TO, UP, US and WE.

In a non-limiting embodiment of the present Example, the non-random serially consecutive ordered different letters symbols sequences contained in the quasi-random letter symbol matrix, are generated or selected from alphabetic set arrays of a library of complete non-random serial orders of letters symbols sequences. As a consequence, the generated or selected complete non-random letters symbols sequences will possess a serial sequential order among their letters symbols of two types: letters symbols sequences having an alphabetical serial order positioning of their letters symbols which is a direct alphabetical serial order of letters symbols sequence in nature; and letter symbols sequences having an alphabetical serial order positioning of their letters symbols which is an inverse alphabetical serial order of letters symbols sequence in nature.

It is understood that any number of non-random letters symbols sequences with serially consecutive ordered different letters symbols which is a direct alphabetical serial order of letters symbols sequence in nature and any number of non-random letters symbols sequences with serially consecutive ordered different letters symbols which is an inverse alphabetical serial order of letters symbols sequence in nature, can be generated and displayed for a subject to perform in a given block exercise in Example 4. In a non-limiting embodiment, the number of non-random letters symbols sequences with serially consecutive ordered different letters symbols with a direct alphabetical serial order of letters symbols sequence nature is from 3-8 letters symbols sequences, more particularly 6 letters symbols sequences. Likewise, in a non-limiting embodiment, the number of non-random letter symbols sequences with serially consecutive ordered different letters symbols with an inverse alphabetical serial order of letters symbols sequence nature is from 3-8 letters symbols sequences, more particularly 6 letters symbols sequences.

Each of the non-random direct alphabetical and/or inverse alphabetical serially consecutive ordered different letters symbols sequences can display in various spatial directions within the quasi-random letter symbol matrix: 1) horizontal, 2) vertical and 3) diagonal. In a non-limiting embodiment, the non-random direct alphabetical and inverse alphabetical letters symbols sequences are directionally display and spatially distributed in the quasi-random letter symbol matrix according to the following criteria: a) 4 direct alphabetical and 4 inverse alphabetical letters symbols sequences are displayed horizontally; b) 1 direct alphabetical and 1 inverse alphabetical letters symbols sequences are displayed vertically; and c) l direct alphabetical and 1 inverse alphabetical letters symbols sequences are displayed diagonally.

Furthermore, when the non-random serially consecutive ordered different letters symbols sequence is either associated with a direct alphabetical serial order of letters symbols or associated with an inverse alphabetical serial order of letters symbols, and the serially consecutive ordered different letters symbols are displayed horizontally within the quasi-random letter symbol matrix, these serially consecutive ordered different letters symbols sequences can be of 3-7 letters symbols long, although other letters symbols lengths of serially consecutive ordered different letters symbols sequences displaying horizontally in the quasi-random letter symbol matrix are also contemplated. Furthermore, when the serially consecutive ordered different letters symbols sequence is associated with either a direct alphabetical serial order of letters symbols or associated with an inverse alphabetical serial order of letters symbols, and the letters symbols sequence displays either vertical or diagonal, within the quasi-random letter symbol matrix, it can be of 8-13 letters symbols long, although other letters symbols lengths of serially consecutive ordered different letters symbols sequences displaying vertically or diagonally in the quasi-random letter symbol matrix are also contemplated.

Upon correct identification and selection of non-random serially consecutive ordered letter symbols in a sequence within the quasi-random letter symbol matrix, the correctly selected letter symbol is then displayed with a spatial or time perceptual related attribute different than the spatial or time perceptual related attributes of the remaining plurality of randomly generated letters symbols in the quasi-random letter symbol matrix. In general, though, the changed spatial or time perceptual related attribute of the correctly identified letter symbol is selected from the group of spatial or time perceptual related attributes, or combinations thereof. In a particular non-limiting aspect, the changed letters symbols attributes are selected from the group consisting of symbol letter size, symbol letter font style, letter symbol spacing, letter symbol case, boldness of letter symbol, angle of letter symbol rotation, letter symbol mirroring, or combinations thereof. These attributes are considered spatial perceptual related attributes of the letter symbols. Other spatial perceptual related attributes of letters symbols that could be used to further emphasize differences between correctly selected non-random symbols sequences and a plurality of letters symbols randomly serially distributed across the quasi-random letter symbol matrix include, without limitation, letter symbol vertical line of symmetry, letter symbol horizontal line of symmetry, letter symbol vertical and horizontal lines of symmetry, letter symbol infinite lines of symmetry, and letter symbol with no line of symmetry. In a particular non-limiting aspect, the changed letters symbols attributes are selected from the group consisting of symbol color, symbol flickering and symbol sound. These attributes are considered time perceptual related attributes of the letters symbols. Furthermore, the correctly identified letter symbol may be displayed with a time perceptual related flickering attribute behavior in order to further highlight the differences in letters symbols perceptual related attributes namely between the randomly serially distributed letters symbols versus the non-random serially consecutive ordered different letter symbols sequences displaying in the quasi-random letter matrix.

In a non-limiting embodiment, once the subject has successfully selected all correct different letters symbols of the associated non-random direct alphabetical and/or inverse alphabetical serially consecutive ordered different letters symbols sequence, the entire non-random serially consecutive ordered different letters symbols sequence will immediately become time perceptual related color attribute active, changing from a default time perceptual related color attribute to a different time perceptual related color attribute according to the following criteria: a) for the associated non-random direct alphabetical or inverse alphabetical serially consecutive ordered letters symbols sequences displaying in the horizontal direction in the quasi-random letter symbol matrix, those non-random serially consecutive ordered letters symbols in the sequence turn their default time perceptual related color attribute to a first time perceptual related color attribute when all the letters symbols of the serially consecutive ordered letters symbols sequence has been correctly identified and selected by the subject; and b) for the non-random associated direct alphabetical or inverse alphabetical serially consecutive ordered different letters symbols sequences displaying in the vertically or diagonally directions in the quasi-random letter symbol matrix, those serially consecutive ordered different letters symbols in the sequences turn their default time perceptual related color attribute to a second time perceptual related color attribute when all the serially consecutive ordered different letters symbols in the sequence has been correctly identified and selected by the subject. The correctly selected letters symbols in the non-random serially consecutive ordered different letters symbols sequence can also be caused to behave with a time perceptual related flicker attribute behavior. It is contemplated that the time perceptual related color attribute change and/or the time perceptual related flickering attribute change of all correctly selected letters symbols in their respective discovered non-random serially consecutive ordered different letters symbols sequence is maintained until all serially consecutive ordered different letters in the sequences have been successfully identified and correctly selected by the subject in the quasi-random letter symbol matrix. It is also contemplated that the original default time perceptual related color attribute of the correctly selected letters symbols in the non-random letter symbol matrix namely, the first time perceptual related color attribute and the second time perceptual related color attribute are all different time perceptual related colors attributes from each other. For a non-limiting example, the original default time perceptual related color attribute can be color black, the first time perceptual related color attribute can be color red and the second time perceptual related color attribute can be color blue.

In a particular aspect of the present Example, the change in attributes is done according to predefined correlations between space and time related attributes, and the ordinal position of those letter symbols in the selected complete serial order of symbols in the first step of the method. For the case of a subject's visual perception of a complete direct alphabetic set array of the English language, the first ordinal position (occupied by the letter “A”), will generally appear toward the left side of his/her field of vision, whereas the last ordinal position (occupied by the letter “Z”) will appear towards his/her right field of vision. For a non-limiting example of this predefined correlation, if the ordinal position of the letter symbol for which an attribute will be changed falls in the left field of vision, the change in attribute may be different than if the ordinal position of the letter symbol for which the attribute will be changed falls in the right field of vision. In this non-limiting example, if the attribute to be changed is the color of the letter symbol, and if the ordinal position of the letter symbol for which the attribute will be changed falls in the left field of vision, then the color will be changed to a first different color, while if the ordinal position of the letter symbol falls in the right field of vision, then the color will be changed to a second color different from the first color. Likewise, if the attribute to be changed is the size of the letter symbol being displayed, then those letter symbols with an ordinal position falling in the left field of vision will be changed to a first different size, while the letter symbols with an ordinal position falling in the right field of vision will be changed to a second different size that is yet different than the first different size.

As with the above non-limiting Examples, the non-limiting exercises in Example 2 are useful in promoting fluid intelligence abilities in the subject by grounding its basic fluid intelligence abilities in selective motor activity that occurs when the subject performs the given exercise. That is, the serial search, identification and selection of the symbols inside the quasi-random or non-random symbol matrix by the subject engage motor activity within the subject's body. The motor activity engaged within the subject's body may be any motor activity involved in the group consisting of sensorial perception of serially searching, identifying and selecting a plurality of non-random serially consecutive ordered different letters symbols sequences allocated among a random serial distribution of letters symbols in the quasi-random symbol matrix, any motor activity involved in the group consisting of sensorial perception of serially searching, identifying and selecting a plurality of non-random serially consecutive ordered different letters symbols sequences allocated among a non-random distribution of letters symbols in a quasi-random or non-random letter symbol matrix, body movements to execute selecting the next correct letter symbol, sensorial perception of correctly selected letters symbols and of their changing spatial or time perceptual related attributes, sensorial perception to visually ignore or suppress attending to a plurality of letters symbols randomly serially distributed in the quasi-random letter symbol matrix, sensorial perception to visually ignore or suppress attending to a plurality of letters symbols non-randomly serially distributed in the quasi-random or non-random letter symbol matrix, sensorial visual perception concerning the spatial directionality (e.g., horizontal, vertical, diagonal) of non-random serially consecutive ordered different letters symbols sequences among a random serial distribution of letters symbols in the quasi-random symbol matrix, sensorial visual perception concerning the spatial directionality (e.g., horizontal, vertical, diagonal) of non-random serially consecutive ordered different letters symbols sequences among a non-random serial distribution of letters symbols in a quasi-random or non-random symbol matrix and/or combinations thereof. While any body movements can be considered motor activity within the subject, the present subject matter is concerned with body movements selected from the group consisting of body movements of the subject's eyes, head, neck, arms, hands, fingers and combinations thereof.

Requesting the subject to engage in various degrees of motor activity in the exercises of Example 2, require of him/her to bodily-ground cognitive fluid intelligence abilities as discussed above. The exercises of Example 2 cause the subject to revisit an early developmental realm where he/she implicitly experienced a fast enactment of fluid cognitive abilities specifically when performing serial pattern recognition of non-concrete symbols meshing and interacting with their salient space-time perceptual related attributes. The established relationships between non-concrete symbols and their (salient) spatial and/or time related attributes, heavily promote symbolic knowhow in a subject. Accordingly, the exercises of Example 2 strengthen fluid intelligence abilities by promoting in a subject novel inductive-deductive reasoning strategies that result in the attainment of more efficient ways to solve the mentioned exercises. It is important that the exercises of Example 2 accomplish promotion of symbolic relationships between symbols and their spatial and temporal perceptual related attributes by downplaying or mitigating as much as possible the subject's need to recall/retrieve from memory and use verbal semantic or episodic information as part of his/her novel reasoning strategy for problem solving of the exercises in Example 2. The non-limiting exercises of Example 2 are mainly about promoting fluid intelligence abilities and novel inductive-deductive reasoning strategies translating to the implicit discovery of abstract rules leading to fast and accurate pattern recognition of serial orders of symbols in a subject. Still, the exercises of Example 2 are not intended to raise the subject's sensorial-perceptual body motor performances with symbols and their spatial and/or time perceptual related attributes to the more cognoscenti formal operational stage, where crystalized intelligence's abilities are also promoted in the specific trained domain (crystallized intelligence abilities are brought into play by cognitively establishment of a multi-dimensional mesh of relationships between concrete items/things themselves, concrete items/things with their spatial and/or time perceptual related attributes and by substitution of concrete items/things with non-concrete symbols). Still, crystalized intelligence's narrow abilities are mainly promoted by sequential, descriptive and associative forms of explicit learning, which is a kind of learning strongly rooted in declarative semantic knowledge. As such, the serially consecutive ordered letters symbols sequences (but also number or alphanumeric serially consecutive ordered symbols sequences) and symbolic constrains imposed upon the serial construction of the quasi-random and non-random symbol matrices are herein selected to principally downplay or mitigate the subject's need for developing problem solving strategies and/or drawing abstract relationships necessitating verbal knowledge and/or automatic recall-retrieval of information from declarative-semantic and/or episodic kinds of memories.

In a non-limiting aspect of the exercises presented in Example 2, the library of complete serial orders of letters symbols sequences includes the following set arrays: direct alphabetic set array; inverse alphabetic set array; direct type of alphabetic set array; inverse type of alphabetic set array; central type of alphabetic set array; and, inverse central type alphabetic set array. It is understood that the above library of complete serial orders of letters symbols sequences may contain additional complete letter symbols sequences or fewer complete letters symbols sequences than those listed above.

Furthermore, it is also important to consider that the exercises of Example 2 are not limited to alphabetic serial orders of letters symbols. It is also contemplated that the exercises are also useful when numeric symbols serial orders and/or alpha-numeric symbols serial orders are used within the exercises. In other words, while the specific examples set forth employ serial orders of letters symbols, it is also contemplated that serial orders comprising numbers symbols and/or alpha-numeric symbols can be used.

In an aspect of the present subject matter, the exercises of Example 2 include providing a ruler to the subject namely, a direct alphabetic or inverse alphabetic set array is provided to the subject by showing it below the quasi-random symbol matrix in the form of a ruler. The presence of the ruler helps the subject to perform the exercise, by steering his/her visual attention to promote fast and accurate visual-perceptual spatial serial recognition concerning the discovery of consecutive different letters symbols that the subject is required to correctly select (one serially consecutive different letter symbol at a time) within the non-random serially consecutive ordered different letters symbols sequences in the quasi-random or non-random letter symbol matrix. In the present exercises, the ruler comprises one of a plurality of non-random letters symbols sequences in the above disclosed library of complete letters symbols sequences, namely direct alphabetic set array; inverse alphabetic set array; direct type of alphabetic set array; inverse type of alphabetic set array; central type of alphabetic set array; and inverse central type alphabetic set array.

Within a trial exercise of the present exercise, the subject is given a predefined maximal time period within which the subject must validly perform each time a correct identification of a symbol in the quasi-random or non-random symbol matrix. If the subject does not perform the correct identification of each single symbol in the non-random symbols sequences located inside the quasi-random or non-random symbol matrix of the trial exercise, within this predefined maximal time interval, also herein referred to as “a valid performance time period”, then after a delay, which could be of about 4 seconds, the next in-line quasi-random or non-random symbol matrix trial exercise for the subject to perform is displayed. In embodiments, this predefined maximal time interval or valid performance time period for a lack of response, is defined to be 20-90 seconds, in particular 30-75 seconds, and further specifically 60 seconds.

In the present Example, there also is a predefined time interval between trial exercises. Let Δ1 herein represent a time interval between trial exercises' performances of the present task, where Δ1 is herein defined to be of 4 seconds. However, other time intervals are also contemplated, including without limitation, 3-10 seconds and the integral times there between.

The methods implemented by the exercises of Example 2 also contemplate those situations in which the subject fails to perform any given trial exercise of this Example. The following failing to perform criteria is applicable to any trial exercise in the single block exercise of the present Example in which the subject fails to perform. Specifically, for the present exercises, “failure to perform” occurs in the event the subject fails to perform by not identifying and selecting the correct non-random direct alphabetical or inverse alphabetical serially consecutive ordered different letters symbols sequence located in the quasi-random or non-random symbol matrix, within the valid performance time period mentioned above. In such a case, the subject will automatically be prompted to start a new quasi-random or non-random symbol matrix trial exercise in which the subject must start the serially searching, identifying and selecting of the non-random serially consecutive ordered different letters symbols sequences again from the beginning of the new trial exercise. If the subject fails to perform in this manner again, the subject will automatically be prompted to start a new quasi-random or non-random symbol matrix trial exercise. The valid performance time period can be any set period of time, for instance 60 seconds for the recognition and correct selection of any next letter symbol. If the subject fails to perform in this manner for 2 new trial exercises consecutively within the block exercise, then the subject is automatically stopped within the exercises of Example 2 and returned to the main menu of Examples implementing the present methods.

Further failure to perform occurs when the subject selects letters symbols errors in the quasi-random or non-random symbol matrix. In such a case, when the subject wrongly selects more than 6 letters symbols in a given trial exercise, a new trial exercise is automatically put forth before the subject. The new trial exercise requires the subject to start a new serial search, identification and correct selection of the herein required to perform non-random serially consecutive ordered different letters symbols in the new provided letter symbols sequences which may present a different plurality of serially consecutive ordered different letters symbols for the subject to serially search, identify and correctly select (one serially consecutive ordered different letter symbol at a time). In addition, if the subject fails to identify and correctly select all of the letters symbols in a non-random serially consecutive ordered different letters sequence, then the method may treat that failure to perform as a failure to perform of the complete trial exercise. However, if the number of non-correctly identified letters symbols in any non-random letters symbols sequence is of 1 or 2 letters symbols, the method contemplates that the subject successfully completed this non-random letters symbols sequence of the trial exercise and responds accordingly. Failure to identify and correctly select more than 2 letters symbols in each non-random serially consecutive ordered different letters symbols sequence, results in the discontinuing of the changes in spatial or time perceptual related attributes for correctly selected letter symbols in the non-random serially consecutive ordered different letters symbols sequence, as described above.

Total duration to complete the exercises of Example 2, as well as the time it took to implement each one of the individual trial exercises, is registered in order to help generate an individual an age-gender related performance score. Records of all wrong answers for all type non-random letters symbols sequences required to be performed, are also generated and displayed. In general, the subject will perform this Example about 6 times during their-based brain mental fitness training program.

The disclosed subject matter being thus described, it will be obvious that the same may be modified or varied in many ways. Such modifications and variations are not to be regarded as a departure from the spirit and scope of the disclosed subject matter and all such modifications and variations are intended to be included within the scope of the following claims.

1. A method of promoting fluid intelligence abilities in a subject, by performing sequential sensorial discriminations of consecutive different letter symbols in a serial order of a selected alphabetic set array, wherein direct and inverse letter sequences of two or more consecutive letters formed from the selected alphabetic set array do not carry a semantic meaning, and involving a pre-semantic sensory motor activity not requiring retrieval of semantic knowledge from long term memory, the method comprising:
a) selecting at least one serial order of letter symbols of an alphabetic set array from a predefined library of complete symbols sequences, wherein the symbols all have the same spatial and time perceptual related attributes; and providing the subject with a symbol matrix containing the at least one serial order of symbols and a plurality of symbols having the same spatial and time perceptual related attributes as selected at least one serial order of symbols and a ruler containing the at least one serial order of symbols;
b) prompting the subject to search in the symbol matrix, to serially discriminate and sensory motor select, within a first predefined time interval, each symbol of the at least one serial order of symbols in the same serial order as shown in the ruler;
c) if the symbol selection is not a correct symbol of the serial order of symbols in the ruler, then returning to step b);
d) if the symbol selection is the correct next symbol from the serial order of symbols in the ruler, then changing at least one spatial or time perceptual related attribute of the correctly selected symbol;
e) if the complete serial order of symbols of the selected at least one serial order of symbols of the alphabetic set array has not been selected, then returning to step b);
f) if the complete serial order of symbols of the selected at least one serial order of symbols of the alphabetic set array has been selected, then changing at least one spatial or time perceptual related attribute of the complete serial order of symbols again to highlight a difference between the complete serial order of symbols and the plurality of symbols in the symbol matrix;
g) repeating the above steps for a predetermined number of iterations separated by one or more predefined time intervals; and
h) upon completion of the predetermined number of iterations, providing the subject with results of each iteration.

2. The method of claim 1, wherein the library of complete symbols sequences comprises alphabetic set arrays, each alphabetic set array having a serial order with direct or inverse sequences of two or more consecutive letters that do not carry a semantic meaning, and the symbol matrix has a plurality of letter and/or number symbols.

3. The method of claim 2, wherein the plurality of letter and/or number symbols of the symbol matrix is obtained by: a quasi-random generator of letters and/or numbers; a written text selected from books, newspapers, magazines, science papers, or combinations thereof; or transcriptions of audio recordings.

4. The method of claim 2, wherein the alphabetic set arrays comprise:
direct alphabetic set array; inverse alphabetic set array; direct type of alphabetic set array;
inverse type of alphabetic set array; central type of alphabetic set array; and inverse central type alphabetic set array.

5. The method of claim 4, wherein the selected at least one serial order of symbols located within the symbol matrix is selected from the group comprising: direct alphabetic set array, direct type of alphabetic set array, and central type of alphabetic set array.

6. The method of claim 4, wherein the selected at least one serial order of symbols located within the symbol matrix is selected from the group comprising; inverse alphabetic set array, inverse type of alphabetic set array, and inverse central type alphabetic set array.

7. The method of claim 3, wherein the symbol matrix is obtained from a predefined library of letter and/or number symbol matrices.

8. The method of claim 1, wherein the symbol matrix comprises at least 702 symbols, where 26×26 of the symbols correspond to the plurality of symbols and the other 26 symbols correspond to the selected alphabetic set array.

9. The method of claim 1, wherein the symbol matrix comprises at least 5000 symbols.

10. The method of claim 1, wherein the symbol matrix comprises at least 104 symbols, where 26×3 of the symbols correspond to the plurality of symbols and the other 26 symbols correspond to the selected alphabetic set array.

11. The method of claim 1, wherein the changed spatial and/or time perceptual related attribute of steps d) and f) is selected from one or more of symbol font color, symbol font size, symbol font style, symbol font spacing, symbol font case, symbol font boldness, symbol font angle of rotation, and symbol font mirroring.

12. The method of claim 11, wherein the changed spatial and/or time perceptual related attributes is made according to predefined correlations between the spatial and time perceptual related attributes and an ordinal position of the symbols in the selected at least one serial order of symbols of the alphabetic set array.

13. The method of claim 1, wherein the selecting by the subject engages motor activity within the subject's body, the motor activity selected from the group consisting of: sensorial perception of the at least one serial order of symbols sequence; body movements to execute searching, discriminating, and sensory motor selecting the correct symbol; and combinations thereof.

14. The method of claim 13, wherein the body movements are selected from the group consisting of movements of the subject's eyes, head, neck, arms, hands, fingers, and combinations thereof.

15. The method of claim 1, wherein the predetermined number of iterations ranges from 1-23 iterations.

16. The method of claim h wherein the selecting by the subject is done by a predefined selection choice method selected from the group consisting of multiple-choice selection method, force choice selection method and go-no go selection method.

17. A computer program product for promoting fluid intelligence abilities in a subject, by performing sequential sensorial discriminations of consecutive different letter symbols in a serial order of a selected alphabetic set array, wherein direct and inverse letter sequences of two or more consecutive letters formed from the selected alphabetic set array do not carry a semantic meaning, and involving a pre-semantic sensory motor activity not requiring retrieval of semantic knowledge from long term memory, the computer program product stored on a non-transitory computer-readable medium which when executed causes a computer system to perform a method, comprising:
a) selecting at least one serial order of letter symbols of an alphabetic set array from a predefined library of complete symbols sequences, wherein the symbols all have the same spatial and time perceptual related attributes; and providing the subject with a symbol matrix containing the at least one serial order of symbols and a plurality of symbols having the same spatial and time perceptual related attributes as the selected at least one serial order of symbols, and a ruler containing the at least one serial order of symbols;
b) prompting the subject to search in the symbol matrix, to serially discriminate and sensory motor select, within a first predefined time interval, each symbol of the at least one serial order of symbols in the same serial order as shown in the ruler;
c) if the symbol selection is not a correct symbol of the serial order of symbols in the provided ruler, then returning to step b);
d) if the symbol selection is the correct next symbol from the serial order of symbols in the provided ruler, then changing at least one spatial or time perceptual related attribute of the correctly selected symbol;
e) if the complete serial order of symbols of the selected at least one serial order of symbols of the alphabetic set array has not been selected, then returning to step b);
f) if the complete serial order of symbols of the selected at least one serial order of symbols of the alphabetic set array has been selected, then changing at least one spatial or time perceptual related attribute of the complete serial order of symbols again to highlight a difference between the complete serial order of symbols and the plurality of symbols in the symbol matrix;
g) repeating the above steps for a predetermined number of iterations separated by one or more predefined time intervals; and
h) upon completion of the predetermined number of iterations, providing the subject with results of each iteration.

18. A system for promoting fluid intelligence abilities in a subject, by performing sequential sensorial discriminations of consecutive different letter symbols in a serial order of a selected alphabetic set array, wherein direct and inverse letter sequences of two or more consecutive letters formed from the selected alphabetic set array do not carry a semantic meaning, and involving a pre-semantic sensory motor activity not requiring retrieval of semantic knowledge from long term memory, the system comprising:
a computer system comprising a processor, memory, and a graphical user interface (GUI), the processor containing instructions for:
a) selecting at least one serial order of letter symbols of an alphabetic set array from a predefined library of complete symbols sequences, wherein the symbols all have the same spatial and time perceptual related attributes; and providing the subject on the GUI with a symbol matrix containing the at least one serial order of symbols and a plurality of symbols having the same spatial and time perceptual related attributes as the selected at least one serial order of symbols, and a ruler containing the at least one serial order of symbols;
b) prompting the subject on the GUI to search in the symbol matrix to serially discriminate and sensory motor select, within a first predefined time interval, each symbol of the at least one serial order of symbols in the same serial order as shown in the ruler;
c) if the symbol selection is not a correct symbol of the serial order of symbols in the ruler, then returning to step b);
d) if the symbol selection is the correct next symbol from the serial order of symbols in the ruler, then changing at least one spatial or time perceptual related attribute of the correctly selected symbol on the GUI;
e) if the complete serial order of symbols of the selected at least one serial order of symbols of the alphabetic set array has not been selected, then returning to step b);
f) if the complete serial order of symbols of the selected at least one serial order of symbols of the alphabetic set array has been selected, then changing at least one spatial or time perceptual related attribute of the complete serial order of symbols on the GUI again to highlight a difference between the complete serial order of symbols and the plurality of symbols in the symbol matrix;
g) repeating the above steps for a predetermined number of iterations separated by second predefined time intervals; and
h) upon completion of the predetermined number of iterations, providing the subject with results of each iteration on the GUI.

19. A method of promoting fluid intelligence abilities in a subject, by performing sequential sensorial discriminations of consecutive different letter symbols in a serial order of a selected alphabetic set array, wherein direct and inverse letter sequences of two or more consecutive letters formed from the selected alphabetic set array do not carry a semantic meaning, and involving a pre-semantic sensory motor activity not requiring retrieval of semantic knowledge from long term memory, the method comprising:
a) selecting at least one serial order of an alphabetic set array having a predefined number of different letter symbols from a predefined library of complete symbols sequences, wherein the symbols all have the same spatial and time perceptual related attributes; and providing the subject with a plurality of letter symbol sequences having a reduced number of consecutive letter symbols, the plurality of letter symbol sequences obtained from and following the same serial order as the selected at least one serial order of the alphabetic set array, and an additional plurality of same letter symbols all having the same spatial and time perceptual related attributes and arranged in a quasi-random sequence, wherein the plurality of letter symbol sequences and the additional plurality of same letter symbols are assembled together to form a quasi-random symbol matrix;
b) prompting the subject, within a first predefined time interval, to serially search, discriminate, and sensory motor select each symbol from the plurality of letter symbol sequences, one at a time, from the quasi-random symbol matrix;
c) if the symbol selection is not a correct symbol from the plurality of letter symbol sequences, then returning to step b);
d) if the symbol selection is the correct next symbol from the plurality of letter symbol sequences, then changing at least one spatial and/or time perceptual related attribute of the correctly selected symbol;
e) if all of the symbols from the plurality of letter symbol sequences have not been selected, then returning to step b);
f) if all of the symbols from the plurality of letter symbol sequences have been correctly selected, then changing at least one spatial and/or time perceptual related attribute of the plurality of letter symbol sequences to highlight a difference between the plurality of letter symbol sequences and the additional plurality of same letter other symbols in the quasi-random symbol matrix;
g) repeating the above steps for a predetermined number of iterations separated by one or more predefined time intervals; and
h) upon completion of the predetermined number of iterations, providing the subject with the results of each iteration.

20. The method of claim 19, wherein the predefined library of complete symbols sequences comprises alphabetic set arrays, each alphabetic set array having a serial order with direct or inverse sequences of two or more consecutive letters that do not carry a semantic meaning, and wherein the alphabetic set arrays comprise:
direct alphabetic set array; inverse alphabetic set array; direct type of alphabetic set array; inverse type of alphabetic set array; central type of alphabetic set array; and inverse central type alphabetic set array.

21. The method of claim 20, wherein each symbol sequence from the plurality of letter symbol sequences is selected from the group consisting of direct alphabetic set array, direct type of alphabetic set array, and central type of alphabetic set array.

22. The method of claim 20, wherein each symbol sequence from the plurality of letter symbol sequences is selected from the group consisting of inverse alphabetic set array, inverse type of alphabetic set array, and inverse central type of alphabetic set array.

23. The method of claim 19, wherein the total number of symbols in the quasi-random symbol matrix, comprises at least 702 symbols, where 26×26 of the symbols correspond to the plurality of letter symbol sequences and the other 26 symbols correspond to the selected alphabetic set array.

24. The method of claim 19, wherein the total number of symbols in the quasi-random symbol matrix, comprises at least 5000 symbols.

25. The method of claim 19, wherein the plurality of letter symbol sequences comprises six symbol sequences.

26. The method of claim 19, wherein a symbol sequence from the plurality of letter symbol sequences is positioned horizontally within the quasi-random symbol matrix.

27. The method of claim 26, wherein the symbol sequence comprises 3-7 symbols.

28. The method of claim 19, wherein a symbol sequence from the plurality of letter symbol sequences is positioned vertically within the quasi-random symbol matrix.

29. The method of claim 28, wherein the symbol sequence comprises 8-13 symbols.

30. The method of claim 19, wherein a symbol sequence from the plurality of letter symbols sequences is positioned diagonally within the quasi-random symbol matrix.

31. The method of claim 30, wherein the symbol sequence comprises 8-13 symbols.

32. The method of claim 20, wherein letter symbols J, K, Q, X and Z are not present inside the quasi-random symbol matrix unless any of the letter symbols J, K, Q, X and Z are present in any of the plurality of symbols sequences.

33. The method of claim 20, wherein the quasi-random symbol matrix does not contain repeated letter symbol pairs selected from the group consisting of: AA, BB, CC, DD, EE, FF, GG, HH, II, LL, MM, NN, OO, PP, RR, SS, TT, UU, VV, WW, and YY.

34. The method of claim 20, wherein the quasi-random symbol matrix does not contain letters symbol pairs having a semantic meaning, the letter symbols pairs selected from the group consisting of: AM, AN, AS, AT, BE, BY, DO, GO, HE, IF, IN, IS, IT, ME, MY, NO, OF, ON, OR, SO, TO, UP, US and WE.

35. The method of claim 19, wherein the changed spatial and/or time perceptual related attribute of steps d) and f) is selected from one or more of symbol font color, symbol font size, symbol font style, symbol font spacing, symbol font case, symbol font boldness, symbol font angle of rotation, and symbol font mirroring.

36. The method of claim 35, wherein the changed spatial and/or time perceptual related attributes is made according to predefined correlations between the spatial and time related attributes and an ordinal position of the symbols in the selected at least one serial order of the alphabetic set array.

37. The method of claim 19, wherein the selecting by the subject engages motor activity within the subject's body, the motor activity selected from the group consisting of: sensorial perception of the selected at least one serial order of the alphabetic set array and the plurality of letter symbol sequences obtained therefrom: sensorial perception of the additional plurality of same letter symbols arranged in a quasi-random sequence; body movements to execute searching, discriminating, and sensory motor selecting the symbols from the plurality of letter symbol sequences; and combinations thereof.

38. The method of claim 37, wherein the body movements are selected from the group consisting of movements of the subject's eyes, head, neck, arms, hands, fingers and combinations thereof.

39. The method of claim 19, further comprising providing a ruler displaying the at least one serial order of the alphabetic set array in step a).

40. The method of claim 39, wherein the at least one serial order displayed in the ruler is selected from the group consisting of: direct alphabetic set array; inverse alphabetic set array; direct type of alphabetic set array; inverse type of alphabetic set array; central type of alphabetic set array; and inverse central type alphabetic set array.

41. The method of claim 19, wherein the predetermined number of iterations ranges from 1-24 iterations.

42. The method of claim 19, wherein the plurality of letter symbol sequences is randomly obtained, by a mathematical algorithm, from the alphabetic set array.

43. A computer program product for promoting fluid intelligence abilities in a subject, by performing sequential sensorial discriminations of consecutive different letter symbols in a serial order of a selected alphabetic set array, wherein direct and inverse letter sequences of two or more consecutive letters formed from the selected alphabetic set array do not carry a semantic meaning, and involving a pre-semantic sensory motor activity not requiring retrieval of semantic knowledge from long term memory, the computer program product stored on a non-transitory computer-readable medium which when executed causes a computer system to perform a method, comprising:
a) selecting at least one serial order of an alphabetic set array having a predefined number of different letter symbols from a predefined library of complete symbols sequences, wherein the symbols all have the same spatial and time perceptual related attributes; and providing the subject with a plurality of letter symbol sequences having a reduced number of consecutive letter symbols, the plurality of letter symbol sequences obtained from and following the same serial order as the selected at least one serial order of the alphabetic set array, and providing an additional plurality of same letter symbols all having the same spatial and time perceptual related attributes and arranged in a quasi-random sequence, wherein the plurality of letter symbol sequences and the additional plurality of same letter symbols are assembled together to form a quasi-random symbol matrix;
b) prompting the subject, within a first predefined time interval, to serially search, discriminate, and sensory motor select each symbol from the plurality of letter symbol sequences, one at a time, from the quasi-random symbol matrix;
c) if the symbol selection is not a correct symbol from the plurality of letter symbol sequences, then returning to step b);
d) if the symbol selection is the correct next symbol from the plurality of letter symbol sequences, then changing at least one spatial and/or time perceptual related attribute of the correct selected symbol;
e) if all of the symbols from the plurality of letter symbol sequences have not been selected, then returning to step b);
f) if all of the symbols from the plurality of letter symbol sequences have been correctly selected, then changing at least one spatial and/or time perceptual related attribute of the plurality of letter symbol sequences to highlight a difference between the plurality of letter symbol sequences and the additional plurality of same letter symbols in the quasi-random symbol matrix;
g) repeating the above steps for a predetermined number of iterations separated by one or more predefined time intervals; and
h) upon completion of the predetermined number of iterations, providing the subject with results of each iteration.

44. A system for promoting fluid intelligence abilities in a subject, by performing sequential sensorial discriminations of consecutive different letter symbols in a serial order of a selected alphabetic set array, wherein direct and inverse letter sequences of two or more consecutive letters formed from the selected alphabetic set array do not carry a semantic meaning, and involving a pre-semantic sensory motor activity not requiring retrieval of semantic knowledge from long term memory, the system comprising:
a computer system comprising a processor, memory, and a graphical user interface (GUI), the processor containing instructions for:
a) selecting at least one serial order of an alphabetic set array having a predefined number of different letter symbols from a predefined library of complete symbols sequences, wherein the symbols all have the same spatial and time perceptual related attributes; and providing the subject on the GUI with a plurality of letter symbol sequences having a reduced number of consecutive letter symbols, the plurality of letter symbol sequences obtained from and following the same serial order as the selected at least one serial order of the alphabetic set array, and an additional plurality of same letter symbols all having the same spatial and time perceptual related attributes and arranged in a quasi-random sequence, wherein the plurality of letter symbol sequences and the additional plurality of same letter symbols are assembled together to form a quasi-random symbol matrix;
b) prompting the subject on the GUI, within a first predefined time interval, to serially search, discriminate, and sensory motor select each symbol from the plurality of letter symbol sequences, one at a time, from the quasi-random symbol matrix;
c) if the symbol selection is not a correct symbol from the plurality of letter symbol sequences, then returning to step b);
d) if the symbol selection is the correct next symbol from the plurality of letter symbol sequences, then changing at least one spatial and/or time perceptual related attribute of the correctly selected symbol on the GUI;
e) if all of the symbols from the plurality of letter symbol sequences have not been selected, then returning to step b);
f) if all of the symbols from the plurality of letter symbol sequences have been correctly selected, then changing at least one spatial and/or time perceptual related attribute of the plurality of letter symbol sequences on the GUI to highlight a difference between the plurality of letter symbol sequences and the additional plurality of same letter symbols in the quasi-random symbol matrix;
g) repeating the above steps for a predetermined number of iterations separated by one or more predefined time intervals; and
h) upon completion of the predetermined number of iterations, providing the subject with results of each iteration on the GUI.
